(19) United States
(12) Patent Application Publication
(10) Pub. No.: US 2025/0304162 A1
(43) Pub. Date: Oct. 2, 2025

(54) UTILITY VEHICLE

(71) Applicant: Polaris Industries Inc., Medina, MN (US)

(72) Inventors: Beat R. Kohler, Burgdorf (CH); Hans-Rudolf Jenni, Burgdorf (CH); Marcel Frei, Burgdorf (CH); Ronald Zurbruegg, Burgdorf (CH); Urs Wenger, Burgdorf (CH); Alain Daeppen, Burgdorf (CH); Yassin M. Kelay, Burgdorf (CH)

(21) Appl. No.: 18/864,265

(22) PCT Filed: May 8, 2023
(86) PCT No.: PCT/US2023/066741

§ 371 Date: Nov. 8, 2024

Related U.S. Application Data
(60) Provisional application No. 63/339,578, filed on May 9, 2022.
(60) Provisional application No. 63/403,587, filed on Sep. 2, 2022.

(51) Int. Cl. B62D 11/14; B62D 11/00; B62D 55/06

(52) U.S. Cl. CPC B62D 11/14; B62D 11/003; B62D 55/06

(57) ABSTRACT

Tracked vehicles include a track assembly, a powertrain assembly to power the track assembly, and a steering assembly configured to provide a torque to the track assembly. A steering motor is operably coupled to the powertrain assembly to effectuate a steering of the vehicle. A backup steering assembly is configured to provide backup steering capability to the tracked vehicle. The tracked vehicle also includes a plurality of steering modes, as well as a plurality of suspension components configured to increase rider comfort.

### RELATED APPLICATIONS

The present application claims priority to U.S. Provisional Patent Application Ser. No. 63/339,578, filed May 9, 2022, and entitled “UTILITY VEHICLE”; and U.S. Provisional Patent Application Ser. No. 63/403,587, filed Sep. 2, 2022, and entitled “UTILITY VEHICLE”, the complete disclosures of which are expressly incorporated by reference herein.

### FIELD OF THE DISCLOSURE

The present disclosure relates to a tracked utility vehicle.

### BACKGROUND OF THE DISCLOSURE

Tracked utility vehicles include track assemblies and steering assemblies. The track assemblies often utilize a suspension assembly and it is necessary to ensure that the size of the suspension assembly and track assembly appropriately fit within the necessary packaging of the vehicle.

### SUMMARY OF THE DISCLOSURE

In one embodiment of the present disclosure, a tracked vehicle is provided. The tracked vehicle comprises a first track assembly and a second track assembly and a powertrain configured to provide rotational power to the first track assembly and the second track assembly. The tracked vehicle also comprises a steering system operably coupled to the first track assembly and the second track assembly. The steering system comprises a steering motor, a geartrain operably coupled between the steering motor and the powertrain, a steering control unit configured to receive a steering input signal, a generator operably coupled to the powertrain, and the generator is configured to provide power to the steering motor. Further, the steering control unit is configured to provide a steering output signal to the steering motor, the steering output signal being one of a positive torque command and a negative torque command.

Additionally, the powertrain includes an electronic controller, the electronic controller configured to receive a first powertrain characteristic from the powertrain at a first time and receive the first powertrain characteristic at a second time. The steering control unit is configured to receive the first powertrain characteristic from the electronic controller and alter the steering output signal when the first powertrain characteristic at the second time is different than the first powertrain characteristic at the first time.

In one embodiment, the first powertrain characteristic is one of an engine speed, a gearbox position, and a vehicle speed.

In another embodiment, the first powertrain characteristic is a gearbox position, and the steering motor is configured to output one of a positive torque and a negative torque when the gearbox position is one of a reverse gear and a forward gear and a steering input is in a first direction. Further, the steering motor is configured to output the other one of a positive torque and a negative torque when the gearbox position is the other one of a reverse gear and a forward gear and the steering input is in the first direction.

In another embodiment, the first powertrain characteristic is one of an engine speed and a vehicle speed, and the steering control unit is configured to request an increase in the absolute value of the torque command when the first powertrain characteristic is increased.

In various embodiments, the steering system further comprises a steering feedback unit, and the steering feedback unit is configured to provide a feedback signal to an operator of the vehicle when the steering output signal is provided to the steering motor. In various embodiments, the steering feedback unit is an electronic power steering unit.

In various embodiments of the present disclosure, the powertrain includes an electronic controller and the electronic controller is configured to receive an engine speed, a vehicle speed and a gearbox position from the powertrain. Further, the steering output signal is configured to change based upon a change in any of the engine speed, the vehicle speed, and the gearbox position. Further, the steering output signal is configured to change in accordance with a steering motor speed gradient based upon a change in the engine speed or the vehicle speed. Additionally, the speed gradient includes a first steering motor speed interval between a first engine speed and a second engine speed and a second steering motor speed interval between a third engine speed and a fourth engine speed. Further, the difference between the first engine speed and the second engine speed equals the difference between the third engine speed and the fourth engine speed. In the present embodiment, the first speed is less than the second speed which is less than the third speed which is less than the fourth speed, and the first steering motor speed interval is less than the second steering motor speed interval.

In yet another embodiment of the present disclosure, a vehicle is provided. The vehicle comprising a first track assembly and a second track assembly and a frame supported by the first track assembly and the second track assembly. The vehicle further comprises a powertrain supported by the frame, the powertrain including a prime mover, a transmission operably coupled to the prime mover, a drive member, and a propshaft extending from the transmission to the drive member. The drive member comprises a drive housing, an input configured to receive the propshaft, and a plurality of outputs. The plurality of outputs includes a first output and a second output, the first output is rotatably coupled to the first track assembly and the second output is rotatably coupled to the second track assembly. The vehicle further comprises a steering assembly, the steering assembly comprising a steering motor and a geartrain operably coupled between the steering motor and the plurality of outputs. Further, the steering motor is coupled to the drive housing.

The drive member of the vehicle is positioned at a forward portion of the vehicle and the prime mover is positioned at a rearward portion of the vehicle. Further, the generator is operably coupled to the prime mover and electrically coupled to the steering motor. In another embodiment, the geartrain is configured to provide a first torque to the first output and a second torque to the second output, and the first torque is a positive value and the second torque is a negative value.

The steering assembly of the vehicle further comprises a steering control unit communicably coupled to the steering motor, and the steering control unit receives one of an engine speed and a vehicle speed from the powertrain. Further, the steering control unit alters an operating characteristic of the steering motor based upon a change in one of the engine speed and the vehicle speed. In another embodiment, the steering motor output is parallel to the first output and the second output.

The geartrain of the vehicle further comprises a first shaft and a second shaft parallel to the first shaft. Further, the drive member includes a drive input shaft coupled to the input, and a portion of the drive input shaft extends between the first shaft and the second shaft.

In yet another embodiment of the present disclosure, a vehicle is provided. A vehicle comprising a plurality of ground engaging members comprising a first ground engaging member and a second ground engaging member and a frame supported by the plurality of ground engaging members. The vehicle comprises a steering assembly supported by the frame. The steering assembly is configured to provide a steering force to each of the first ground engaging member and the second ground engaging member. The steering input has a first steering range when the steering assembly has a first operating condition and a second steering range when the steering assembly has a second operating condition, and the second steering range being greater than the first steering range. The vehicle also comprises a braking system which comprises a first brake assembly operably coupled to the first ground engaging member and a second brake assembly operably coupled to the second ground engaging member. The first brake assembly comprises a first braking actuator and the second brake assembly comprises a second braking actuator. The vehicle also comprises a controller supported by the frame, the controller communicably coupled to the steering assembly, and the steering input is configured to actuate either of the first braking actuator or the second braking actuator in the second operating condition.

In the present embodiment, when the steering assembly has the first operating condition, a steering stop is in a first position limiting the steering assembly to operate within the first steering range. Further, when the steering assembly has the second operating condition, a steering stop is in a second position which allows the steering assembly to operate within the second steering range. Additionally, the vehicle further comprises a steering stop actuator, wherein the actuator is configured to move the steering stop from the first position to the second position.

In the present embodiment, the second operating condition is indicative of a fault condition, and the fault condition is a fault with a steering motor.

In another embodiment of the present disclosure, the vehicle comprises a brake input, and the actuation of the brake input actuates both of the first braking actuator and the second braking actuator.

In another embodiment of the present disclosure, a steering input in a first direction actuates the first braking actuator providing a braking force to the first ground engaging member. Further, a steering input in a second direction actuates the second braking actuator providing a braking force to the second ground engaging member.

In yet another embodiment of the present disclosure, a steering system for a vehicle with a plurality of ground engaging members is provided. The steering system comprising a powertrain configured to provide power to the plurality of ground engaging members. Further, the powertrain comprises a prime mover, a gearbox and a final drive. The steering system is operably coupled to at least one of the plurality of ground engaging members. Further, the steering assembly comprises a steering motor and a geartrain operably coupled between the steering motor and the final drive. The steering system further comprises an electronic controller communicably coupled with the steering motor and the powertrain. The electronic controller is configured to: receive, by the electronic controller, a gearbox position from a gearbox position sensor, disable the steering motor when the gearbox has a first position, and enable the steering motor when the gearbox has a second position.

In the present embodiment, the plurality of ground engaging members are tracks.

In another embodiment of the present disclosure, the plurality of ground engaging members are tracks.

In another embodiment of the present disclosure, the first position is a park position.

In another embodiment of the present disclosure, the steering system comprises a steering input communicably coupled to the steering motor. The steering input is configured to provide a steering input signal to the steering motor, and the electronic controller is further configured to notify the operator if a steering input signal is received when the gearbox has the first position.

In another embodiment of the present disclosure, the steering system further comprises a motor control unit electrically coupled to the steering motor, the motor control unit configured to decouple from the steering input when the gearbox has the first position.

In another embodiment of the present disclosure, the steering system further comprises a battery electrically coupled to the steering motor, the battery configured to decouple from the steering motor when the gearbox has the first position.

In another embodiment of the present disclosure, the steering system further comprises a generator electrically coupled to the steering motor, the generator configured to decouple from the steering motor when the gearbox has the first position.

In yet another embodiment of the present disclosure, a tracked vehicle is provided. The tracked vehicle comprising a first track assembly, a second track assembly and a frame supported by the first and second track assembly. The tracked vehicle further comprises a powertrain configured to provide power to the first track assembly and the second track assembly The powertrain comprises a prime mover, a gearbox, and a final drive. The tracked vehicle further comprises a steering assembly comprising a steering motor operably coupled to the front drive. The tracked vehicle further comprises an electronic controller communicably coupled with the powertrain and the steering motor. The electronic controller is configured to receive a gearbox position sensor and an engine state condition, disable the steering motor when the gearbox has a first position and the engine has an on condition, and enable the steering motor when the gearbox has a second position and the engine has an off condition.

In another embodiment of the present disclosure, the first track assembly and the second track assembly are non-steerable members.

In another embodiment of the present disclosure, the first position is a park position.

In another embodiment, the tracked vehicle further comprises a steering input communicably coupled to the steering motor. Further, the steering input is configured to provide a steering input signal to the steering motor. Additionally, the electronic controller is further configured to notify the operator if a steering input signal is received when the gearbox has the first position.

In another embodiment of the present disclosure, the steering system further comprises a motor control unit electrically coupled to the steering motor, and the motor control unit is configured to decouple from the steering input when the gearbox has the first position.

In another embodiment of the present disclosure, the steering system further comprises a battery electrically coupled to the steering motor, the battery configured to decouple from the steering motor when the gearbox has the first position.

In another embodiment of the present disclosure, the steering system further comprises a generator electrically coupled to the steering motor, the generator configured to decouple from the steering motor when the gearbox has the first position.

In yet another embodiment of the present disclosure, a vehicle is provided. The vehicle comprises a plurality of ground engaging members including a first track assembly, a second track assembly, and a frame supported by the plurality of ground engaging members. The vehicle comprises a powertrain supported by the frame, the powertrain comprising a prime mover and a final drive, and the final drive is coupled to each of the first track assembly and the second track assembly. The vehicle also comprises a steering assembly including a steering input and a steering motor comprising a motor output. The motor output is operably coupled to the plurality of ground engaging members. The vehicle comprises a user interface supported by the frame, the user interface including a user input. The vehicle also comprises an electronic controller communicably coupled to the steering assembly and configured to control a motor speed of the steering motor. The electronic controller is configured to receive a steering angle from the steering input and a user input signal from the user input. and the user input signal comprises one of a first steering mode and a second steering mode. In the present embodiment, when the user input signal indicates the first steering mode: a first steering angle corresponds to a first motor speed and a second steering angle corresponds to a second motor speed, and the first motor speed is distinct form the second motor speed. When the user input signal indicates the second steering mode, the first steering angle corresponds to a third motor speed and the second steering angle corresponds to a fourth motor speed, and the fourth motor speed is distinct from each of the second motor speed and the third motor speed.

In another embodiment of the present disclosure, the vehicle further comprises a steering feedback unit operably coupled to the steering input. The steering input has a first steering angle and the steering feedback unit is configured to provide a first feedback force to the steering input.

In another embodiment of the present disclosure, when the user input indicates the first steering mode, the first steering angle corresponds to a first target output torque and the second steering angle corresponds to a second target output torque.

In another embodiment of the present disclosure, the motor speed is further determined by at least one of a prime mover speed, a gearbox position, and a vehicle speed.

In another embodiment of the present disclosure, at the first steering angle the steering motor speed increases as vehicle speed increases.

In another embodiment of the present disclosure, at the first steering angle the steering motor speed increases as the prime mover speed increases.

In yet another embodiment of the present disclosure, a vehicle is provided. The vehicle comprises a plurality of ground engaging members and a front drive operably coupled to at least a portion of the plurality of ground engaging members. The vehicle also comprises a steering assembly comprising a steering input configure to receive a user input, a steering feedback unit operably coupled to the steering input, and a steering motor operably coupled to the front drive. The vehicle also comprises an electronic controller communicably coupled to the steering assembly, and the electronic controller is configured to receive a steering angle from the steering input. Further, the steering feedback unit is configured to provide a first feedback force to the steering input when the steering input has a first steering angle.

In another embodiment of the present disclosure, the steering controller is configured to provide a first target output speed to the steering motor. Further, the steering input outputs a second steering angle and the steering feedback unit is configured to provide a second feedback force to the steering input and a second target output speed to the steering motor when the steering input has the second steering angle.

In another embodiment of the present disclosure, the steering feedback unit provides a second feedback force to the steering input when the steering input has a second steering angle.

In another embodiment of the present disclosure, the absolute value of the second steering angle is greater than the absolute value of the first steering angle, and the second feedback force is greater than the first feedback force.

In another embodiment of the present disclosure, the vehicle comprises a first steering mode and a second steering mode. When the vehicle is in the first steering mode the first steering angle corresponds to a third feedback force, and when the vehicle is in the second steering mode the first steering angle corresponds to a fourth feedback force.

In another embodiment of the present disclosure, the vehicle comprises a user interface, and the user interface comprises a user input configured to select a desired amount of feedback force.

In yet another embodiment of the present disclosure, a track assembly is provided. The track assembly comprises a suspension including a frame, a carrier wheel, an arm rotatably coupled to the frame and extending between the frame and the carrier wheel, and a biasing member extending between the frame and the carrier wheel. The track assembly further comprises a track surrounding the suspension and a drive wheel assembly coupled to the frame. The front drive assembly comprises a drive shaft supported by the frame, and a drive wheel rotatably coupled to the drive shaft which is rotatable about a drive shaft axis. The track assembly further comprises a brake assembly operably coupled to the drive wheel assembly, the brake assembly comprising a brake caliper supported by the drive wheel assembly. The brake assembly further comprises a brake disc rotatably coupled to the drive shaft, the brake caliper configured to engage the brake disc. The track assembly further comprises a linkage assembly coupled between the brake caliper and the arm.

In another embodiment of the present disclosure, the brake caliper is rotatable about the drive shaft axis.

In another embodiment of the present disclosure, the brake caliper is supported by the drive axle.

In another embodiment of the present disclosure, the arm is stationary when the brake caliper engages the brake disc.

In another embodiment of the present disclosure, the brake caliper can rotate about the drive axle when disengaged from the brake disc.

In another embodiment of the present disclosure, a rigid connection is created between the drive axle and the carrier wheel when the brake caliper engages the brake disc.

In yet another embodiment of the present disclosure, a tracked vehicle is provided. The tracked vehicle comprising a plurality of track assemblies including a first track assembly and a second track assembly, and a frame supported by the first track assembly and the second track assembly. The frame is comprised of a frame front portion and frame rear portion, and the frame has a plurality of coupling points. The tracked vehicle further comprises a powertrain supported by the frame, the powertrain operably coupled to the first track assembly and the second track assembly. The powertrain further comprises a prime mover, a shiftable transmission, a final drive, and a pair of halfshafts extending between the final drive and each of the first track assembly and the second track assembly. Further, a first halfshaft of the pair of halfshafts being coupled between the final drive and the first track assembly at a first drive mounting point and a second halfshaft of the pair of halfshafts being coupled between the final drive and the second track assembly at a second drive mounting point. Further, the first track assembly is coupled to the frame at a first portion of the plurality of coupling points. The plurality of coupling points includes a first mounting point positioned within the frame front portion adjacent the first rive mounting point, a second mounting point within the frame rear portion, and a third mounting point intermediate the first mounting point and the second mounting point.

In another embodiment of the present disclosure, the second track assembly is coupled to the frame at a second portion of the plurality of coupling points. The plurality of coupling points including a fourth mounting point positioned within the frame front portion adjacent the second drive mounting point, a fifth mounting point positioned within the frame rear portion, and a sixth mounting point intermediate the fourth mounting point and the fifth mounting point.

In another embodiment of the present disclosure, the first track assembly includes a drive wheel positioned about the first drive mounting point, a first carrier wheel positioned adjacent the drive wheel, and a second carrier wheel positioned at a rear of the first track assembly. Further, the first carrier wheel and the second carrier wheel are configured to engage a ground surface.

In yet another embodiment of the present disclosure, a track assembly is provided. The track assembly comprises a frame, a track surrounding the frame, and a plurality of carrier wheel assemblies coupled to the frame. The plurality of carrier wheels comprises a rear carrier wheel assembly. The rear carrier wheel assembly comprises a tensioner assembly and a rear carrier wheel. The tensioner assembly comprises a mounting frame coupled to the frame. The mounting frame comprises an aperture, and the swingarm is configured to translate within the aperture, and a fastener is configured to couple the swingarm to the mounting frame at the aperture.

In another embodiment of the present disclosure, the track assembly further comprises an adjustment screw configured with an opening, the adjustment screw positioned within the aperture and the fastener configured to extend through the opening.

In another embodiment of the present disclosure, the swingarm is configured to rotate about the fastener.

In another embodiment of the present disclosure, the track assembly further comprises a shock absorber which extends between the frame and the swingarm.

In another embodiment of the present disclosure, the rear carrier wheel is configured to engage the ground surface.

In yet another embodiment of the present disclosure, a track assembly is provided. The track assembly comprises a frame and a track surrounding the frame. The track assembly also comprises a plurality of carrier wheel assemblies coupled to the frame. The plurality of carrier wheels comprises a rear carrier wheel assembly. The rear carrier wheel assembly comprises a swingarm coupled between the frame and a rear carrier wheel. The swingarm comprises a body extending between the frame and the rear carrier wheel, and a first biasing member positioned within the body.

In another embodiment of the present disclosure, the body further comprises a shock mount, and a second biasing member is configured to extend between the frame and the shock mount.

In another embodiment of the present disclosure, the rear carrier wheel is configured to engage a ground surface.

In another embodiment of the present disclosure, the track assembly further comprises a tension assembly positioned intermediate the swingarm and the frame, and the swingarm is configured to translate within the tension assembly.

In another embodiment of the present disclosure, the swingarm is configured to rotate about the frame.

### BRIEF DESCRIPTION OF THE DRAWINGS

FIG. 1 is a front left perspective view of the vehicle of the present disclosure;

FIG. 2 is a rear right perspective view of the vehicle of FIG. 1;

FIG. 3 is a left side view of the vehicle of FIG. 1;

FIG. 4 is a right side view of the vehicle of FIG. 1;

FIG. 5 is a top plan view of the vehicle of FIG. 1;

FIG. 6 is a bottom view of the vehicle of FIG. 1;

FIG. 7 is an exploded perspective view of the tracks and frame of the vehicle of FIG. 1;

FIG. 8 is a perspective view of a track assembly of FIG. 7;

FIG. 9 is an exploded perspective view of a frame of the track assembly of FIG. 8;

FIG. 10 is a side view of a rear carrier wheel assembly of the track assembly of FIG. 8;

FIG. 11 is a perspective view of a portion of the rear carrier wheel assembly of FIG. 10;

FIG. 12 is a cross-sectional view of a portion of the rear carrier wheel assembly, taken along line 12-12 of FIG. 10;

FIG. 13 is an exploded view of a portion of the rear carrier wheel assembly of FIG. 10;

FIG. 14 is an exploded view of another portion of the rear carrier wheel assembly of FIG. 10;

FIG. 15 is a perspective view of a front drive wheel assembly of the track assembly of FIG. 8;

FIG. 16 is a side view of the front drive wheel assembly of FIG. 15;

FIG. 17 is a cross-sectional view of the front drive wheel assembly, taken along line 17-17 of FIG. 16;

FIG. 18 is an exploded view of the front drive wheel assembly of FIG. 15;

FIG. 19 is a side view of a vehicle of the present disclosure with an adjustable suspension;

FIG. 19A is a control diagram of the adjustable suspension of the vehicle of FIG. 19;

FIG. 19B is a rear view of the vehicle of FIG. 19 on a side sloped ground surface;

FIG. 19C is a side view of the vehicle of FIG. 19 on a forward sloped ground surface;

FIG. 20 is a top plan view of the frame and powertrain of the vehicle of FIG. 1;

FIG. 21 is a rear right perspective view of a portion of a steering system of the vehicle of FIG. 1;

FIG. 22 is a perspective view of a front drive and steering system of the vehicle of FIG. 1;

FIG. 23 is a perspective view of a geartrain of a front drive and the steering system of FIG. 22;

FIG. 24 is an exploded view of the geartrain of FIG. 23;

FIG. 25 is a further exploded view of a portion of the geartrain of FIG. 23;

FIG. 26 is a control diagram of the steering system of a vehicle of the present disclosure;

FIG. 27 is a front left perspective view of a portion of a steering and braking system of the vehicle of FIG. 1;

FIG. 28 is an exploded view of a portion of a steering and braking system of the vehicle of FIG. 1;

FIG. 29 is an exploded view of a portion of the steering and braking system of FIG. 28;

FIG. 30 is a plan view of a portion of the steering and braking system in a first state, mode, or condition, such as a ‘steering non-fault’ state, of the system of FIG. 28;

FIG. 31 is a plan view of a portion of the steering and braking system in a second state, mode, or condition, such as a ‘steering fault’ state, of the system of FIG. 28;

FIG. 32 is a view of a screen layout of a display with user selectable modes of the vehicle of FIG. 1;

FIG. 33 is a graphical representation of a plurality of steering modes of the vehicle of FIG. 1;

FIG. 33A is a further graphical representation of a plurality of steering modes of the vehicle of FIG. 1;

FIG. 34 is a control diagram for calculating a requested feedback force for the steering system of the vehicle of FIG. 1;

FIG. 35 is a control diagram of an autonomous system of the vehicle of FIG. 1; and

FIG. 36 is a side view of a vehicle of the present disclosure with a suspension with a lifted rear wheel;

FIG. 37 is a cross-section of a track of the vehicle of the present disclosure;

FIG. 38 is a plan view of an interior surface of the track of FIG. 37;

FIG. 39 is a left side view of a vehicle of the present disclosure with a support structure;

FIG. 40 is a left side view of the vehicle of FIG. 39 with a cab structure;

FIG. 41 is a left side view of the vehicle of FIG. 39 with an alternate cab structure;

FIG. 42 is a left side view of the vehicle of FIG. 39 with a further alternate cab structure; and

FIG. 43 is a left side view of the vehicle of FIG. 39 with another alternate cab structure.

### DETAILED DESCRIPTION OF THE DRAWINGS

For the purposes of promoting an understanding of the principles of the present disclosure, reference is now made to the embodiments illustrated in the drawings, which are described below. The embodiments disclosed below are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

The terms “couples”, “coupled”, “coupler”, and variations thereof are used to include both arrangements wherein two or more components are in direct physical contact and arrangements wherein the two or more components are not in direct contact with each other (e.g., the components are “coupled” via at least a third component, but yet still cooperates or interact with each other).

In some instances throughout this disclosure and in the claims, numeric terminology, such as first, second, third, and fourth, is used in reference to various operative transmission components and other components and features. Such use is not intended to denote an ordering of the components. Rather, numeric terminology is used to assist the reader in identifying the component being referenced and should not be narrowly interpreted as providing a specific order of components.

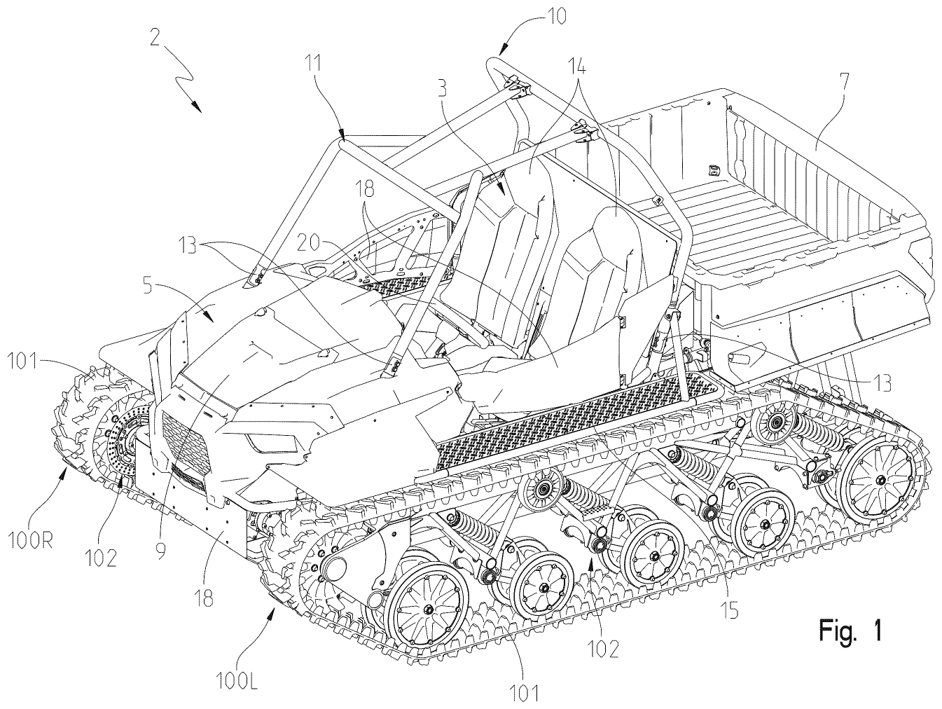

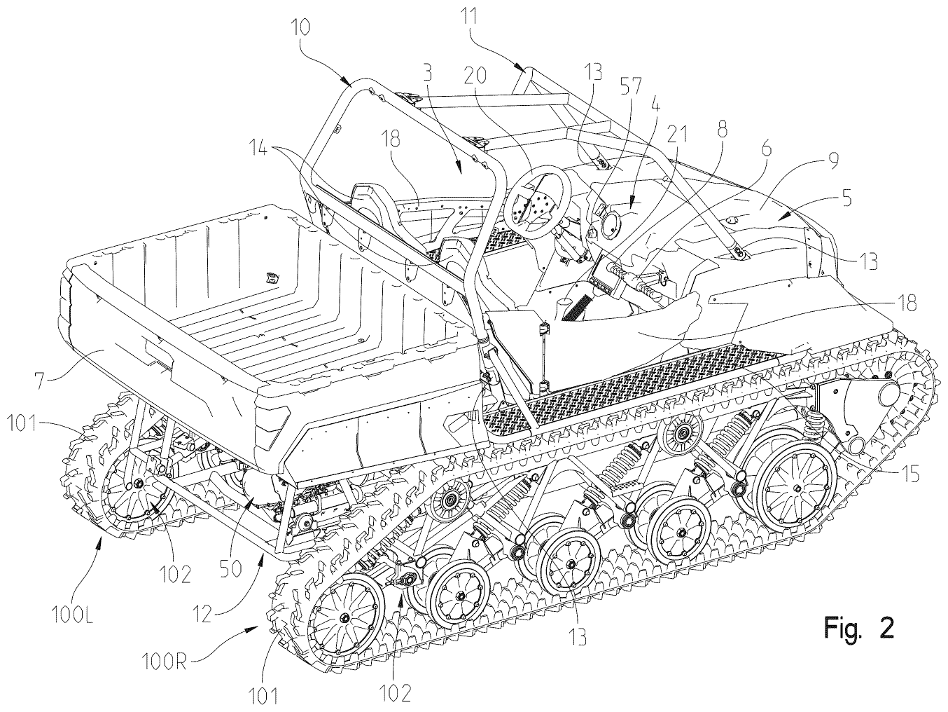

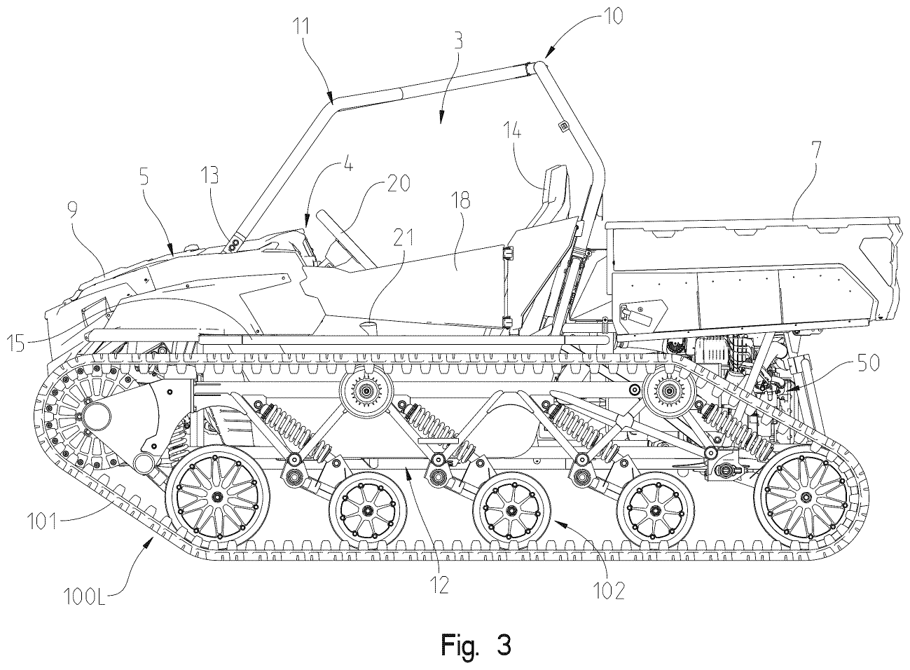

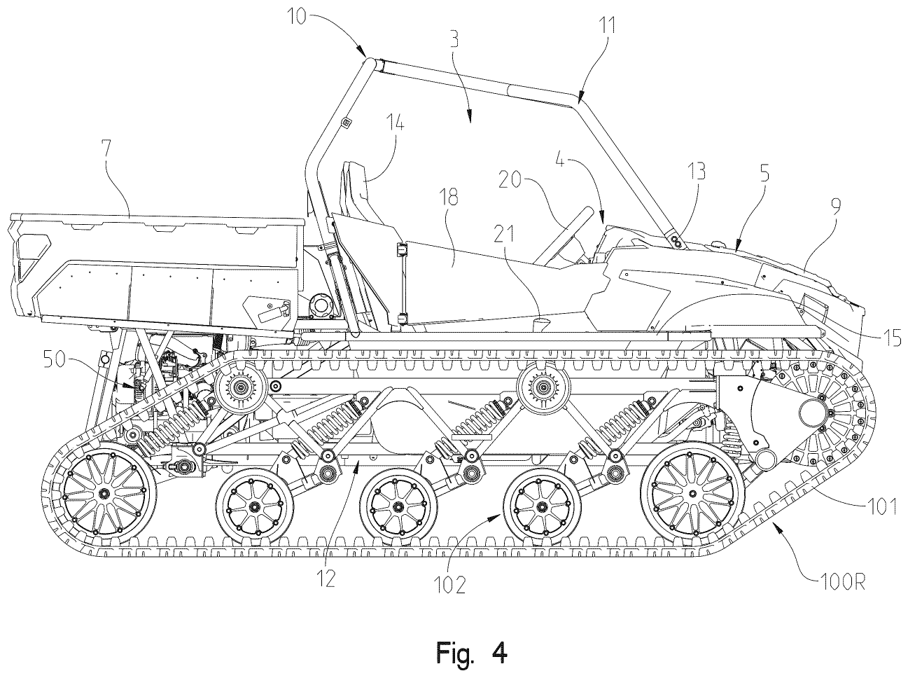

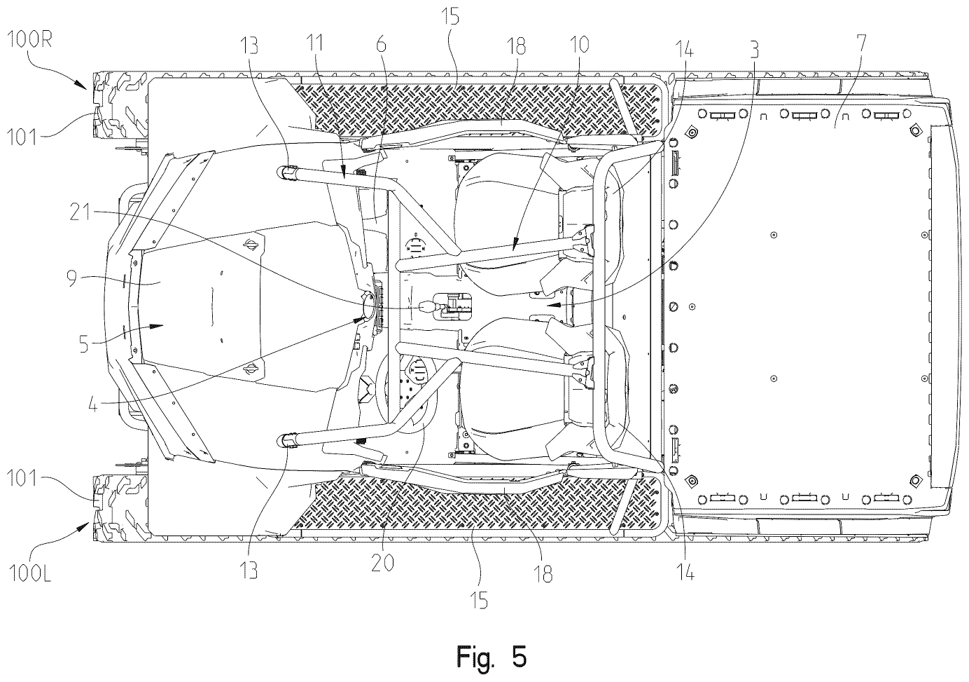

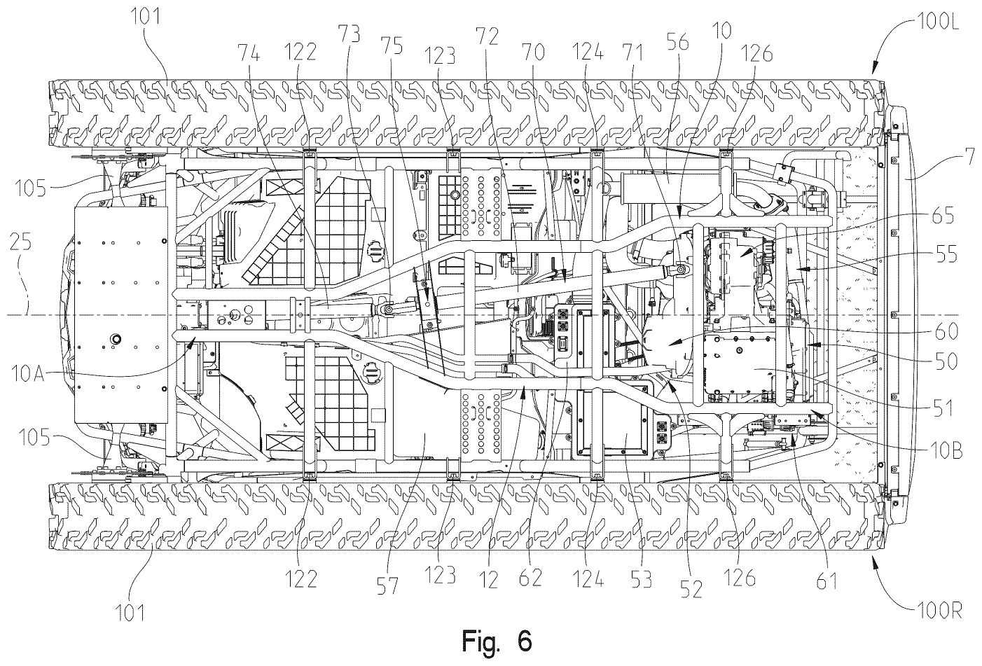

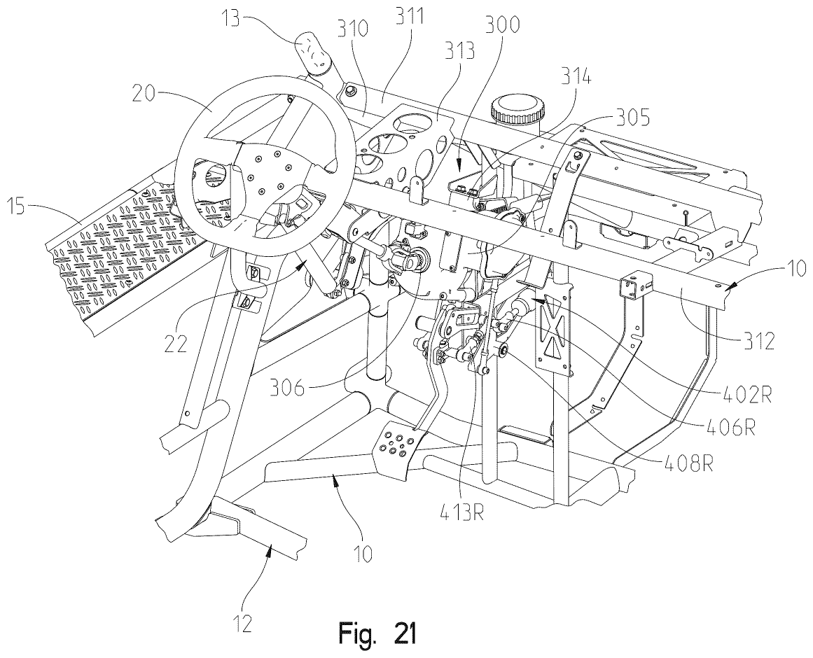

Referring to FIGS. 1-6, a vehicle 2 is provided. Vehicle 2 includes a frame 10 including an upper frame 11 and a lower frame 12. Upper frame 11 is coupled to lower frame 12 by a plurality of couplers 13, which allow upper frame 11 to be removably bolted to lower frame 12. In various embodiment, frame 10 may be a unitary piece, that is, upper frame 11 and lower frame 12 may be welded or otherwise permanently formed together. Frame 10 generally includes a front portion 10A and a rear portion 10B (FIG. 6). Lower frame 12 also includes a generally U-shaped frame member 310 (FIG. 21) positioned within front portion 10A and configured to support a pair of couplers 13 at a forward extent of upper frame 11. A first lateral member 311 (FIG. 21) extends between the U-shaped frame member 310, and a second lateral member 312 (FIG. 21) is positioned longitudinally rearward of first lateral member 311. A support member 313 (FIG. 21) extends between lateral member 311 and lateral member 312 and provides additional rigidity to frame 10. Vehicle 2 includes a body assembly 5 supported by frame 10, wherein body assembly 5 generally includes a storage box 7, a pair of doors 18, a hood 9, and other body panels which couple to and/or otherwise conceal portions of frame 10. Generally, storage box 7 is supported by lower frame 12 and is positioned at a rear portion of vehicle 2. Hood 9 is supported by lower frame 12 and is positioned at a forward portion of vehicle 2. Upper frame 11 generally surrounds an operator area 3 which is further enclosed on either side by doors 18. In some embodiments of vehicle 2, doors 18 may be removed or omitted from vehicle 2. Operator area 3 also includes at least one seat and, illustratively a pair of seats 14, including a driver seat and a passenger seat. Operator area 3 further includes a steering input 20 supported by frame 10. More specifically, steering input 20 is supported by support member 313. An adjustment assembly 22 (FIG. 21) is coupled to frame 10 and allows steering input 20 to tilt and/or telescope. Additional details regarding a tilting and telescoping steering wheel may be found in U.S. application Ser. No. 16/244,462, filed Jan. 10, 2019, now issued as U.S. Pat. No. 10,960,941, issued Mar. 30, 2021, the complete disclosure of which is expressly incorporated by reference herein.

In various embodiments, operator area 3 only comprises a single seat. In various embodiments, operator area 3 may be configured with three seats, four seats, or more seats. Operator area 3 also includes a dash assembly 4 and a grab bar 6 configured to be grasped by a passenger. Operator area 3 also includes a display 8 configured to display information, such as engine information, suspension information, audio information, or the like. Dash assembly 4 and display 8 may comprise a variety of inputs including knobs, buttons, switches, sliders, or others. In various embodiments, upper frame 11 is configured to surround operator area 3 and a portion of storage box 7. Frame 10 also includes a pair of laterally disposed foot supports 15. Illustratively, foot supports 15 extend longitudinally along the side of operator area 3 and vertically above a pair of track assemblies 100. Foot supports 15 are configured to support an operator entering and exiting operator area 3 and may have a rough tread or a corrugated surface to increase traction.

Vehicle 2 also includes a plurality of ground-engaging members. Illustratively, the ground-engaging members define a pair of track assemblies 100 configured to support frame 10, while in other embodiments, the ground-engaging members may be wheels and tires, skis, or the like. Illustratively, a left track 100L is positioned on the left side of vehicle 2 and a right track 100R is positioned on the right side of vehicle 2. In the present embodiment, left track 100L and right track 100R are substantially similar and share many similar components and, as such, where a disclosure is made to just one of tracks 100L, 100R, it is to be understood that the disclosure is equally applicable to the other of tracks 100L, 100R. Illustratively, track assemblies 100 each include a track 101 surrounding a track suspension assembly 102. Track assemblies 100L, 100R extend longitudinally along vehicle 2 at either lateral extent of vehicle 2. In the present embodiment, track assemblies 100L, 100R are non-steerable ground engaging members. As will be described in greater detail below, vehicle 2 is steered by turning one of track assemblies 100L, 100R faster or slower than the other of track assemblies 100L, 100R.

A powertrain 50 is supported by frame 10 and is positioned vertically below at least a portion of storage box 7. Powertrain 50 includes a prime mover 51 configured to provide motive force to vehicle 2. In the present embodiment, prime mover 51 is an internal combustion engine. In various embodiment, prime mover 51 may be an electric motor or other type of motor. In the present embodiment, prime mover 51 comprises at least one cylinder (not shown) and a piston (not shown) positioned therein. An intake assembly 52 includes an airbox 53 and an exhaust assembly 55 fluidly coupled to prime mover 51. In one embodiment, exhaust assembly 55 includes a silencer 56. Prime mover 51 may be operably coupled to a transmission assembly, such as a continuously variable transmission 60 which includes a drive pulley (not shown) and a driven pulley (not shown). The drive pully is coupled to an output of prime mover 51 and the driven pulley is operably coupled to a shiftable transmission 65. Shiftable transmission 65 provides a plurality of fixed gears for an operator to utilize when driving vehicle 2. Shiftable transmission 65 may be manually operated using a shifter 21 positioned within operator area 3. In various embodiments, shiftable transmission 65 is electronic, and an input on the display 8 or dash assembly 4 may shift the shiftable transmission 65 between gears. Depending on the configuration of powertrain 50, continuously variable transmission 60 and/or shiftable transmission 65 may be omitted from vehicle 2. Powertrain 50 also includes a generator 61 operably coupled to the prime mover 51.

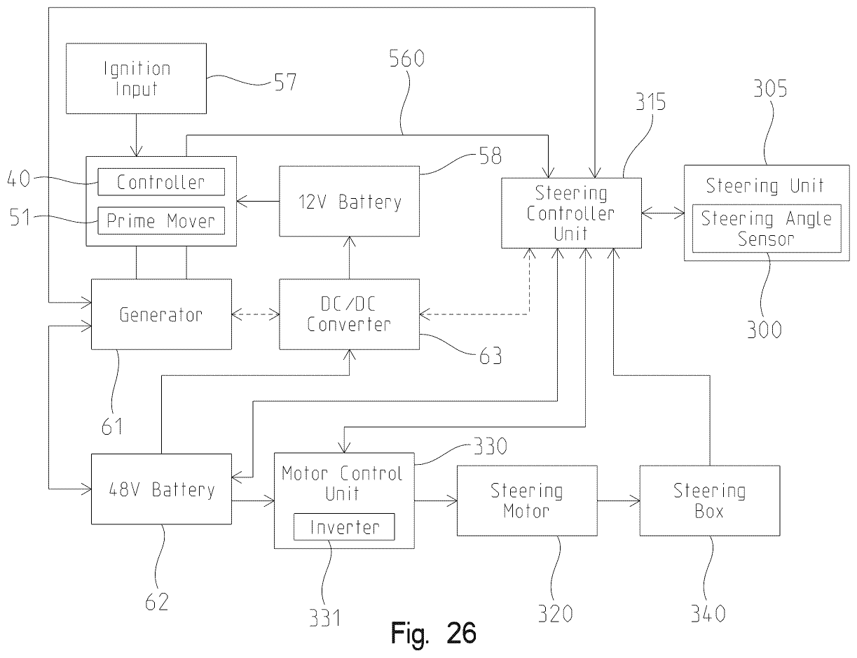

In various embodiments, referring to FIG. 26, vehicle 2 includes an ignition input 57 positioned on dash assembly 4. Ignition input 57 may be a push button, a switch, or other input. Ignition input 57 is communicably coupled to controller 40. When controller 40 receives an ignition signal from ignition input 57, controller 40 will initiate an ignition sequence for prime mover 51 and start prime mover 51. In various embodiments, as discussed more below, an ignition signal from ignition input 57 will initiate generator 61 to provide a starting force to prime mover 51. Vehicle 2 also includes a throttle input 26 operably coupled to prime mover 51. In the present embodiment, throttle input 26 provides a throttle signal to a controller 40 which provides an electronic signal to a throttle valve, a throttle body, a fuel rail, a motor controller, or other prime mover component configured to create combustion within prime mover 51. In various embodiments, throttle input 26 is mechanically coupled to prime mover 51 and an input to throttle input 26 rotates a throttle valve and changes a throttle angle 559 of prime mover 51.

Referring still to FIGS. 1-6, powertrain 50 further includes a propshaft assembly 70 and a final drive, or front drive 90. Propshaft assembly 70 extends forwardly from the shiftable transmission to final drive 90, or front drive 90. Propshaft assembly 70 couples to shiftable transmission at a CV joint 71. A first propshaft 72 extends forwardly and is angled toward a vehicle centerline 25 from joint 71. First propshaft 72 is supported by frame 10 at a carrier bearing 75. First propshaft 72 is coupled to a second propshaft 74 at a CVT joint 73, and second propshaft 74 couples to front drive 90 at front drive input 80. A pair of drive shafts 105 extend laterally outward from front drive 90 and provide rotational power to track assemblies 100

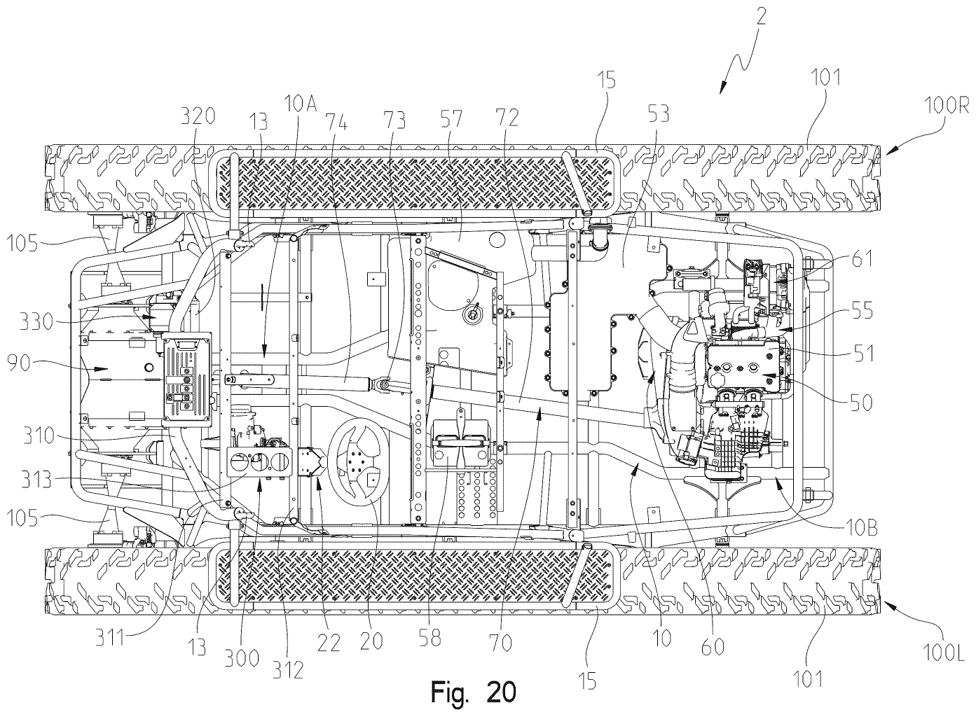

Generator 61 generally includes a rotor (not shown) and a stator (not shown). Generator 61 is rotatably or mechanically coupled to a crankshaft (not shown) of the prime mover 51 with a pulley belt or chain such that the rotation of the crankshaft is transferred to the rotor of generator 61. The rotor rotates relative to the stator, creating a magnetic field, generating an electrical current. Generator 61 is then capable of transmitting electrical power to a battery 58 (FIG. 20) or other electrical component of vehicle 2. In various embodiments, generator 61 may be directly coupled to the crankshaft of prime mover 51. In various embodiments, the rotor may be an integral part of the crankshaft.

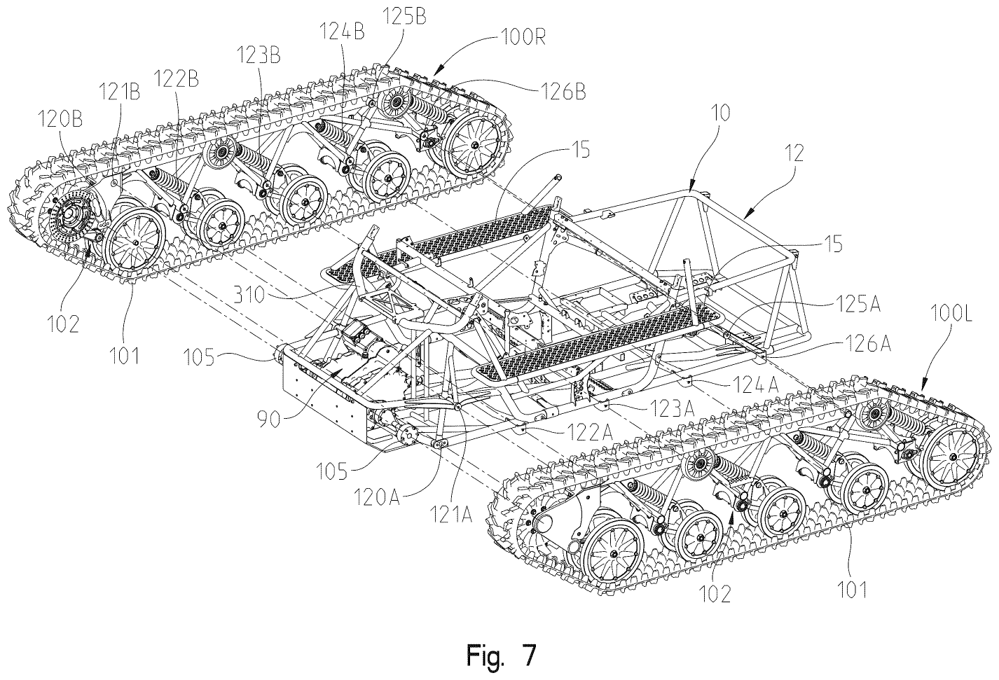

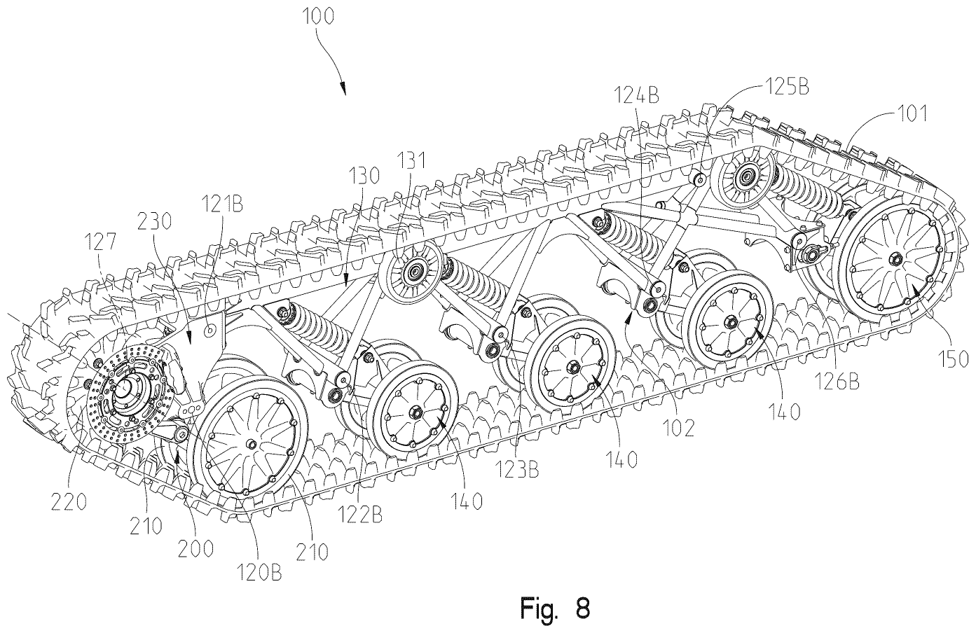

As best seen in FIGS. 7-8, track assemblies 100 are coupled to frame 10 at a plurality of mounting points. Illustratively, the frame 10 includes a plurality of mounting apertures, wherein each lateral side of frame 10 includes a first frame mounting aperture 120A, second frame mounting aperture 121A, third frame mounting aperture 122A, fourth frame mounting aperture 123A, fifth frame mounting aperture 124A, sixth frame mounting aperture 125A, and seventh frame mounting aperture 126A. Further, each track assembly 100L, 100R includes a plurality of mounting apertures, wherein each track assembly 100 includes a first track mounting aperture 120B, second track mounting aperture 121B, third track mounting aperture 122B, fourth track mounting aperture 123B, fifth track mounting aperture 124B, sixth track mounting aperture 125B, and seventh mounting aperture 126B, each corresponding to the adjacent frame mounting apertures 120A, 121A, 122A, 123A, 124A, 125A, and 126A, respectively. A plurality of fasteners (not shown) couple track assemblies 100 to frame 10 at the above-recited mounting apertures. That is, a first fastener (not shown) extends through first frame mounting aperture 120A and first track mounting aperture 120B, a second fastener (not shown) extends through second frame mounting aperture 121A and second track mounting aperture 121B, a third fastener (not shown) extends through third frame mounting aperture 122A and third track mounting aperture 122B, a fourth fastener (not shown) extends through fourth frame mounting aperture 123A and fourth track mounting aperture 123B, a fifth fastener (not shown) extends through fifth frame mounting aperture 124A and fifth track mounting aperture 124B, a sixth fastener (not shown) extends through sixth frame mounting aperture 125A and sixth track mounting aperture 125B, and a seventh fastener extends through seventh frame mounting aperture 126A and seventh track mounting aperture 126B. Track assemblies 100 are also coupled to frame 10 through drive axles 105, where drive axles 105 mount to a drive wheel 220 along a drive wheel axis 127.

Track assemblies 100 are able to be installed and removed through a limited number of fasteners that are easy to reach. In the present embodiment, each of fasteners used to mount track assemblies 100 to frame 10 are accessible on a lateral outer side of track assemblies 100. Additionally, track assemblies 100 may be removed from frame 10 so that track assemblies 100 and frame 10 may be shipped separately and/or in a more compact manner during manufacture and/or transport of vehicle 2. In the present embodiment, first frame mounting aperture 120A, second frame mounting aperture 121A and third frame mounting aperture 122A are generally positioned on the front portion 10A of frame 10, and fifth frame mounting aperture 124A, sixth frame mounting aperture 125A, and seventh frame mounting aperture 126A are generally positioned on the rear portion 10B of frame 10. Generally, fifth frame mounting aperture 124A is positioned longitudinally intermediate fourth frame mounting aperture 123A and sixth frame mounting aperture 125A.

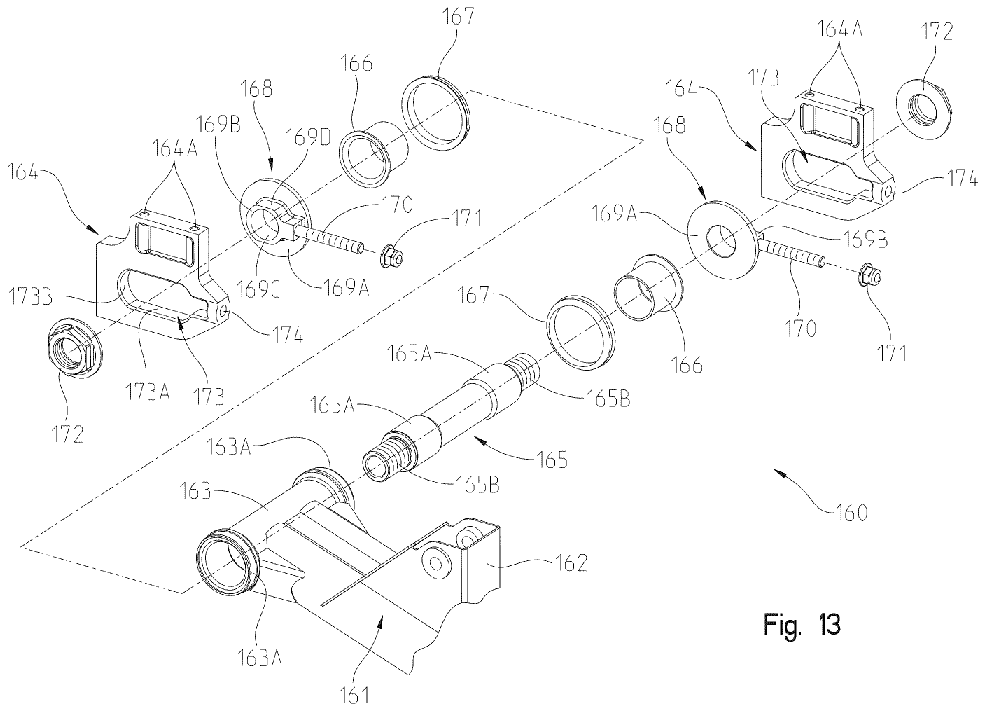

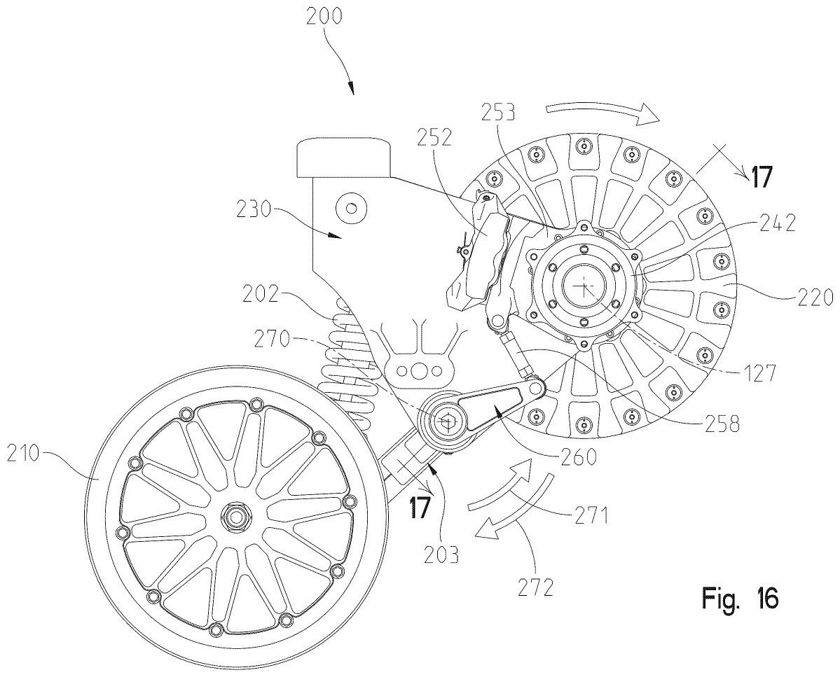

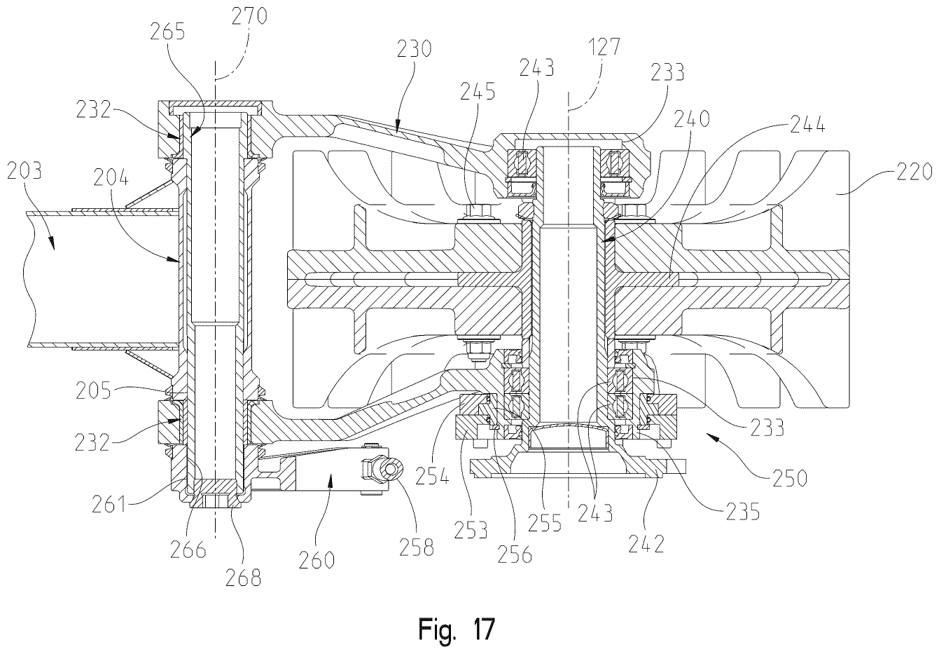

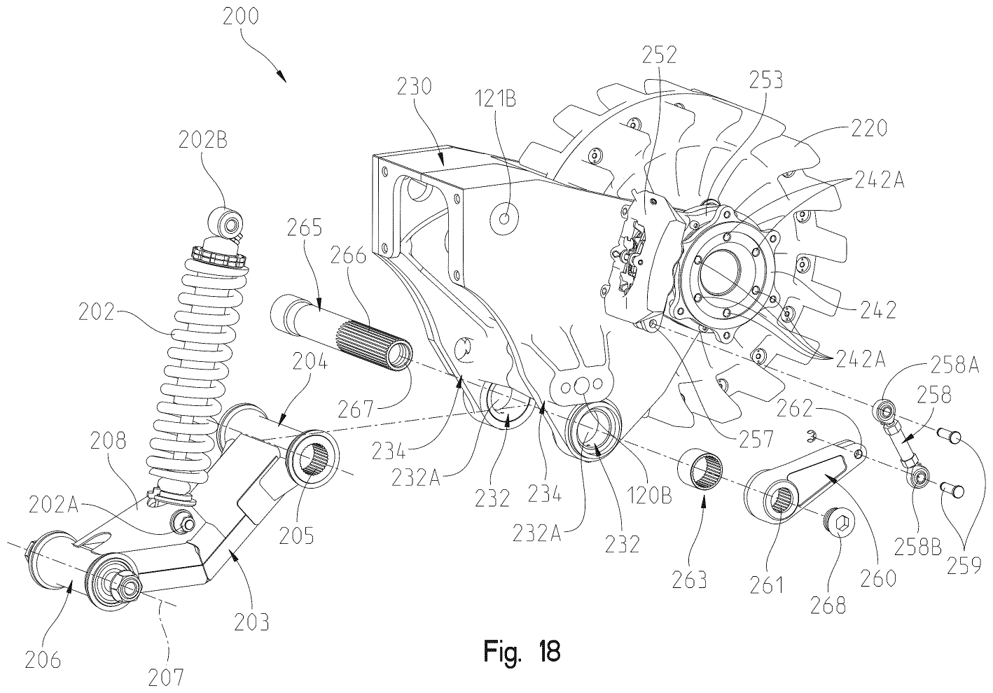

Now referring to FIGS. 7-19, track assemblies 100 will be explained in greater detail. For the purposes of this description, a single track assembly 100 will be described. Both track assemblies 100L, 100R are substantially similar, however some components may be inverted, rotated, or otherwise moved so that various mounting interfaces are appropriately situated.

Each track assembly 100 comprises track 101 surrounding track suspension assembly 102. Track suspension 102 includes a track frame 130 running along its upper extent. Track frame 130 includes third track mounting aperture 122B, fourth track mounting aperture 123B, fifth track mounting aperture 124B, sixth track mounting aperture 125B, and seventh track mounting aperture 126B and thereby couples to frame 10. A plurality of upper carrier wheels 131 are mounted to an upper portion of track frame 130 using fasteners 131A and track 101 is configured to rotate about upper carrier wheels 131. Upper carrier wheels 131 help guide track 101 and keep track 101 on the track suspension 102. Track frame 130 also includes a plurality of extensions 132 which extend generally downwardly. Extensions 132 may be coupled together with adjacent extensions 132 to generally define a triangular shape, like a truss. Illustratively, a first extension 132A is positioned forward of a second extension 132B, which is positioned forward of a third extension 132C, which is positioned forward of a fourth extension 132D. Each extension 132 includes one of the mounting points to the frame. Illustratively, first extension 132A includes third track mounting aperture 122B, second extension 132B includes fourth track mounting aperture 123B, third extension 132C includes fifth track mounting aperture 124B and fourth extension 132D includes seventh mounting aperture 126B. Further, first extension 132A includes a first receiving frame 134A, a second extension 132B includes a second receiving frame 134B, a third extension 132C includes a third receiving frame 134C, and a fourth extension 132D includes a fourth receiving frame 134D. Fourth receiving frame 134D includes a plurality of apertures 136.

Track frame 130 includes a forward mounting portion 133 positioned longitudinally forward of the first extension 132A. Mounting portion 133 is configured to couple to a drive wheel frame 230 of a drive wheel assembly 200. Forward mounting portion 133 includes a plurality of apertures 133A configured to align with a plurality of apertures 231 in drive wheel frame 230 and a plurality of fasteners (not shown) are configured to extend and couple therebetween. A plurality of lower carrier wheel assemblies 140 are coupled to the plurality of extensions 132. Illustratively, a first lower carrier wheel assembly 140A is coupled to first extension 132A, a second lower carrier wheel assembly 140B is coupled to second extension 132B, and a third lower carrier wheel assembly 140C is coupled to third extension 132C. Further, a load bearing wheel assembly 150 is positioned at a rear extent of track assembly 100 and coupled to fourth extension 132D. Illustratively, lower carrier wheel assemblies 140A, 140B, 140C are positioned intermediate load bearing wheel assembly 150 and drive wheel assembly 200.

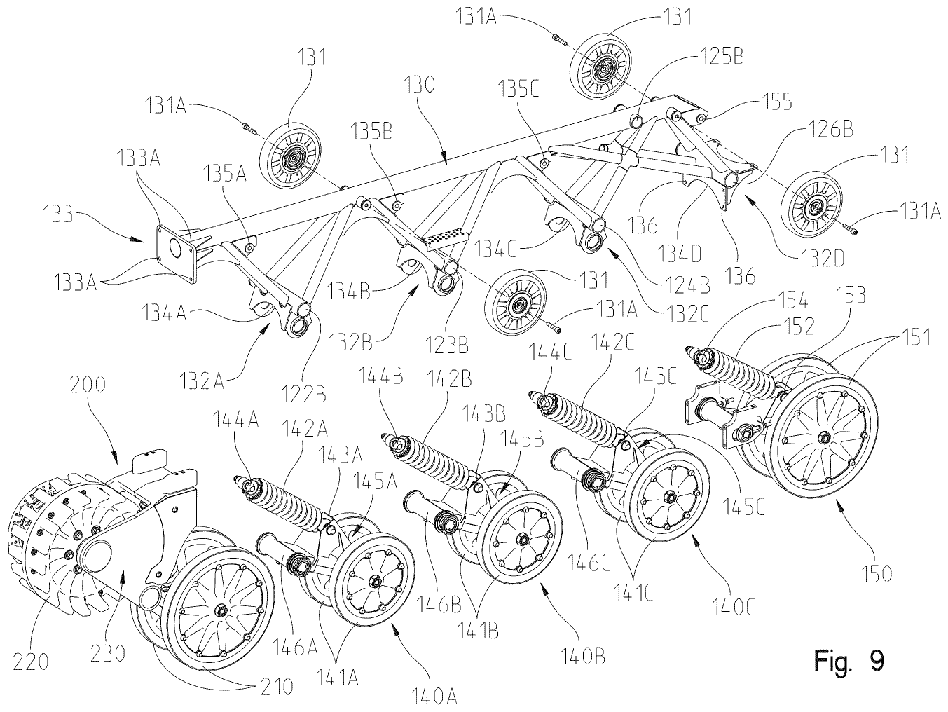

Now referring to FIG. 9, lower carrier wheel assemblies 140A, 140B, 140C will now be described in greater detail. Each of lower carrier wheel assemblies 140A, 140B, 140C are substantially similar or identical to each other. First lower carrier wheel assembly 140A includes a first swing arm 145A with a bushing assembly 146A positioned at an upper extent thereof. Bushing assembly 146A is configured to seat within receiving frame 134A. A fastener (not shown) extends through receiving frame 134A and bushing assembly 146A, allowing first swing arm 145A to rotate there about. Additionally, a first shock absorber 142A extends between a first lower mounting point 143A located on swing arm 145A and a first upper mounting point 135A. First swing arm 145A also supports a pair of first carrier wheels 141A positioned at a lower extent thereof. As such, carrier wheels 141A are able to rotate about the bushing assembly 146A, and the rotational motion of carrier wheels 141A is dampened by first shock absorber 142A about bushing assembly 146A.

Second lower carrier wheel assembly 140B includes a second swing arm 145B with a bushing assembly 146B positioned at an upper extent thereof. Bushing assembly 146B is configured to seat within receiving frame 134B. A fastener (not shown) extends through receiving frame 134B and bushing assembly 146B, allowing second swing arm 145B to rotate there about. Additionally, a second shock absorber 142B extends between a second lower mounting point 143 second located on swing arm 145B and a second upper mounting point 135B. Second swing arm 145B also supports a pair of second carrier wheels 141B positioned at a lower extent thereof. As such, carrier wheels 141B are able to rotate about the bushing assembly 146B, and the rotational motion of carrier wheels 141B is dampened by second shock absorber 142B about bushing assembly 146B.

Third lower carrier wheel assembly 140C includes a third swing arm 145C with a bushing assembly 146C positioned at an upper extent thereof. Bushing assembly 146C is configured to seat within receiving frame 134C. A fastener (not shown) extends through receiving frame 134C and bushing assembly 146C, allowing third swing arm 145C to rotate there about. Additionally, a third shock absorber 142C extends between a third lower mounting point 143C located on swing arm 145C and a third upper mounting point 135C. Third swing arm 145C also supports a pair of third carrier wheels 141C positioned at a lower extent thereof. As such, carrier wheels 141C are able to rotate about the bushing assembly 146C, and the rotational motion of carrier wheels 141C is dampened by third shock absorber 142C about bushing assembly 146C.

### Rear Idler Wheel Suspension

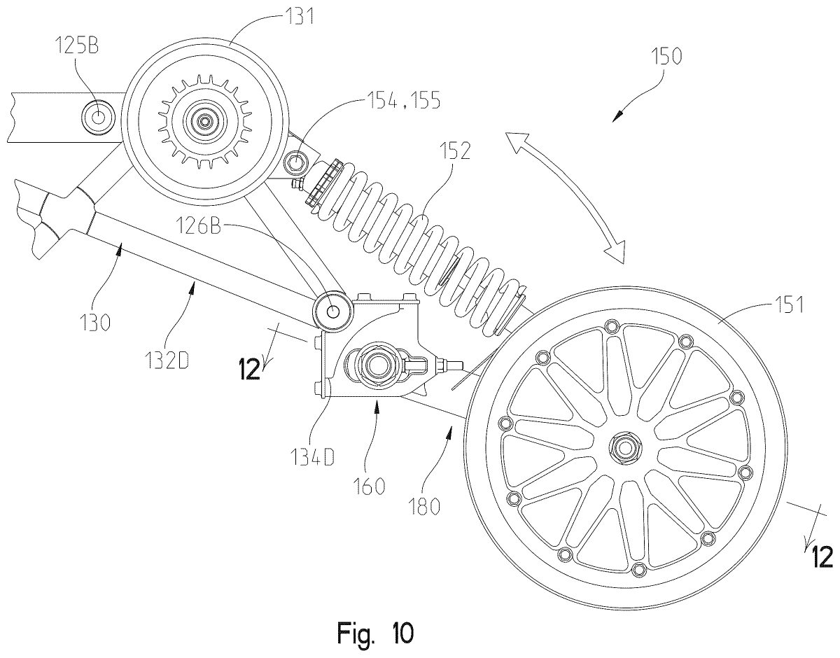

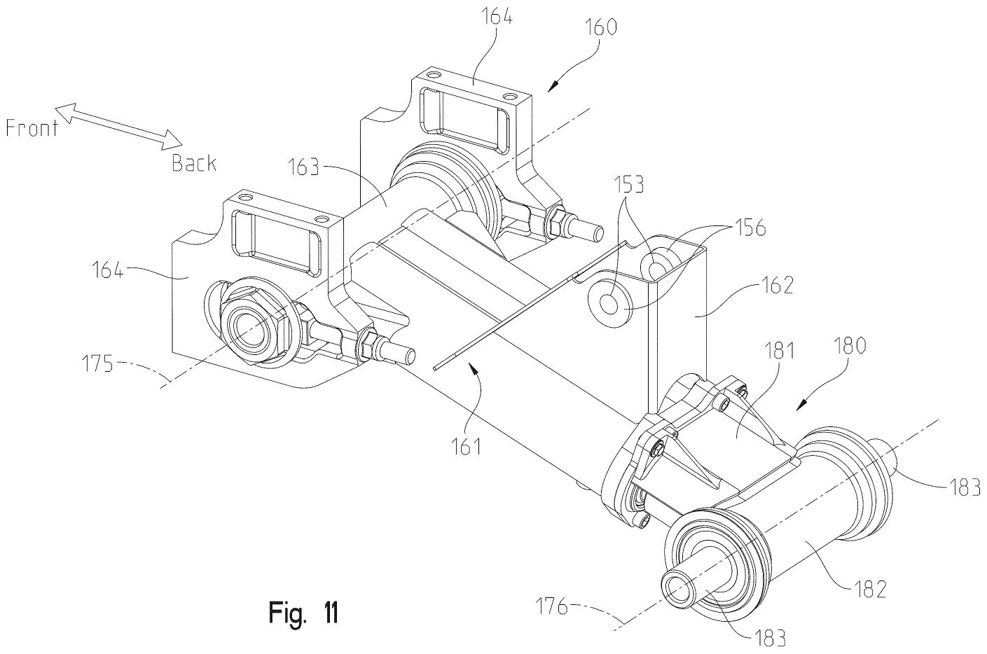

Turning now to FIGS. 10-14, load bearing wheel assembly 150 will be explained in greater detail. Illustratively, load bearing wheel assembly 150 includes a tensioner assembly 160 and a swingarm assembly 180. A pair of carrier wheels 151 are positioned at a lower rear portion of swingarm assembly 180. Tensioner assembly 160 is coupled to fourth receiving frame 134D of fourth extension 132D. Further, a shock absorber 152 couples between swingarm assembly 180 and track frame 130. As best seen in FIG. 11, tensioner assembly 160 and swingarm assembly 180 are positioned within a body member 161. Body member 161 comprises a bore 163 and a shock receiving member 181. Bore 163 is positioned at an upper and forward extent of the body member 161 and shock receiving member 181 is positioned at a lower and rear extent of the body member 161. A pair of mounting frames 164 are positioned on either side of bore 163. A shock mounting frame 162 is positioned on body member 161, and shock mounting frame 162 includes a pair of mounting apertures 153 including a pair of bushings 156. A lower extent of shock absorber 152 is positioned between mounting apertures 153, and a fastener (not shown) extends through apertures 153 and lower extent of shock absorber 152. Further, bushings 156 are configured to support shock absorber 152. A fastener (not shown) extends between mounting apertures 153 and the lower extent of shock absorber 152, and shock absorber 152 is able to rotate thereabout.

Tensioner assembly 160 includes mounting frames 164 with a plurality of apertures 164A. A plurality of fasteners 137 extend through aperture 136 (FIG. 9) of receiving frame 134D and apertures 164A of mounting frames 164 to couple mounting frames 164 to receiving frame 134D. Mounting frames 164 also include an adjustment opening 173 generally in the shape of a geometric stadium. That is, the geometric stadium may be illustratively defined as a generally rectangular shape with a longitudinal side 173A which is greater than a vertical side 173B. Generally, each vertical side 173B comprises a semi-circle spanning the height of the vertical side 173B at either end of longitudinal side 173A. Further, mounting frames 164 each include an aperture 174 which is nominally perpendicular to opening 173. Illustratively, bore 163 extends the lateral width between mounting frames 164, and is generally aligned with openings 173. A shaft 165 is configured with a first diameter, and shaft 165 has a pair of raised portions 165A comprising a second diameter, wherein the second diameter is greater than the first diameter. Shaft 165 extends through bore 163 and each opening 173 such that shaft 165 extends from one of the mounting frames 164 to the other of the mounting frames 164. A pair of bushings 166 extends within either side of bore 163 and interfaces with raised portions 165A to provide a low-friction rotational surface for body member 161 about shaft 165. Further, bore 163 includes a pair of laterally disposed raised surfaces 163A on an outside thereof. A pair of seals 167 are positioned along raised surfaces 163A and configured to provide a sealed interface between bore 163 and an adjustment screw 168. Further, each end of shaft 165 includes a threaded portion 165B. When in an installed configuration, threaded portion 165B extends outwardly past mounting frames 164, and a nut 172 screws on to threaded portions 165B to secure the adjustment assembly 160.

Adjustment screw 168 includes a face 169A and an extension 169B extending outward from face 169A. A bore 169C extends through face 169A and extension 169B and is commensurately sized with shaft 165 such that shaft 165 may pass through bore 169C. Extension 169B is shaped and sized to fit within opening 173. Extension 169B has a flat side 169D configured to contact the opening long side 173A. Flat side 169D is shorter than opening long side 173A allowing extension 169B, and adjustment screw 168, to move within opening 173. Adjustment screw 168 also includes a threaded portion 170 configured to extend through aperture 174 when in an installed state. A nut 171 screws on to threaded portion 170 thereby coupling adjustment screw 168 to mounting frame 164. When in an installed configuration, adjustment screw 168 is positioned laterally intermediate bushing 166 and mounting frames 164.

In the present embodiment, nut 171 may be screwed to a position along any length of threaded portion 170. Positioning nut 171 further onto threaded portion 170 means extension screw 168 will be brought closer to nut 171 and positioned further back within opening 173. Positioning nut 171 closer to the end of threaded portion 170 means extension screw 168 will be positioned further from nut 171 and positioned further forward within opening 173. Adjustment screw 168 supports shaft 165 and bore 163, and as adjustment screw 168 is moved forwardly, so are shaft 165 and bore 163 moved forwardly, and as adjustment screw 168 is moved backward or rearwardly, so are shaft 165 and bore 163 moved rearwardly. As will be explained in greater detail below, this movement or adjustment via adjustment screw 168 shifts the position of carrier wheels 151 and alters the tension on track 101.

In the present embodiment, each of mounting frames 164 comprises an adjustment screw 168. In various embodiment, only one of mounting frames 164 comprises an adjustment screw 168 and the adjustment of the one adjustment screw 168 adjusts the entire adjustment assembly 160 and load bearing wheel assembly 150. In the present embodiment, an adjustment axis 175 is created about the longitudinal axis of the shaft, and the adjustment axis 175 adjusts with the adjustment of the adjustment assembly 160. In various embodiments, another type of tensioner assembly may be used in place of adjustment assembly 160.

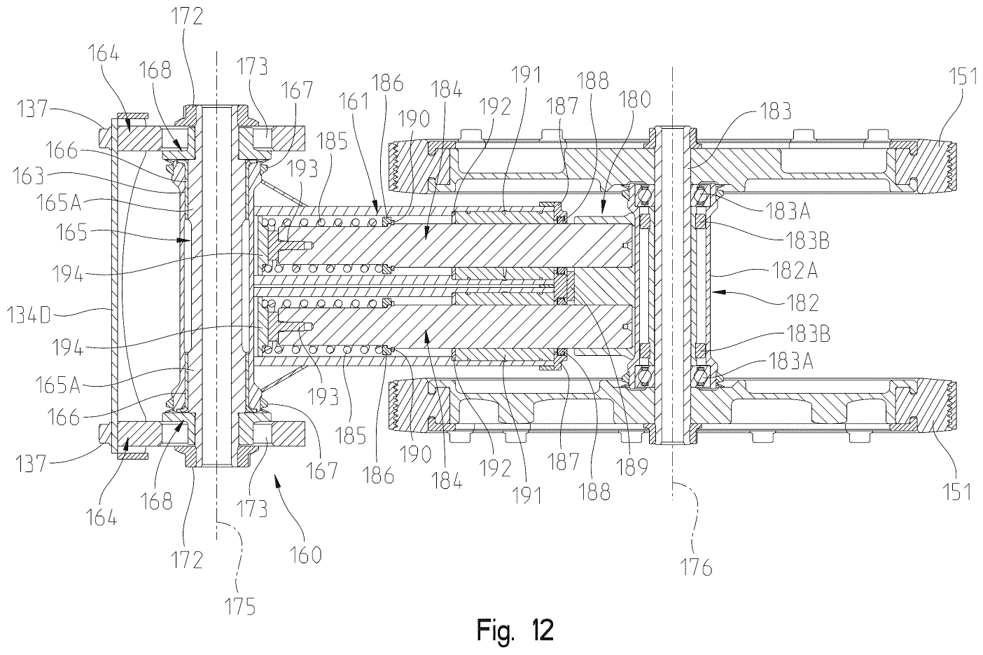

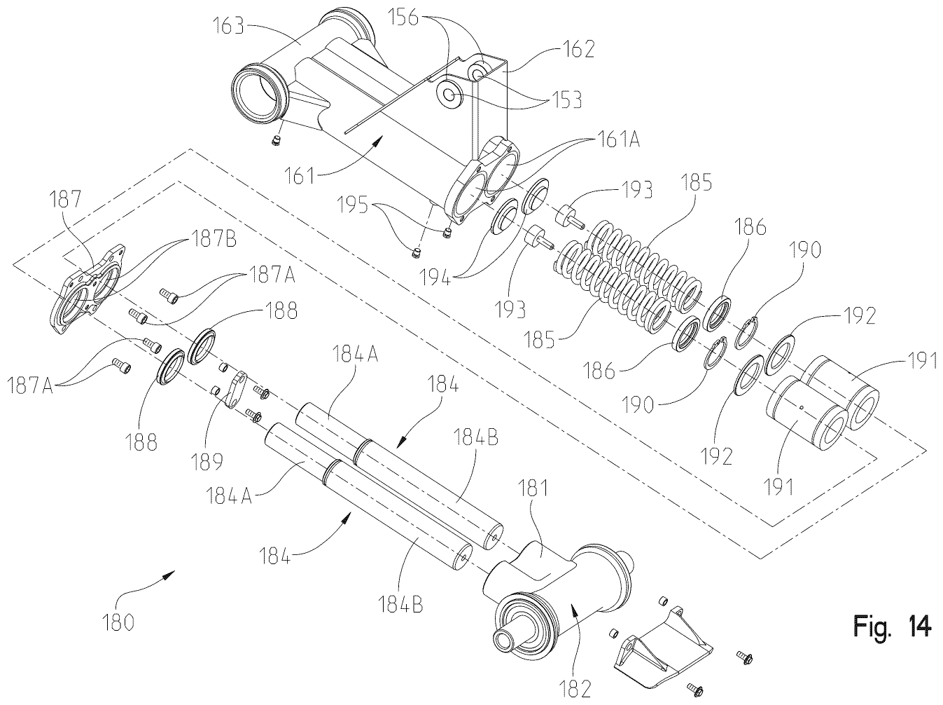

Referring now to FIGS. 12 and 14, swingarm assembly 180 will now be explained in greater detail. Swingarm assembly 180 includes receiving member 181 coupled to body member 161. Body member 161 includes a pair of tube receiving areas 161A. Illustratively, a pair of rods 184 are positioned within tube receiving areas 161A and received by receiving member 181. In the present embodiment, rods 184 are solid rods with a first body portion 184A and a second body portion 184B. Further, first body portion 184A and second body portion 184B are both generally cylindrical with a circular circumference, and the first body portion 184A has a smaller diameter than the second body portion 184B. A retaining clip 190 and a bumper plate 186 are positioned at the interface of first body portion 184A and second body portion 184B. Swingarm assembly 180 also includes a pair of springs 185 surrounding rods 184, and more specifically first body portion 184A. A pair of support plates 194 and a pair of alignment plates 193 are positioned at an inner end of tube receiving areas 161A, and springs 185 extend between support plates 194 and bumper plate 186. Further, rods 184 are received by alignment plates 19.

Still referring to FIGS. 12 and 14, in various embodiments, rods 184 may be switched with shock absorbers 184. Swingarm assembly 180 includes receiving member 181 coupled to body member 161. Illustratively, shock bodies 184 are positioned within tube receiving areas 161A and received by shock receiving member 181. Shock bodies 184 include a first body portion 184A and a second body portion 184B. First body portion 184A and second body portion 184B are configured to move relative to one another, and first body portion 184A is nested within second body portion 184B. Shock bodies 184 are a telescoping shock assembly. That is, second body portion 184B has a greater diameter than first body portion 184A. Retaining clip 190 and bumper plate 186 are positioned at the interface of first body portion 184A and second body portion 184B. Swingarm assembly 180 also includes springs 185 surrounding shock bodies 184, and more specifically first body portion 184A. A pair of support plates 194 and alignment plates 193 are positioned at an inner end of tube receiving areas 161A, and springs 185 extend between support plates 194 and bumper plate 186. Further, shock bodies 184 are received by alignment plates 19. Each of first body portion 184A and second body portion 184B may be filled with a gas or fluid like substance, such as air, oil, water, or another low-compressible air or fluid. Springs 185 are biased to push outward against both support plates and bumper plates 186, and bumper plates are indirectly coupled to second body portion 184B, thereby biasing second body portion 184B toward a fully extended position.

Swingarm assembly 180 also includes a backer plate 187 positioned adjacent the opening of tube receiving area 161A. Backer plate 187 is coupled to body member 161 by a plurality of fasteners 187A. Backer plate 187 includes a pair of apertures 187B configured to allow second body portions 184B to pass through. Further, a pair of seals 188 are positioned around apertures 187B to prevent debris from entering tube receiving area 161A.

Swingarm assembly 180 also includes a bearing sleeve 191 configured to prevent at least a degree or amount of bottom out of shock bodies 184 when second body portion 184B is moving away from first body portion 184A or when second body portion 184B is moving towards first body portion 184A. A bottom out condition occurs when second body portion 184A and first body portion 184B move to their furthest extents, apart from each other, or close to each other, thereby limiting the available amount of travel available within shock bodies 184. A bottom out may occur when vehicle 2 experiences an airborne condition and lands with a large force on the ground surface. Bearing sleeve 191 is supported by backer plate 187 and positioned within tube receiving area 161A. A retaining washer 192 is positioned between bearing sleeve 191 and spring 185 to maintain damper in a fixed position relative to body member 161. That is, if second body portion 184B moves too fast or too far away from first body portion 184A, spring 185 and bumper plate 186 will contact bearing sleeve 191 and slow second body portion 184B from extending away from first body portion too fast. Bearing sleeve 191 may be made of an elastomeric material, such as rubber, to create an appropriate damping profile.

Additionally, a damper 189 may be fixed to backer plate 187 to prevent a severe bottom out of shock bodies 184 when second body portion 184B is moving toward first body portion 184A. Damper 189 is supported by backer plate and supported outside of tube receiving area 161A. That is, if second body portion 184B moves too fast or too close to first body portion 184A, shock receiving member 181 will contact damper 189 instead of backer plate 187, preventing damage to backer plate 187. Damper 189 may be made of an elastomeric material, such as rubber, to create an appropriate damping profile.

Further, an axle assembly 182 is coupled to shock receiving member 181. Axle assembly 182 includes a bore 182A and an axle 183 supported by a pair of bearings 183A and a pair of bushings 183B within the bore 182A. Each end of axle 183 supports carrier wheels 151 and allows carrier wheels 151 to rotate about a load wheel axis 176. Illustratively, axle assembly 182 receives each of axle 183 and portions of shock bodies 184.

In the present embodiment, an operator of vehicle 2 may alter the position of adjustment assembly 160 to change the tension in track 101. In one example, adjustment screw 168 is moved rearwardly, and all of load bearing wheel assembly 150 is moved rearwardly, increasing the tension of track 101. In another example, adjustment screw 168 is moved forwardly, and all of load bearing wheel assembly 150 is moved forwardly, decreasing the tension of track 101. This is an additional level of tuning within track suspension 102 which provides an enhanced level of driving comfort while operating vehicle 2. Further, because swingarm assembly 180 includes a telescoping shock assembly, swingarm assembly 180, and thus carrier wheels 151, are able to move forwardly and rearwardly during operation of vehicle 2. In one example, when vehicle 2 slows down, there is a tendency for vehicle 2 to tip forwardly, or dive in, decreasing the tension of track 101 around carrier wheels 151. Swingarm assembly 180 is able to telescope outward during a dive-in event, thereby increasing the tension of track 101 and increasing the comfort of vehicle 2 during operation.

### Front Carrier Wheel-Anti-Dive

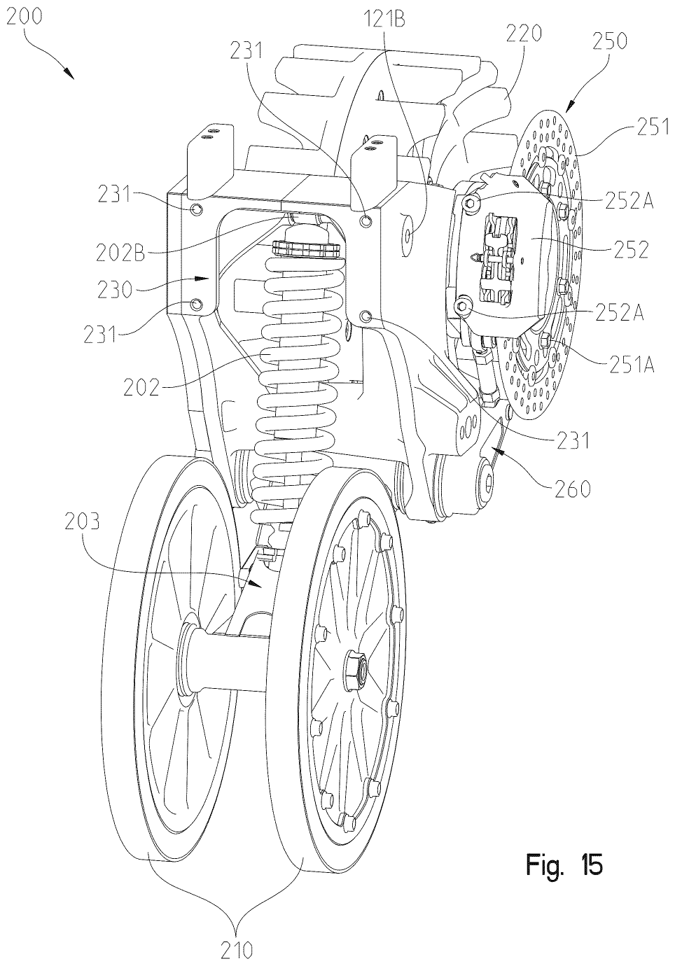

Now referring to FIGS. 15-18, drive wheel assembly 200 will be described in greater detail. Drive wheel assembly 200 includes drive wheel frame 230 with apertures 231. Frame 230 includes a pair of arms 234 which extend generally downwardly. Each of arms 234 comprises a bearing assembly 232. Bearing assemblies 232 surround an opening 232A, and a swingarm axis 270 is defined between the openings 232A. A shaft 265 extends along swingarm axis 270 and is supported by bearing assemblies 232. Shaft 265 includes an external splined portion 266 and an internal threaded portion 267 at an end thereof. Frame 230 also includes an upper mounting point 202B positioned vertically higher than bearing assemblies 232. Frame 230 also includes a pair of drive axle bores 233 positioned forward of bearing assemblies 232.

A swing arm 203 includes a bore 204 with an internal splined portion 205. Bore 204 is configured to extend between arms 234, and shaft 265 extends through bore 204 and splined portion 205. Splined portion 205 engages splined portion 266, thereby rotatably coupling shaft 265 and swing arm 203. Swing arm 203 also includes an axle assembly 206 configured to support a pair of carrier wheels 210. Carrier wheels 210 are configured to guide track 101 as it rotates about suspension 102. Axle assembly 206 may include a plurality of bearings, bushings, or other components to allow for carrier wheels 210 to freely rotate about carrier wheel axis 207. Swing arm 203 also includes a shock mounting portion 208 which includes a lower mounting point 202A. Illustratively, a shock absorber 202 extends between lower mounting point 202A and upper mounting point 202B.

Drive wheel assembly 200 also includes a drive axle 240 with an integrated hub 242 at an inner end thereof. Hub 242 includes a plurality of apertures 242A, and drive shaft 105 is configured to mount to hub 242 at a plurality of apertures 242A. Drive axle 240 extends between drive axle bores 233. A plurality of bearings 243 are placed within drive axle bores 233, which support drive axle 240 and allow drive axle 240 to rotate about drive wheel axis 127. A drive wheel 220 is coupled to a bushing 244 by fasteners 245. Drive wheel 220 and bushing 244 are positioned on drive axle 240 between drive axle bores 233. In the present embodiment, drive wheel 220 is a cog wheel configured to engage projections (not shown) of track 101 and provide rotational force to track 101, thereby providing motive force to vehicle 2.

Frame 230 includes a collar 235 extending around inner drive axle bore 233. Collar 235 extends around drive wheel axis 127 and surrounds a pair of bearings 243. A spacer 255 is positioned around collar 235 and supports a first rotational support 253 and a second rotational support 254. Illustratively, a brake caliper 252 is coupled to first rotational support 253 by a plurality of fasteners 252A. First rotational support 253 and second rotational support 254 are floating members, that is, they are free to rotate about spacer 255. In various embodiments, spacer 255 may be a low-friction material, or may be treated with a low-friction treatment, or may be otherwise lubricated to create a low-friction surface.

Drive wheel assembly 200 also includes a brake assembly 250. Brake assembly 250 includes brake caliper 252 and a brake disc 251. Brake disc 251 is coupled to hub 242 by a plurality of fasteners 251A. Brake caliper 252 also includes an aperture 257 at a bottom extent thereof. A link 258 includes a first end 258A and a second end 258B. In the present embodiment, first end 258A and second end 258B may be threaded into link 258 such that first end 258A and second end 258B may have a variety of positions, thereby increasing or decreasing the overall length of link 258. An arm 260 includes a splined aperture 261 and a second aperture 262. A fastener 259 extends through first end 258A of link 258 and apertures 257 and couples link 258 to caliper 252. A fastener 259 extends through second end 258B of link 258 and second aperture 262 and couples link 258 to arm 260.

A spacer bushing 263 has a splined inner circumference and is placed within the inner bearing assemblies 232. Shaft 265 extends through both bearing assemblies 232, and spacer bushing 263 becomes rotatably coupled to shaft 265. An outer end of shaft 265 extends past the inner bearing assembly 232 and splined aperture 261 slides onto external splined portion 266. That is, arm 260 becomes rotatably coupled to shaft 265. Further, a threaded cap 268 screws into internal threaded portion 267 thereby restraining arm 260 from moving off of shaft 265.

Within drive wheel assembly 200, movement between swing arm 203 and brake caliper 252 is transferred by rigid connections. That is, swing arm 203 is rotatably coupled to shaft 265, which is rotatably coupled to arm 260. Arm 260 is rigidly coupled to link 258, which is fastened to brake caliper 252. If carrier wheels 210 move upward, swing arm 203 rotates rearwardly and upwardly in rotational direction 272, and shaft 265 is rotated in rotational direction 272 with swing arm 203. As shaft 265 is rotated in rotational direction 272, arm 260 is also rotated in rotational direction 272, and link 258 is pulled downward. As link 258 is pulled downward, caliper 252 is able to be pulled downward because it is floating about drive axle 240.

In operation of vehicle 2, when an operator utilizes the braking system, rapid slow down occurs. This often occurs with a dive-in, where the nose of the vehicle dives downwardly, especially in a situation of rapid or hard braking. When brake caliper 252 is actuated, a rigid connection will be created between drive axle 240 and carrier wheels 210. That is, upon receiving a braking signal, or receiving braking fluid from the braking system, brake caliper 252 is actuated and grasps onto brake disc 251. Brake disc 251 is fastened to drive axle 240 at hub 242 and, therefore, brake caliper 252 is effectively slowing the rotation of drive axle 240. When brake caliper 252 grasps onto brake disc 251, it no longer is floating about drive axle 240 and is instead temporarily fixed to brake disc 251 and drive axle 240. Further, a rigid connection is then created from the brake caliper 252, through the link 258, the arm 260, shaft 265, swing arm 203, and carrier wheels 210. That is, when braking occurs, carrier wheels 210 are prevented, or substantially impeded, from rotating upward in direction 272, and the dive-in scenario is mitigated or prevented.

### Active Track Suspension

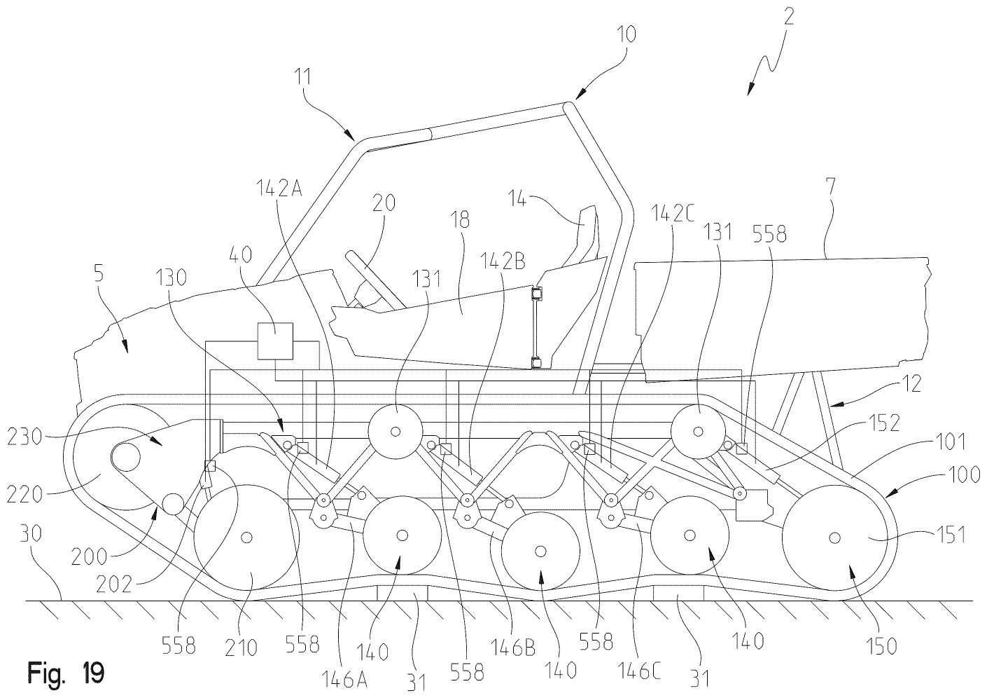

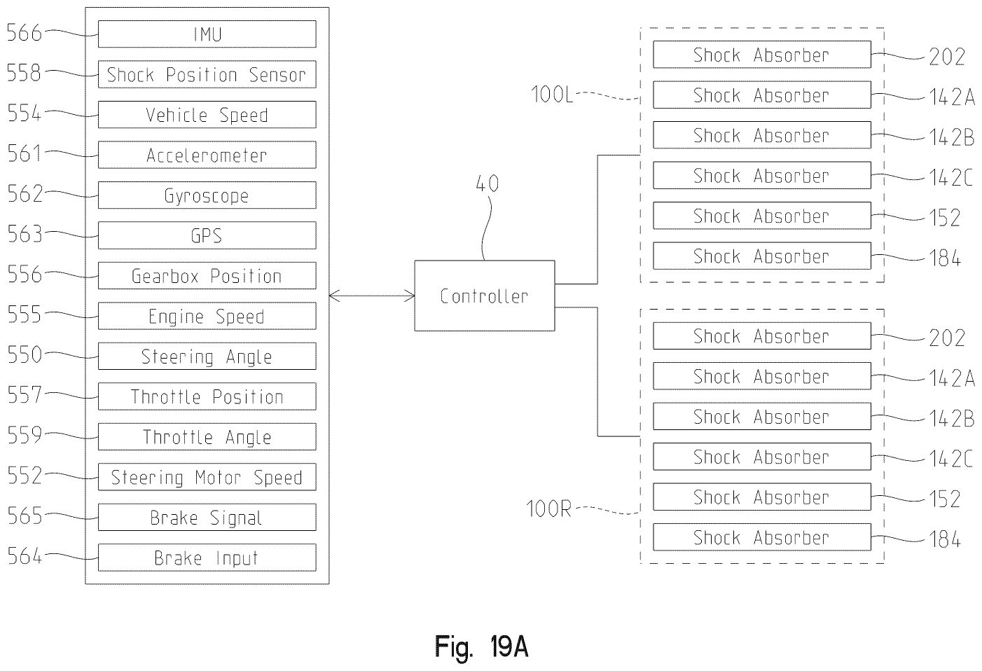

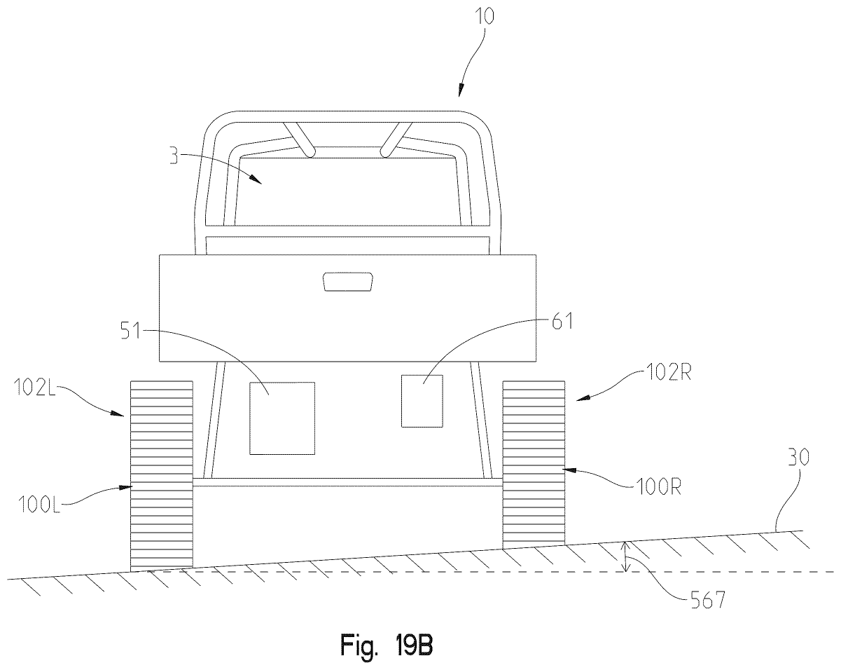

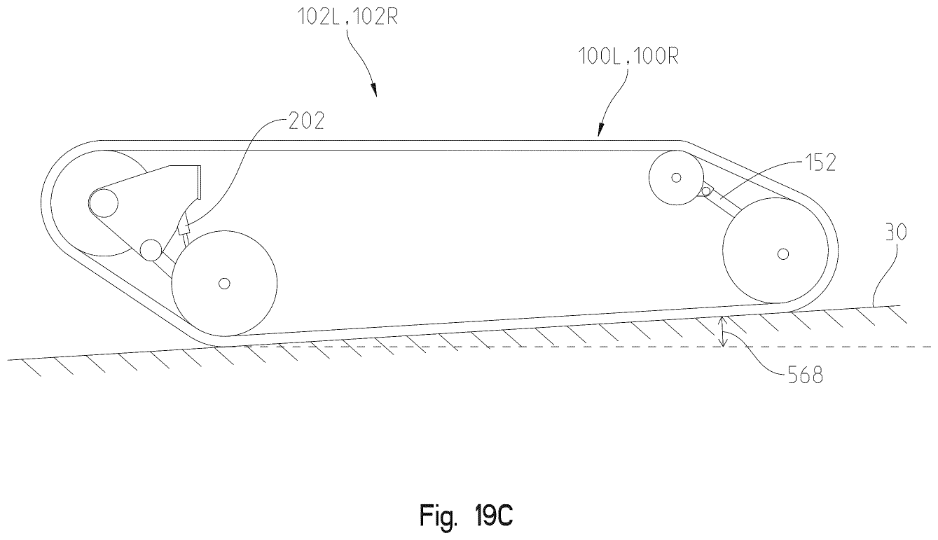

Turning now to FIGS. 19-19A, vehicle 2 is shown traversing over a ground surface 30 which includes a plurality of ground obstructions 31. Track assemblies 100L, 100R move over ground 30 and over ground obstructions 31. Each of drive wheel assembly 200, first lower carrier wheel assembly 140A, second lower carrier wheel assembly 140B, third lower carrier wheel assembly 140C, and load bearing wheel assembly 150 engages ground 30 and obstructions 31 at carrier wheels 210, first carrier wheels 141A, second carrier wheels 141B, third carrier wheels 141C, and carrier wheels 151, respectively. That is, each of drive wheel assembly 200, first lower carrier wheel assembly 140A, second lower carrier wheel assembly 140B, third lower carrier wheel assembly 140C, and load bearing wheel assembly 150 are level with ground 30, and when any of drive wheel assembly 200, first lower carrier wheel assembly 140A, second lower carrier wheel assembly 140B, third lower carrier wheel assembly 140C, and load bearing wheel assembly 150 encounter an obstruction, the respective carrier wheel is configured to articulate upwardly to accommodate the obstruction.

In the present embodiment, each track assembly 100L, 100R includes track suspension assembly 102, which includes shock absorber 202, first shock absorber 142A, second shock absorber 142B, third shock absorber 142C, and shock absorber 152 which are any of a pneumatic shock absorber, a twin tube shock absorber, a remote reservoir shock absorber or any other type of shock absorber. Further, each of shock absorbers, or biasing members 202, 142A, 142B, 142C, and 152 may be an adjustable shock absorber having an adjustable damping characteristic. That is, each of shock absorber 202, first shock absorber 142A, second shock absorber 142B, third shock absorber 142C, and shock absorber 152 may have a damping characteristic adjusted by an input, such as a ‘clicker’ on the shock body, an input on the dash assembly 4, an input on the display 8, or an input on the steering input 20. Each of shock absorber 202, first shock absorber 142A, second shock absorber 142B, third shock absorber 142C, and shock absorber 152 is electronically coupled to electronic controller 40. Electronic controller 40 may also be configured to receive a plurality of inputs, including a vehicle speed 554, an engine speed, or prime mover speed 555, a throttle position 557, a throttle angle 559, a steering angle 550, a steering motor speed 552, a gearbox position 556, a steering motor speed 552, a shock position sensor 558, a brake input sensor 564, and a brake input 565. Electronic controller 40 may also be coupled to an Inertial Measurement Unit (“IMU”) 566, an accelerometer 561, a gyroscope 562, or another vehicle orientation sensor. Electronic Controller 40 may also be coupled to a Global Positioning System (“GPS”) 563.

In various embodiments, each of shock absorber 202, first shock absorber 142A, second shock absorber 142B, third shock absorber 142C, and shock absorber 152 has an adjustable compression damping characteristic. In various embodiments, each of shock absorber 202, first shock absorber 142A, second shock absorber 142B, third shock absorber 142C, and shock absorber 152 has an adjustable rebounding damping characteristic. In various embodiments, each of shock absorber 202, first shock absorber 142A, second shock absorber 142B, third shock absorber 142C, and shock absorber 152 may be an adjustable shock absorber with an adjustable compressing damping characteristic and an adjustable rebound damping characteristic. That is, each of shock absorber 202, first shock absorber 142A, second shock absorber 142B, third shock absorber 142C, and shock absorber 152 may have the ability to be individually controlled to have a different damping characteristic from the others. A shock position sensor 558 may be positioned adjacent each of shock absorber 202, first shock absorber 142A, second shock absorber 142B, third shock absorber 142C, and shock absorber 152 which measures a position of the shock absorber. Each shock position sensor 558 is electronically coupled to electronic controller 40 and provides a shock position value from each of shock absorber 202, first shock absorber 142A, second shock absorber 142B, third shock absorber 142C, and shock absorber 152 at a high frequency. Exemplary frequencies are 5 HZ, 10 HZ, 30 HZ, 60 HZ, or other frequency.

Vehicle 2 may be operable in a plurality of drive modes. Each drive mode may include a pre-determined throttle map, braking map, torque map, compression damping map or rebound damping map. A throttle map outputs a throttle valve opening based upon a throttle input signal. A braking map outputs a brake torque request that may be based upon a brake input sensor, a steering angle, a target brake torque, a target speed, or other value. A torque map may provide a target torque output based upon a gearbox position, an engine speed, a steering angle, or a target speed. A compression damping map and a rebound damping map may provide a damping characteristic for one of, or each of, a compression damping characteristic and a rebound damping characteristic based upon any of vehicle speed 554, engine speed 555, throttle position 557, throttle angle 559, steering angle 550, steering motor speed 552, gearbox position 556, brake input sensor 564, brake signal 565, accelerometer 561, IMU 566, gyroscope 562, or other input.

A user may select a user selectable drive mode on display 8, using an input on dash assembly 4, or using an input on steering input 20. Additional details regarding drive modes, adjustable shock absorbers, and methods of adjusting a suspension can be found in U.S. application Ser. No. 14/074,340, filed Nov. 7, 2013, now issued U.S. Pat. No. 9,662,954, issued May 30, 2017; U.S. application Ser. No. 14/507,355, filed Oct. 6, 2014, now issued U.S. Pat. No. 9,205,717, issued Dec. 8, 2015; U.S. application Ser. No. 15/618,793, filed Jun. 9, 2017, now issued U.S. Pat. No. 10,406,884, issued Sep. 10, 2019; U.S. application Ser. No. 15/816,368, filed Nov. 17, 2017, now issued U.S. Pat. No. 11,110,913, issued Sep. 7, 2021; U.S. application Ser. No. 16/198,280, filed Nov. 21, 2018, now issued U.S. Pat. No. 10,987,987, issued Apr. 27, 2021; U.S. application Ser. No. 17/379,675, filed Jul. 19, 2021, published as US20,220016949A1; and U.S. application Ser. No. 17/325,062, filed May 19, 2021, published as US20,210362806A1, the entire disclosures of which are expressly incorporated herein.

In the present embodiment, electronic controller 40 is configured to adjust one or both of the compression damping characteristic and rebound damping characteristic when vehicle 2 is detected to be in one of an acceleration condition or a braking condition. Electronic controller 40 may determine that vehicle 2 is in an acceleration condition based upon a value of one of the IMU 566, accelerometer 561, engine speed 555, or vehicle speed 554 reaching a specified threshold. When the electronic controller 40 determines that vehicle 2 is in an acceleration command, electronic controller sends a signal to increase the compression damping characteristic of shock absorber 152 and further sends a signal to increase the rebound damping characteristic of shock absorber 202. That is, the compression damping of shock absorber 152 will be increased and the rebound damping of shock absorber 202 will be increased. During an acceleration event, the back portion of vehicle 2 will naturally enter a squat condition, and the front portion of vehicle 2 will rise upward. During an acceleration event, increasing the compression damping of shock absorber 152 will prevent squatting and increase the amount of surface area of track 101 will engage with the ground 30. Further, increasing the rebound damping of shock absorber 202 will push carrier wheels 210 further downward, thereby increasing the amount of surface area of track 101 will engage with the ground 30.

Electronic controller 40 may determine that vehicle 2 is in a braking condition based upon a value of the IMU 566, accelerometer 561, engine speed 555, vehicle speed 554, brake signal 565, or braking input sensor 564 reaching a specified threshold. When the electronic controller 40 determines that vehicle 2 is in a braking command, electronic controller sends a signal to increase the compression damping characteristic of shock absorber 202 and further sends a signal to increase the rebound damping characteristic of shock absorber 152. That is, the compression damping of shock absorber 202 will be increased and the rebound damping of shock absorber 152 will be increased. During a braking event, the front portion of vehicle 2 will naturally enter a dive-in condition, and the rear portion of vehicle 2 will rise upward. During an acceleration event, increasing the compression damping of shock absorber 202 will impede the dive in condition and increase the amount of surface area of track 101 will engage with the ground 30. Further, increasing the rebound damping of shock absorber 152 will push carrier wheels 151 further downward, thereby increasing the amount of surface area of track 101 will engage with the ground 30.

In various embodiments, electronic controller 40 is configured to adjust the damping characteristic of any or all of shock absorber 202, first shock absorber 142A, second shock absorber 142B, third shock absorber 142C, and shock absorber 152 in various conditions.

In various embodiments, shock bodies 184 are adjustable shock absorbers electrically coupled to electronic controller 40. Shock bodies 184 may be remotely or automatically operated to maintain a consistent track tension. Shocks 184 may include an adjustable compression damping characteristic and an adjustable rebounding damping characteristic. Electronic controller 40 is configured to determine when the tension of track 101 is lower than an optimal value. When electronic controller 40 determines that a tension of track 101 is lower than an optimal value, electronic controller 40 is configured to increase a compression damping characteristic of shock bodies 184 to push carrier wheels 151 outward and increase the tension of track 101. When electronic controller 40 determines that a tension of track 101 is higher than an optimal value, electronic controller 40 is configured to decrease a compression damping characteristic of shock bodies 184 which will better allow carrier wheels 151 to retract inward into suspension 102 and decrease the tension of track 101.

Now referring to FIGS. 19B and 19C, vehicle 2 may be configured to automatically level itself using shock absorber 202, first shock absorber 142A, second shock absorber 142B, third shock absorber 142C, and shock absorber 152. Accelerometer 561, gyroscope 562 or IMU 566 may be used to determine an orientation of vehicle 2. As shown in FIG. 19B, vehicle 2 is on a ground surface 30 which is laterally angled at angle 567, and track assembly 100L is positioned on the downhill side and track assembly 100R is positioned on the uphill side. In the present embodiment, left suspension 102L of track assembly 100L is configured to extend each of shock absorber 202, first shock absorber 142A, second shock absorber 142B, third shock absorber 142C, and shock absorber 152 and right suspension 102R of track assembly 100R is configured to compress each of shock absorber 202, first shock absorber 142A, second shock absorber 142B, third shock absorber 142C, and shock absorber 152 so that frame 10 and an operator remain generally level. As shown in FIG. 19C, vehicle 2 is on a ground surface 30 which is longitudinally angled at angle 568, and a front of track assemblies 100L, 100R is positioned on the downhill side and a rear of track assemblies 100L, 100R is positioned on the uphill side. In the present embodiment, each of shock absorber 202 in track assemblies 100L, 100R is configured to be extended, and each of shock absorber 152 in track assemblies 100L, 100R is configured to be compressed so that frame 10 and an operator remain generally level.

In various embodiments, vehicle 2 may be configured to self-level when a heavy load is present on vehicle 2. In one example, if vehicle 2 is towing a heavy trailer and rear portion 10B falls vertically below front portion 10A, suspension 102L, 102R may be configured to extend shock absorbers 152 to increase the height of rear portion 10B relative to ground surface ground surface 30 so that frame 10 and an operator remain generally level.

### Steering System

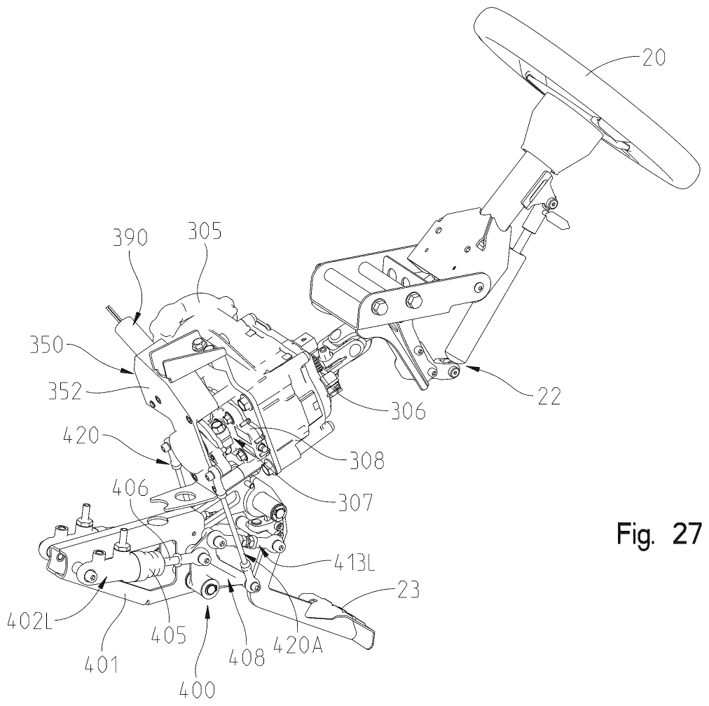

Now referring to FIGS. 20-21, vehicle 2 includes a steering assembly 300 positioned at least partially within operator area 3. Steering assembly 300 includes steering input 20 where a user input to steering input 20 controls steering assembly 300. Steering assembly 300 is generally supported by lower frame 12 by a bracket 314 extending along a face of steering unit 305. Steering assembly 300 further includes a steering unit 305. Steering unit 305 is operably coupled to steering input 20 such that an input to steering input 20 is transferred to steering unit 305. In the present embodiment, steering unit 305 is a power steering unit with a steering unit input 306 operably coupled to the steering input 20 and a steering unit output 307. In the present embodiment, each of steering unit input 306 and steering unit output 307 are splined. Steering assembly 300 includes a steering angle sensor 308 (FIG. 27) configured to measure at least one of a rotational speed or a steering angle of steering input 20. Steering angle sensor 308 is electronically coupled to a steering controller 315 and configured to send the at least one of a rotational speed or a steering angle to the electronic controller 40. In the present embodiment, steering angle sensor 308 is independent of steering unit 305, however, in various embodiments, steering angle sensor 308 may be integrated into steering unit 305.

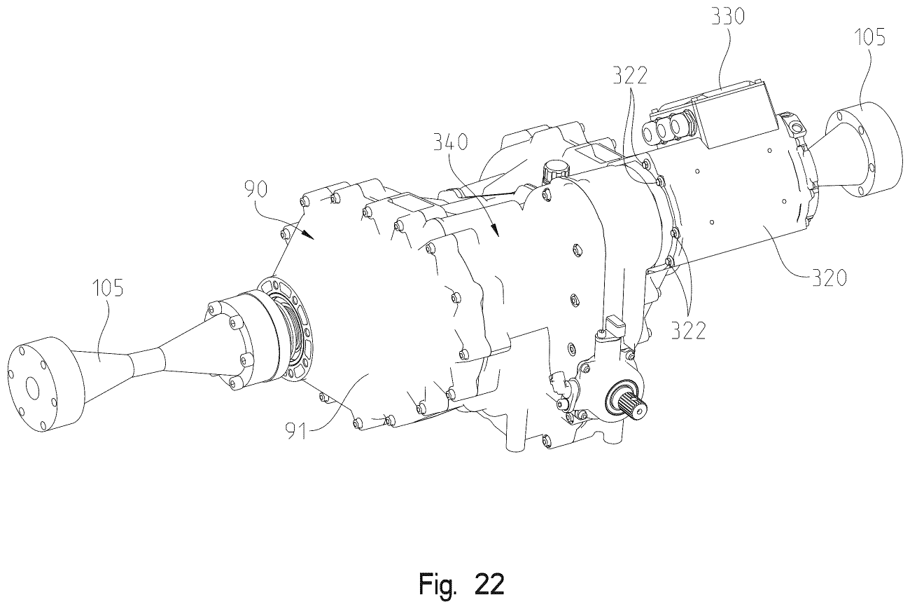

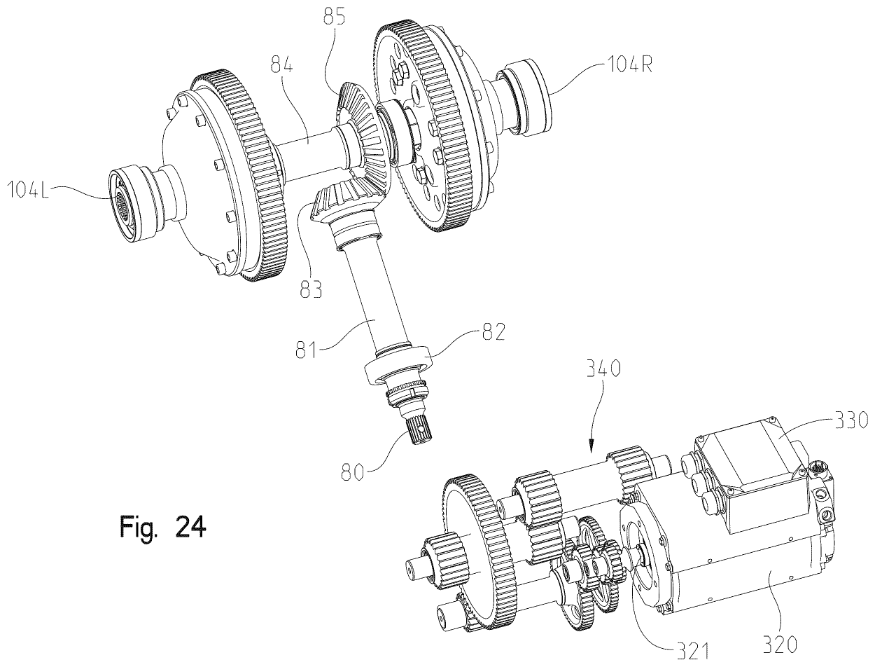

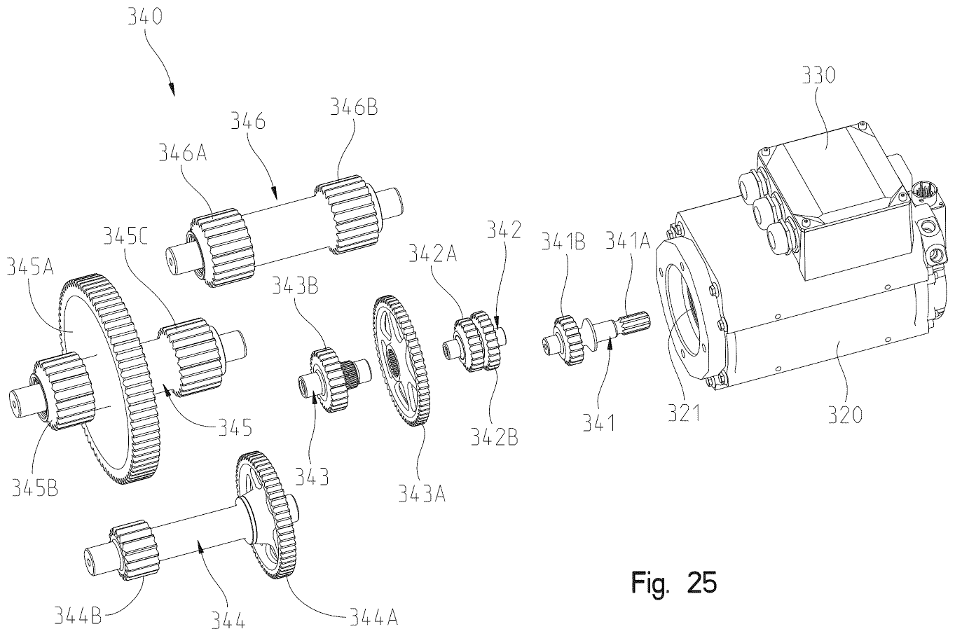

Turning now to FIGS. 22-26, steering assembly 300 further includes a steering motor 320 operably coupled to the front drive 90. Illustratively, steering motor 320 is coupled to front drive 90 through a plurality of fasteners 322. In various embodiments, steering motor 320 is only supported by front drive 90; however, in other embodiments, steering motor 320 is supported by lower frame 12. Steering motor 320 includes a steering motor output 321 operably coupled to a steering geartrain 340. Steering assembly 300 also includes a motor controller 330 electrically coupled to steering motor 320. In the present embodiment, motor controller 330 is integrated into steering motor 320, and in yet additional embodiments, motor controller 330 may be separated from steering motor 320. Steering motor 320 also includes an inverter 331 (FIG. 26) configured to invert an incoming current to allow steering motor 320 to use the incoming current. In the present embodiment, prime mover 51 provides mechanical power to generator 61, which then outputs electrical energy to a high-voltage battery 62. In the present embodiment, battery 62 is a 48 Volt (V) battery, and in yet additional embodiments, battery 62 is 12V, 24V, 36V, 60V, 72V, 84V, 96V, 120V or greater. Battery 62 then provides power directly to motor controller 330 and thereby steering motor 320.

Geartrain 340 is coupled between steering motor 320 and front drive 90. More specifically, front drive 90 includes a first output 104L and a second output 104R, and geartrain 340 is coupled between steering motor output 321 and first output 104L and second output 104R. Geartrain 340 is at least partially laterally positioned between steering motor output 321 and first output 104L. Geartrain 340 is at least partially longitudinally positioned between steering motor output 321 and first output 104L and/or second output 104R. Front drive 90 is generally positioned at a forward portion of vehicle 2. Front drive 90 also includes a front drive housing 91 and an input shaft 81 coupled to front drive input 80. Input shaft 81 is supported by a bearing 82 positioned in drive housing 91. Illustratively, steering motor 320 is coupled to drive housing 91. A first bevel gear 83 is positioned on an inner extent of the input shaft 81 opposite front drive input 80. Front drive 90 also includes an output shaft 84 including a second bevel gear 85 rotatably coupled to output shaft 84 and first bevel gear 83 is meshedly engaged with second bevel gear 85 such that a rotational input to front drive input 80 rotates output shaft 84. Front drive 90 also includes a first output gear 86L and a second output gear 86R rotatably coupled to output shaft 84. First output gear 86L and second output gear 86R are geared on their outer radius or periphery such that they can be meshed with another gear. In the present embodiment, front drive 90 is a differential, and outputs 104L, 104R are able to rotate at different speeds. In various embodiments, front drive 90 is a locking differential, an electronic differential, an open differential, or a limited slip differential.

Geartrain 340 includes a first shaft 341 with a first shaft input gear 341A and a first shaft output gear 341B coupled to first shaft 341. First shaft input gear 341A is rotatably coupled to steering motor output 321. Geartrain 340 also includes a second shaft 342 with a second shaft input gear 342A and a second shaft output gear 342B. Second shaft input gear 342A is meshedly engaged with first shaft second gear 341B. Geartrain 340 also includes a third shaft 343 with a third shaft input gear 343A and a third shaft output gear 343B and third shaft input gear 343A is meshedly engages with second shaft output gear 342B. Geartrain 340 also includes a fourth shaft 344 which includes a fourth shaft input gear 344A and a fourth shaft output gear 344B and fourth shaft input gear 344A is meshedly engaged with third shaft output gear 343B. Geartrain 340 also includes a fifth shaft 345 which includes a fifth shaft input gear 345A, a first final output gear 345B and a fifth shaft output gear 345C, and fifth shaft input gear 345A is meshedly engaged with fourth shaft output gear 344B and first final output gear 345B is meshedly engaged with first output 104L. Geartrain 340 also includes a sixth shaft 346 which includes a sixth shaft input gear 346A and a second final output gear 346B and sixth shaft input gear 346A is meshedly engaged with fifth shaft output gear 345C and second final output gear 346B is meshedly engaged with second output 104R.

Geartrain 340 may be constructed to act as a torque multiplier, such that a low torque, high speed or rpm motor may be used to provide a higher torque to the front drive 90. Additionally, fifth shaft 345 is directly and rotatably coupled to first output 104L and sixth shaft 346 is directly coupled between fifth shaft 345 and second output 104R; therefore, fifth shaft 345 and sixth shaft 346 rotate in opposite directions. That is, geartrain 340 will provide opposite directional forces on each of first output gear 86L and second output gear 86R. In one example, a positive torque is provided to first output gear 86L and a negative torque is provided to second output gear 86R. In another example, a negative torque is provided to first output gear 86L and a positive torque is provided to second output gear 86R. Each of first output gear 86L and second output gear 86R are coupled to first output 104L and second output 104R, respectively, and the torque provided to each of first output gear 86L and second output gear 86R is transmitted to first output 104L and second output 104R, respectively. Each of first output 104L and second output 104R is coupled to drive shafts 105 and, therefore, torque provided to each of first output gear 86L and second output gear 86R is provided to track assemblies 100L and 100R, respectively, and to steer vehicle 2 accordingly. That is, when a positive torque is provided to track assembly 100L and a negative torque is provided to track assembly 100R, track assembly 100L will rotate faster than track assembly 100R and vehicle 2 will turn to the right. Further, when a positive torque is provided to track assembly 100R and a negative torque is provided to track assembly 100L, track assembly 100R will rotate faster than track assembly 100L and vehicle 2 will turn to the left.

The prime mover 51 and steering motor 320 are independent power sources providing independent power output to front drive 90. That is, the outputs 104L, 104R receive the combined output from the prime mover 51 as well as the steering motor 320. Vehicle 2 may then be steered when vehicle is moving forward, moving backward, or not moving at all.

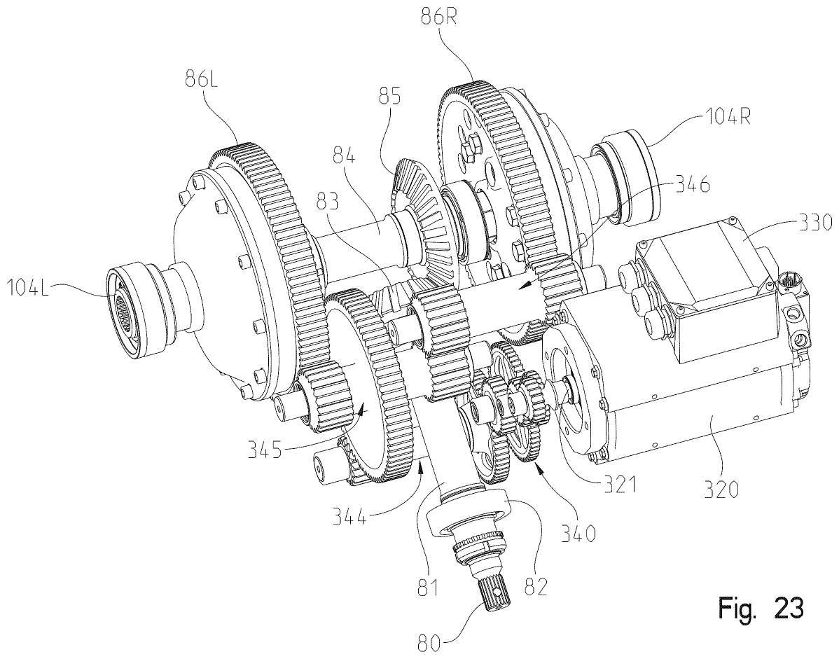

Further, as illustrated in FIG. 23, geartrain 340 is constructed such that input shaft 81 extends through geartrain 340. That is, fourth shaft 344 and fifth shaft 345 are parallel and input shaft 81 extends between fourth shaft 344 and fifth shaft 345. This arrangement provides a more compact packaging arrangement and allows for a smaller housing 91 to be used.

Now referring to FIG. 26, prime mover 51 is operably coupled to generator 61 to create and provide electrical energy to battery 62. In various embodiments, generator 61 and/or battery 62 are each operably coupled to a voltage converter 63. Voltage converter 63 is configured to lower the voltage to be compatible with battery 58 and/or steering controller 315. In the present embodiment, voltage converter 63 is a DC/DC converter configured to convert 48V electricity to 12V electricity. The electronic controller 40 is configured to provide data to the steering control unit for better control of the steering assembly 300. Electronic controller 40 provides engine speed, vehicle speed, and the gearbox position to the steering controller 315. Further, steering controller 315 is configured to receive at least one of a steering angle or steering position from steering unit 305.

In the present embodiment, steering motor 320 is configured to rotate with a positive rotational speed or a negative rotational speed and a positive torque or a negative torque. In one embodiment, a steering input indicating an operator's desire to turn left will create one of a positive or a negative torque at the steering motor 320, and a steering input indicating an operator's desire to turn right will create the other of a positive or a negative torque at the steering motor 320. In one embodiment, a steering input indicating an operator's desire to turn left will provide instructions to create one of a positive or a negative rotational speed at steering motor 320 and a steering input indicating an operator's desire to turn right will provide instructions to create the other of a positive or a negative rotational speed at steering motor 320. That is, each of a desired left or right turn will create opposing torques and request opposing rotational speeds (e.g., right-positive torque, left-negative torque, OR left-positive torque, right=negative torque) and (e.g., right=positive rotational speed, left=negative rotational speed; OR right=negative rotational speed, left-positive rotational speed).

In the present embodiment, steering controller 315 is configured to receive a powertrain characteristic from controller 40 and adjust a torque value of steering motor 320 based upon the first powertrain characteristic. In various embodiments, the first powertrain characteristic is an engine speed 555, a gearbox position 556, and a vehicle speed 554. In various examples, when steering controller 315 receives an indication that gearbox position 556 is in a reverse gear and a steering input is in a first direction, the steering motor 320 outputs one of a positive torque and a negative torque to create one of a positive rotational speed and a negative rotational speed, and when steering controller 315 receives an indication that gearbox position 556 is in a forward gear and a steering input is in the first direction, the steering motor 320 outputs the other of a positive torque and a negative torque to create the other of a positive rotational speed and a negative rotational speed. In another example, when steering controller 315 receives an indication of an increase in one of the engine speed 555 or the vehicle speed 554, the absolute value of the torque command provided to steering motor 320 is increased. In another example, when steering controller 315 receives an indication of a decrease in one of the engine speed 555 or the vehicle speed 554, the absolute value of the torque command provided to steering motor 320 is decreased. In yet another example, when steering controller 315 receives an indication of an increase in one of the engine speed 555 or the vehicle speed 554, the absolute value of the torque command provided to steering motor 320 is decreased. In another example, when steering controller 315 receives an indication of a decrease in one of the engine speed 555 or the vehicle speed 554, the absolute value of the torque command provided to steering motor 320 is increased.

In various embodiments, the requested torque does not match the current rotational speed direction. That is, in one example, steering motor 320 has a positive rotational speed which turns vehicle 2 in a first direction, and a user provides an input to steering input 20 which requests a negative torque from steering motor 320 so that vehicle starts to turn towards a second direction. As such, the requested torque will alter the rotational speed to create a similarly directed torque and rotational speed.

In various embodiments, the requested steering torque or the requested rotational speed of steering motor 320 is determined based upon any of steering angle 550, steering motor speed 552, vehicle speed 554, prime mover speed 555, gearbox position 556, throttle position 557, shock position sensor 558, throttle angle 559, accelerometer 561, gyroscope 562, GPS 563, brake input sensor 564, brake input 565, or imu 566.

### Emergency Steering

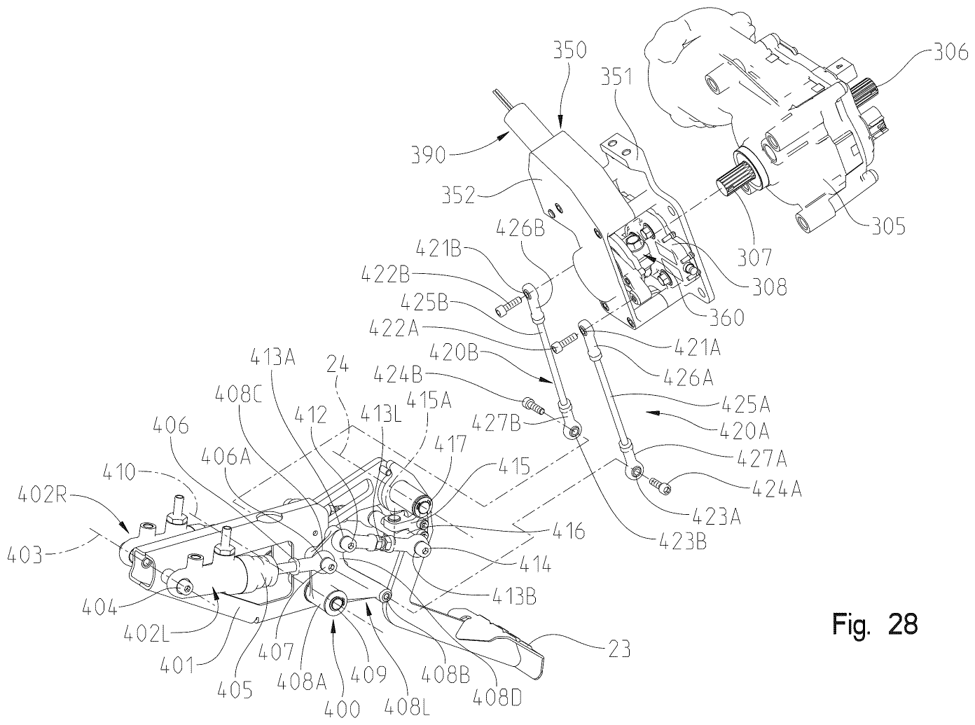

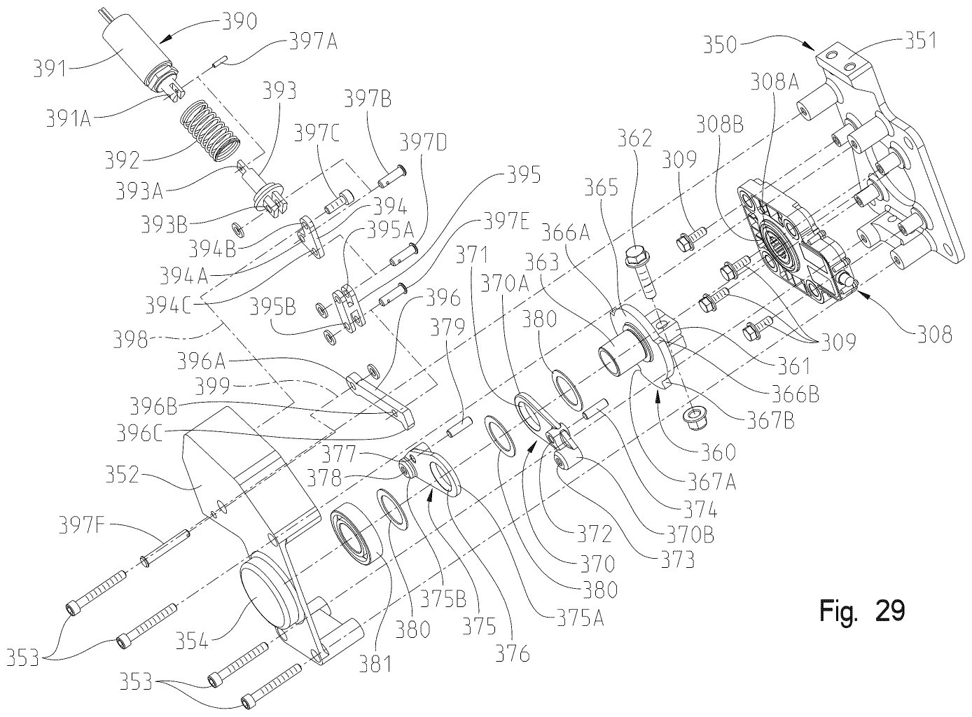

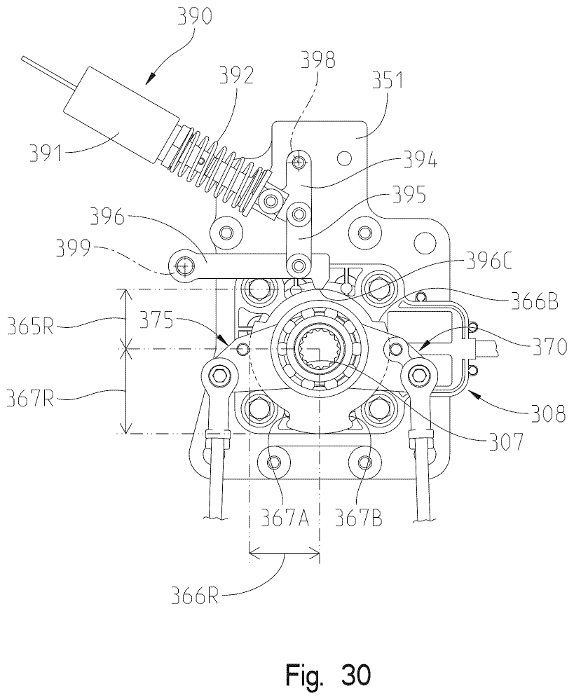

Now referring to FIGS. 27-31, a backup steering assembly 350 is coupled to steering unit 305. Backup steering assembly 350 includes a first wall 351 and a second wall 352 coupled together by a plurality of fasteners 353. Steering angle sensor 308 includes an aperture 308A defining a middle of rotational sensor 308B, and aperture 308A is configured to receive steering unit output 307. In the present embodiment, aperture 308A is splined to receive the steering unit output 307, that is, steering unit output 307 is rotatably coupled to aperture 308A and as steering unit output 307 rotates, rotational sensor 308B rotates with it. Steering angle sensor 308 is coupled to first wall 351 by a plurality of fasteners 309. Backup steering assembly 350 also includes a stop member 360 which includes a collar 361 configured to rotatably couple to steering unit output 307. A fastener 362 extends through collar 361 to fasten steering unit output 307 to collar 361 using a friction fit. That is, steering unit output 307 is rotatably coupled to stop member 360. Stop member 360 includes a flange 365 which includes a pair of first steering stops 366A, 366B and a pair of dog point stops 367A, 367B. Illustratively, the radius of flange 365 increases at the first steering stops 366A, 366B, and the radius of the flange 365 increases again at the dog point stops 367A, 367B. As shown in FIG. 30, flange 365 has a base radius 365R, first steering stops 366A, 366B have a first steering stop radius 366R, and dog point stops 367A, 367B have a dog point stop radius 367R. In the present embodiment, base radius 365R is less than first steering stop radius 366R which is less than dog point stop radius 367R. Stop member 360 also includes a sleeve 363 extending outwardly from flange 365 and opposite collar 361.

Backup steering assembly 350 also includes a plurality of spacers 380, a first arm 370, a second arm 375 and a bearing 381. First arm 370 is generally rounded and, illustratively, is teardrop shaped with a large, rounded end 370A and a smaller, rounded end 370B. End 370A includes a first aperture 371 and end 370B includes a second aperture 373. First arm 370 also includes a third aperture 372 positioned adjacent second aperture 373 and a dog point 374 positioned within second aperture 373 and extending toward stop member 360. Second arm 375 also is generally rounded and, illustratively, is generally teardrop shaped, with a large, rounded end 375A and a smaller, rounded end 375B. End 375A includes a first aperture 376 and end 375B includes a second aperture 378. Second arm 375 also includes a third aperture 377 positioned adjacent second aperture 378 and a dog point 379 positioned within second aperture 378 and extending toward stop member 360. Illustratively, bearing 381 sits within a recessed portion 354 of second wall 352. One of the plurality of spacers 380 is placed on sleeve 363. Further, sleeve 363 extends through aperture 371 of first arm 370 to couple first arm 370 to stop member 360. Another of the plurality of spacers 380 is placed on sleeve 363. Further, sleeve 363 extends through apertures 376 of second arm 375 to couple second arm 375 to stop member 360. Another spacer 380 is then placed on sleeve 363, and sleeve 363 then inserts into-and is supported by-bearing 381. That is, first arm 370, second arm 375 and bearing 381 are all placed onto sleeve 363, where each is separated by spacers 380. In the present embodiment, first arm 370 and second arm 375 are supported by sleeve 363, however, each of first arm 370 and second arm 375 are independently rotatable about sleeve 363.

Backup steering assembly 350 also includes a solenoid assembly 390 including a solenoid or actuator 391 with a first aperture 391A. Solenoid 391 is configured to be a linear actuator and move between an unactuated/unextended/first position and an actuated/extended/second position. Backup steering assembly 350 also includes a first link 393 with a second aperture 393A and a third aperture 393B. Solenoid 391 and first link 393 couple together by a fastener 397A extending through first aperture 391A and second aperture 393A. Further, a biasing member 392 extends between solenoid 391 and first link 393. A second link 394 includes a fourth aperture 394A, a fifth aperture 394B, and a sixth aperture 394C. Second link 394 is generally V-shaped, and first link 393 couples to second link 394 by a fastener 397B extending through third aperture 393B and fourth aperture 394A. Second link 394 is coupled to second wall 352 by a fastener 397C extending through fifth aperture 394B and coupling to second wall 352. That is, fastener 397C which extends through aperture 394B defines a second link rotation axis 398 and second link 394 is able to rotate about second link rotation axis 398. Backup steering assembly 350 also includes a third link 395 including a seventh aperture 395A and an eighth aperture 395B. A fastener 397D extends through sixth aperture 394C and seventh aperture 395A to couple second link 394 to third link 395. Backup steering assembly 350 also includes a fourth link 396 including a ninth aperture 396A and a tenth aperture 396B. A fastener 397E extends through eighth aperture 395B and tenth aperture 396B to couple third link 395 to fourth link 396. Further, a fastener 397F extends through second wall 352 and ninth aperture 396A to couple fourth link 396 to second wall 352. That is, fastener 397F defines a fourth link rotation axis 399 and fourth link 396 is rotatable about fourth link rotation axis 399. Fourth link 396 is generally linear and includes a protrusion 396C at an end opposite ninth aperture 396A and adjacent tenth aperture 396B. Protrusion 396C extends downward from fourth link 396 and is configured to be a limit, or stop, for first steering stops 366A and first steering stops 366B.

Backup steering assembly 350 is operably coupled to brake input assembly 400. Brake input assembly 400 includes a brake input 23 positioned within operator area 3 and accessible by an operator of vehicle 2. Brake input assembly 400 includes a frame 401 and a bushing 417, and a fastener (not shown) extends through frame 401 and bushing 417 and a portion of frame 10 to couple brake input assembly 400 to frame 10. Further, bushing 417 defines a brake input rotation axis 24, and brake input 23 is supported by bushing 417 and allowed to rotate about brake input rotation axis 24. Brake input assembly 400 further includes a center bracket 415 coupled to brake input 23 positioned adjacent brake input rotation axis 24. A balance shaft 416 is generally cylindrical and coupled to center bracket 415 at its midpoint, and more particularly, balance shaft 416 is pinned to center bracket 415 about center bracket pin axis 415A. That is, balance shaft 416 is coupled to center bracket 415, however, balance shaft may rotate about bracket pin axis 415A. In the present embodiment, both ends of balance shaft 416 have internal threads configured to receive a threaded fastener. In various embodiments, brake input 23 is an electronic input which provides a brake input signal 565 to a brake controller 275.

Frame 10 also includes a mounting point 404 positioned at a forward portion thereof. A first brake cylinder, or actuator 402L and a second brake cylinder, or actuator 402R are rotatably coupled to either side of frame 10 at mounting point 404 which defines brake cylinder rotation axis 403. First brake cylinder 402L and second brake cylinder 402R are rotatable about brake cylinder rotation axis 403. First brake cylinder 402L and second brake cylinder 402R each include a cylinder body 405 and a pushrod 406 which includes a pushrod aperture 406A. Pushrod 406 is configured to move in an out of cylinder body 405 to move brake fluid through brake lines (not shown) to brake assembly 250. Brake input assembly 400 also includes a first cam member 408L which includes a first aperture 408A, a second aperture 408B, a third aperture 408C, and a fourth aperture 408D. A bushing 409 is positioned within first aperture 408A, and a fastener (not shown) extends through bushing 409 and couples cam member 408L to frame 401. Bushing 409 defines a cam member rotation axis 410 and cam member 408L is rotatable about cam member rotation axis 410. A fastener 407 extends through pushrod aperture 406A and third aperture 408C to couple pushrod 406 of first brake cylinder 402L, to cam member 408L. That is, the rotation of cam member 408 moves pushrod 406 in and out of cylinder body 405 to operate brake assembly 250. A first link 413L includes a first aperture 413A and a second aperture 413B and extends between cam member 408L and balance shaft 416. That is, a fastener 412 extends through first aperture 413A and fourth aperture 408D to couple link 413 to balance shaft 416, and a fastener 414 extends through second aperture 413B and a threaded end of balance shaft 416 to couple link 413 to balance shaft 416. A second cam member 408R (FIG. 21) is coupled to second brake cylinder 402R and frame 401 opposite from first cam member 408L in a mirrored fashion. Further, a second link 413R is coupled between the second cam member 408R and the balance shaft 416. In the present embodiment, first brake cylinder 402L provides brake input to brake assembly 250 positioned on left track assembly 100L and second brake cylinder 402R provides brake input to brake assembly 250 positioned on right track assembly 100R. In the present embodiment, as brake input 23 is actuated by an operator (e.g., an operator's foot, not shown), brake input 23 is rotated downwardly and forwardly, and balance shaft 416 is pushed forward. Balance shaft 416 distributes an equal amount of force between both links 413L and 413R, and an equal amount of force is provided to cam members 408L and 408R. A force from links 413L and 413R is provided to cam members 408L and 408R at fourth aperture 408D which creates an upward and forward rotation of cam members 408L and 408R, thereby actuating the pushrod 406 of each first brake cylinder 402L and second brake cylinder 402R through cylinder body 405, and moving brake fluid through the brake lines (not shown) to the brake calipers 252 at both track assemblies 100L, 100R. That is, an input to brake input 23 actuates both brake calipers 252 at both track assemblies 100L, 100R.

Brake input assembly 400 also includes a first link 420A and a second link 420B. First link 420A includes a first end 426A with a first aperture 421A and a second end 427A with a second aperture 423A and a rod 425A extending between first end 426A and second end 427A. A fastener 422A extends through first aperture 421A and second aperture 373 and couples first link 420A to first arm 370. Second link 420B includes a first end 426B with a first aperture 421B and a second end 427B with a second aperture 423B and a rod 425B extending between first end 426B and second end 427B. A fastener 422B extends through first aperture 421B and second aperture 378 and couples second link 420B to second arm 375. A fastener 424A extends through second aperture 423A and second aperture 408B to couple second end 427A to cam member 408L. Similarly, a fastener 424B extends through second aperture 423B and a second aperture of second cam member 408R to couple second end 427B to the second cam member 408R.

Links 420A, 420B are coupled to cam members 408L, 408R, respectively, and therefore a force input to either, or both, of links 420A, 420B will operate substantially similar to a force input to brake input 23. That is, if link 420A is moved upwardly, cam member 408L will be rotated upwardly and forwardly, thereby actuating first brake cylinder 402L and providing a braking force to track assembly 100L. Similarly, if link 420B is moved upwardly, cam member 408R will be rotated upwardly and forwardly, thereby actuating second brake cylinder 402R and providing a braking force to track assembly 100R. In the present embodiment, balance shaft 416 is able to rotate about center bracket pin axis 415A so that one of first cam member 408L or second cam member 408R can be rotated independently of the other without rotating the other of first cam member 408L or second cam member 408R.

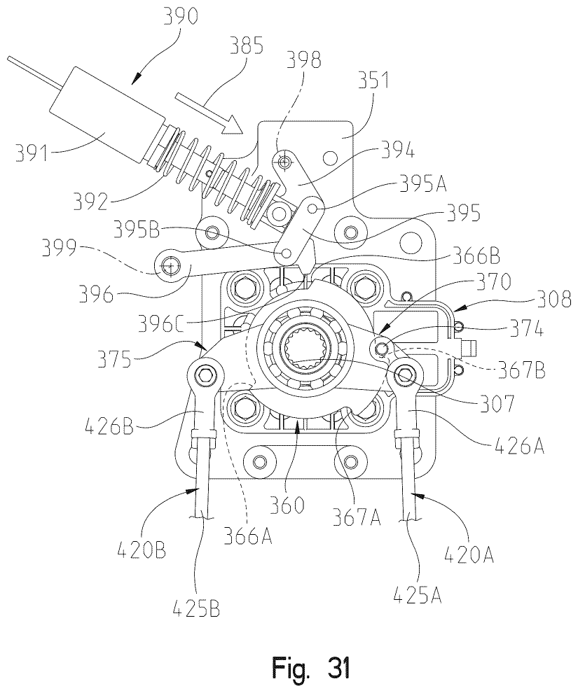

Now turning to FIGS. 30 and 31, the operation of backup steering assembly 350 will be explained in greater detail. Solenoid 391 is communicably coupled to steering controller 315 and is configured to extend or unextend based upon a received steering operation signal from steering controller 315. Steering controller 315 will send an actuation signal to solenoid 391 when steering controller 315 detects a fault condition within steering assembly 300. Various fault conditions may be an unresponsive steering motor 320, a faulty motor controller 330, low power mode at battery 62, faulty generator 61, a faulty sensor or fault detected in the wiring or error detection system, or other fault condition. That is, when a fault condition is detected within steering assembly 300, backup steering assembly 350 will be engaged. As shown in FIG. 30, solenoid 391 is shown in an unextended position, indicating that there is no detected fault condition present within steering assembly 300. As such, second link 394 remains unrotated about second link rotation axis 398 and fourth link 396 remains unrotated about fourth link rotation axis 399. In this position, fourth link rotation axis 399 is nominally perpendicular to third link 395, and protrusion 396C is generally engaged with flange 365 of stop member 360. More specifically, protrusion 396C is generally positioned a specified distance from the center of flange 365 which is nominally equal to that of base radius 365R such that protrusion 396C is generally in contact with flange 365. When no fault condition is detected, solenoid 391 is unactuated and protrusion 396C is in a first position and acts as a steering stop for steering assembly 300. As an operator provides an input to steering input 20, steering unit output 307 rotates, and therefore stop member 360 rotates with steering unit output 307.

As steering input 20 is rotated, it is beneficial to have a steering stop to limit the amount of steering input that can be provided to steering input 20. As stop member 360 is rotated with steering unit output 307, protrusion 396C rotates along flange 365 until it reaches either of first steering stops 366A, 366B. That is, when no fault condition exists, steering input has a first steering range of approximately 120 degrees. In other words, steering stops 366A, 366B are angled approximately 120 degrees apart. In various embodiments, steering stops 366A, 366B are angled approximately 90 degrees apart, 100 degrees apart, 110 degrees apart, 130 degrees apart, 140 degrees apart, 150 degrees apart 180 degrees apart, 270 degrees apart, or another angle. Various angles of separation are contemplated.

Turning to FIG. 31, solenoid 391 is illustrated in an actuated position indicating that a fault condition was received from steering controller 315. In response to receiving the fault condition, steering controller 315 actuates solenoid 391 from a first, or unactuated position (FIG. 30) to a second, or actuated position (FIG. 31). When solenoid 391 is in an actuated/extended/second position, second link 394 is moved in the same direction as the actuation of solenoid 391, and second link 394 is rotated about second link rotation axis 398. As second link 394 is rotated, third link 395 is also moved in the same direction as solenoid 391, that is, seventh aperture 395A is pushed forward and eight aperture 395B is rotated upwardly. As eight aperture 395B is rotated upwardly, fourth link 396 is rotated upwardly about fourth link rotation axis 399 and protrusion 396C is moved upwardly out of engagement with flange 365 to a second position. Specifically, when protrusion 396C is moved from the first position to the second position, protrusion 396C is raised a distance greater than the difference between base radius 365R and first steering stop radius 366R. That is, steering input 20 and stop member 360 can be rotated and are no longer constrained by the steering stops 366A, 366B and steering input 20 is able to operate within a second steering range with an angle greater than the first steering range. Further, protrusion 396C is raised a distance greater than the difference between base radius 365R and first steering stop radius 366R but less than the difference between base radius 365R and dog point stop radius 367R. As illustrated in FIG. 31, stop member 360 is able to rotate past steering stops 366A, 366B, and dog point 374 and dog point 379 are able to engage dog point stops 367A, 367B.

In one example, steering input 20 is rotated such that stop member 360 is rotated so that first steering stops 366B rotates past protrusion 396C, and dog point stops 367B engages dog point 374 so that first arm 370 is rotated upwardly. First link 420A is coupled to first arm 370, therefore, first link 420A is also moved upwardly. As previously described, as first link 420A is moved upward, cam member 408L will be rotated upwardly and forwardly, thereby actuating first brake cylinder 402L and providing a braking force to track assembly 100L. This example would have the effect of allowing track assembly 100R to turn faster than track assembly 100L and turn vehicle 2 to the left.

In another example, steering input 20 is rotated such that stop member 360 is rotated so that first steering stops 366A rotates past protrusion 396C, and dog point stops 367A engages dog point 379 so that second arm 375 is rotated upwardly. Second link 420B is coupled to second arm 375 and, therefore, second link 420B is also moved upwardly. As previously described, as second link 420B is moved upwardly, cam member 408R will be rotated upwardly and forwardly, thereby actuating second brake cylinder 402R and providing a braking force to track assembly 100R. This example would have the effect of allowing track assembly 100L to turn faster than track assembly 100R and turn vehicle 2 to the right.

Backup steering assembly 350 initiates when a fault condition of steering assembly 300 is detected. That is, when the primary steering assembly 300 no longer works properly, backup steering assembly 350 provides an operator an additional method of steering vehicle 2. When backup steering assembly 350 is in operation, an operator may rotate steering input 20 in either direction (i.e., right or left) to provide a braking force to either track assembly 100L or 100R and create a steering effect on vehicle 2.

In various embodiments, steering controller may rank various fault conditions of steering assembly 300 according to severity and only a certain level of severity will initiate the actuation of solenoid 391 and backup steering assembly 350.

In various embodiments, controller 40 or steering controller 315 may detect a fault with only a portion of the steering assembly 300 such that steering unit 305 is still operational. In one example, steering motor 320 is faulty and unresponsive but steering unit 305 is still operating correctly. In the event that backup steering assembly 350 is actuated and steering unit 305 is operational, steering unit 305 may provide a steering assist torque to backup steering assembly 350 to assist the operator in actuating actuator 402L, and actuator 402R. Additional details regarding the use of steering unit 305 to provide steering assist torque can be found in U.S. Pat. No. 9,771,084, issued Sep. 26, 2017, titled SYSTEM AND METHOD FOR CONTROLLING A VEHICLE, the entire disclosure of which is expressly incorporated herein by reference.

### Steering Feedback Force and Steering Modes

Steering assembly 300 of vehicle 2 may also be capable of providing tactile feedback to an operator. In the present embodiment, steering unit 305 is a power steering unit which includes a motor configured to provide a torque to steering input 20. Steering unit 305 is communicably coupled with steering controller 315 and in response to an input to steering input 20, steering controller 315 may provide a feedback signal to the operator of vehicle 2 through the steering input 20.

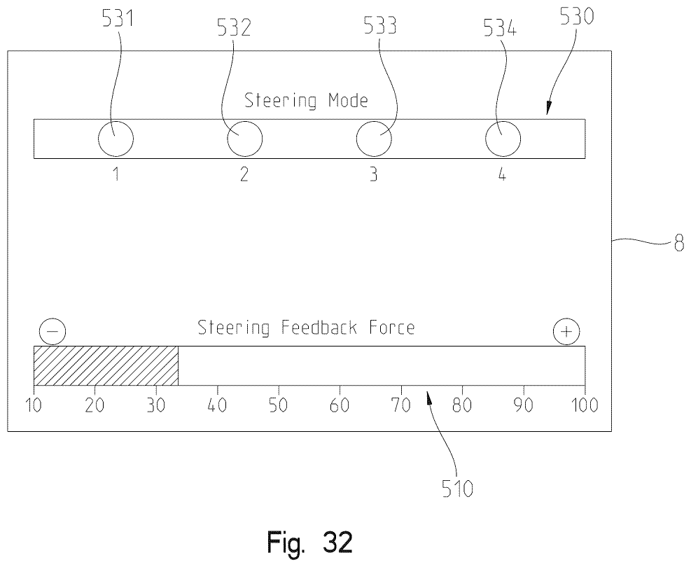

Now referring to FIG. 32, an operator of vehicle 2 may select a desired feedback force level 510 and a desired steering mode 530. Selection of the feedback force level 510 and steering mode 530 may occur on display 8 or via another mode of selection including buttons, knobs, sliders, switches, or any other method. In the present embodiment, a user may select a plus ‘+’ sign to increase the feedback force level 510 or may further select a minus ‘−’ sign to decrease the feedback force level 510. In an exemplary embodiment, a user may select any discrete integer between 0% of feedback force and 100% of feedback force by toggling between any value in the range of 0%-100%.

Still referring to FIG. 32, steering modes 530 may be selected by an operator of vehicle 2. In the present embodiment, the operator may choose from a first steering mode 531, a second steering mode 532, a third steering mode 533, and a fourth steering mode 534. In embodiments, first steering mode 531 is a “Turf” mode, second steering mode 532 is a “Comfort” mode, third steering mode 533 is a “Sport” mode, and fourth steering mode 534 is a “Sport+” mode. In embodiments, the various modes may represent different steering behaviors. In embodiments, “Turf” mode may be configured to facilitate the least aggressive steering behavior to reduce the chance of tearing the ground up and may facilitate the feel of steering a wheeled-vehicle. In embodiments, the “Sport+” mode may be configured to facilitate a more aggressive steering behavior to increase responsiveness to an operator and create a sportier feel. In various embodiments, more steering modes may be available to the operator. Each of first steering mode 531, second steering mode 532, third steering mode 533, fourth steering mode 534 are linked to a steering motor map, where a steering motor speed 552 is determined based upon the values of steering angle 550. In other embodiments, steering motor speed 552 may be based upon any of vehicle speed 554, engine speed 555 and gearbox position 556. That is, each steering map, or steering gradient, for each steering mode 531, 532, 533, 534 provides a target output speed 552 for steering motor 320. In various embodiments, each steering map for each steering mode 531, 532, 533, 534 may provide a target output torque for steering motor 320.

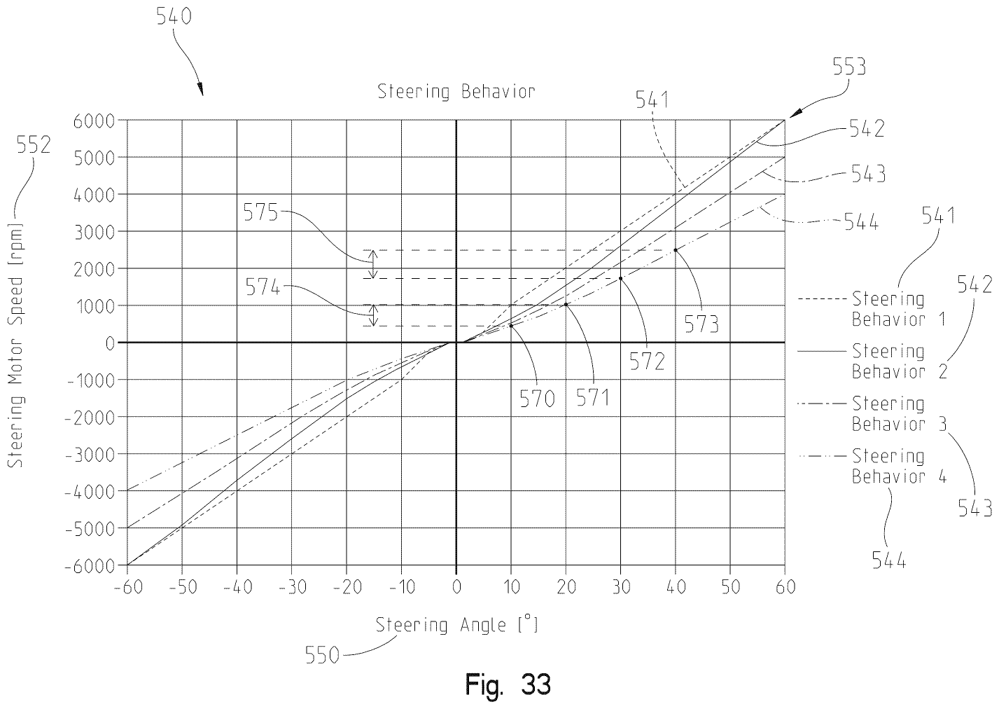

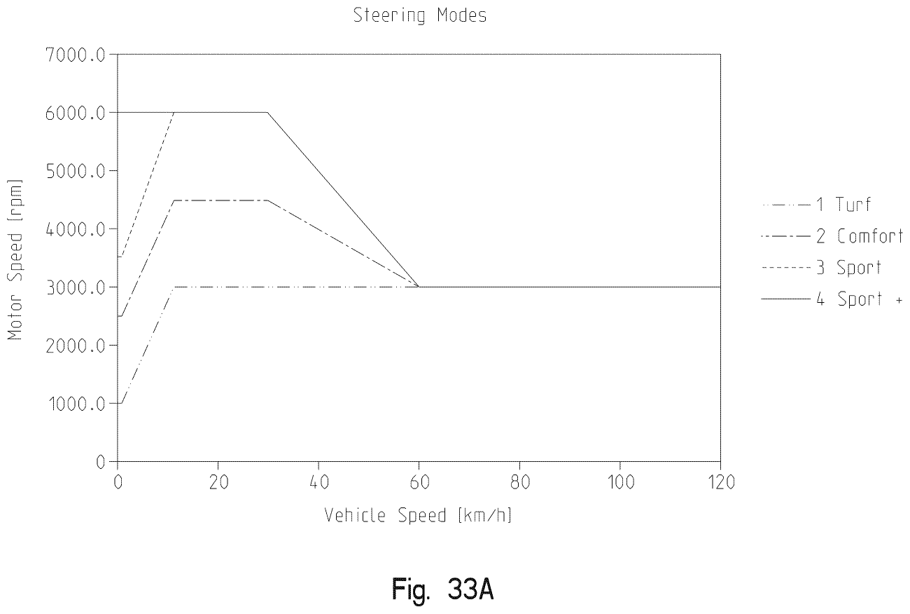

Now referring to FIG. 33, an example map 540 provides a plurality of steering motor speed gradients. More particularly a first steering mode 531 has a first profile, or first steering motor speed gradient 544 which provides a smooth curvilinear function up to a fraction of the maximum steering motor speed 552 at a maximum steering angle 550. That is, first steering mode 531 has a steering motor speed 552 of (+/−)4000 RPM at a steering angle 550 of (+/−)60 degrees. Second steering mode 532 has a second profile, or second steering motor speed gradient 543 which provides a smooth curvilinear function up to a fraction of the maximum steering motor speed 552 at a maximum steering angle 550. That is, second steering mode 532 has a steering motor speed 552 of (+/−)5000 RPM at a steering angle 550 of (+/−)60 degrees.

Third steering mode 533 has a third profile, or third steering motor speed gradient 542 which provides a smooth curvilinear function up to a maximum steering motor speed 552 at a maximum steering angle 550. Fourth steering mode 534 has a fourth profile, or fourth steering motor speed gradient 541 which provides a generally linear function, creating a nominally ‘direct’ correlation between steering angle 550 and steering motor speed 552. In the present example, third profile 542 and fourth profile 541 each have a steering motor speed 552 of 0 Revolutions Per Minute (RPM) at a steering angle 550 of 0 degrees and each have a maximum steering motor speed 552 of (+/−)6000 RPM at a steering angle 550 of (+/−)60 degrees.

In various embodiments, each of first profile 541, second profile 542, third profile 543 and fourth profile 544 represents a target output torque based upon at least one of engine speed 555, gearbox position 556, vehicle speed 554, or steering angle 550. That is, each of first profile 541, second profile 542, third profile 543 and fourth profile 544 creates a different torque gradient.

In the present embodiment, first steering mode 531 and second steering mode 532 are less aggressive steering modes than third steering mode 533 and fourth steering mode 534 because the steering motor speed 552 will be less for a given vehicle speed 554 at any given steering angle 550. Third steering mode 533 or fourth steering mode 534 may be used in a muddy condition or other drive condition where sharp movement is required. Alternatively, first steering mode 531 or second steering mode 532 may be used when more comfortable driving is desired.

In the present embodiment, each of profiles 541, 542, 543, 544 are offset around a steering angle value of 0 degrees. That is, plus/minus approximately one to three degrees around a neutral steering angle (0 degrees), the steering motor speed will be approximately zero to maintain control and prevent uncontrolled movement.

In various embodiments, and referring to FIG. 33 as an example, at least one of profiles 541, 542, 543, 544 includes a first steering motor speed interval 574 defined by the steering motor speed difference between a first engine speed 570 and a second engine speed 571 and a second steering motor speed interval 575 defined by the steering motor speed difference between a third engine speed 572 and a fourth engine speed 573. Illustratively, first engine speed 570 is less than second engine speed 571 which is less than third engine speed 572 which is less than fourth engine speed 573. Further, the first steering motor speed interval 574 is less than second steering motor speed interval 575. In various embodiments, any of profiles 541, 542, 543, 544 may be created based upon a 3D map, a 2D map, or any other function based upon variables including any of steering angle 550, steering motor speed 552, vehicle speed 554, prime mover speed 555, gearbox position 556, throttle position 557, shock position sensor 558, throttle angle 559, accelerometer 561, gyroscope 562, GPS 563, brake input sensor 564, brake input 565, or IMU 566.

In various embodiments, vehicle 2 has a steering motor output speed 552 defined only by a single profile of the plurality of profiles 541, 542, 543, and 544, for example first profile 541. In embodiments, the steering motor speed 552 is an output based upon each of steering angle 550 (e.g., first profile 541) and vehicle speed 554. Referring now to FIG. 33A, each of first steering mode 531 (i.e., “Turf” mode), second steering mode 532 (i.e., “Comfort” mode), third steering mode 533 (i.e., “Sport” mode), and fourth steering mode 534 (i.e., “Sport +” mode) are each defined by a maximum steering motor speed profile which sets a maximum steering motor speed 552 based upon a vehicle speed 554. In embodiments, first steering mode 531 (i.e., “Turf” mode) is defined by a maximum motor speed 552 of 1000 RPM at a vehicle speed of zero (0) kilometers per hour (kph) and a maximum motor speed 552 of 3000 RPM at a vehicle speed 554 of 20 kph. That is, when vehicle speed 554 is 0 kph, the steering motor speed 552 may be between 0-1000 RPM depending on the steering angle 550 (see FIG. 33). Further, when vehicle speed 554 is 20 kph, the steering motor speed 552 may be between 0-3000 RPM depending on the steering angle 550 (see FIG. 33). In embodiments, second steering mode 532 (i.e., “Comfort” mode) is defined by a maximum motor speed 552 of 2500 RPM at a vehicle speed of zero (0) kilometers per hour (kph) and a maximum motor speed 552 of 4500 RPM at a vehicle speed 554 of 20 kph and a maximum motor speed 552 of 3000 RPM at a vehicle speed 554 of 60 kph. That is, when vehicle speed 554 is 0 kph, the steering motor speed 552 may be between 0-2500 RPM depending on the steering angle 550 (see FIG. 33). Further, when vehicle speed 554 is 20 kph, the steering motor speed 552 may be between 0-4500 RPM depending on the steering angle 550 (see FIG. 33). Further, when vehicle speed 554 is 60 kph, the steering motor speed 552 may be between 0-3000 RPM depending on the steering angle 550 (see FIG. 33).

Referring to FIGS. 33-33A, first profile 541 is configured to have a steering motor speed 552 of 6000 RPM in response to a steering angle 550 of 60 degrees. However, in “Turf” mode 531, when vehicle 2 has a steering angle 550 of 60 degrees and a vehicle speed of 20 kph, steering motor speed 552 will be limited to 3000 RPM. Further, in “Comfort” mode 532, when vehicle 2 has a steering angle 550 of 60 degrees and a vehicle speed of 20 kph, steering motor speed 552 will be limited to 4500 RPM. Further, in “Sport” mode 533, when vehicle 2 has a steering angle 550 of 60 degrees and a vehicle speed of 20 kph, steering motor speed 552 will be limited to 6000 RPM. Further, in “Sport +” mode 532, when vehicle 2 has a steering angle 550 of 60 degrees and a vehicle speed of 20 kph, steering motor speed 552 will be limited to 4500 RPM.

In embodiments, vehicle 2 is configured to have a default steering mode. That is, upon vehicle 2 starting up (e.g., prime mover 51 is turned on or controller 40, 330 is engaged, or turned on), controller 40, 330 will control steering motor 320 to operate in a default steering mode (e.g., one of steering modes 531, 532, 533, 534). In embodiments, vehicle 2 is configured to have a default steering mode of the first steering mode 531, or “Turf” mode. That is, upon start-up, controller 40, 330 is configured to automatically control steering motor 320 according to the first steering mode 531, or the “Turf” mode. In embodiments, controller 40, 330 is configured to automatically switch from any one of the steering modes (e.g., steering modes 531, 532, 533, 534) to the default steering mode (e g, first steering mode 531) upon a determination that vehicle 2 is turned off (e.g., prime mover 51 is turned off or controller 40, 330 is disengaged, or turned off). That is, in embodiments, controller 40, 330 is configured to operate steering motor 320 in the default steering mode any time that vehicle 2 is restarted (e.g., prime mover 51 is turned off and turned back on, or power is cycled to controller 40, 330).

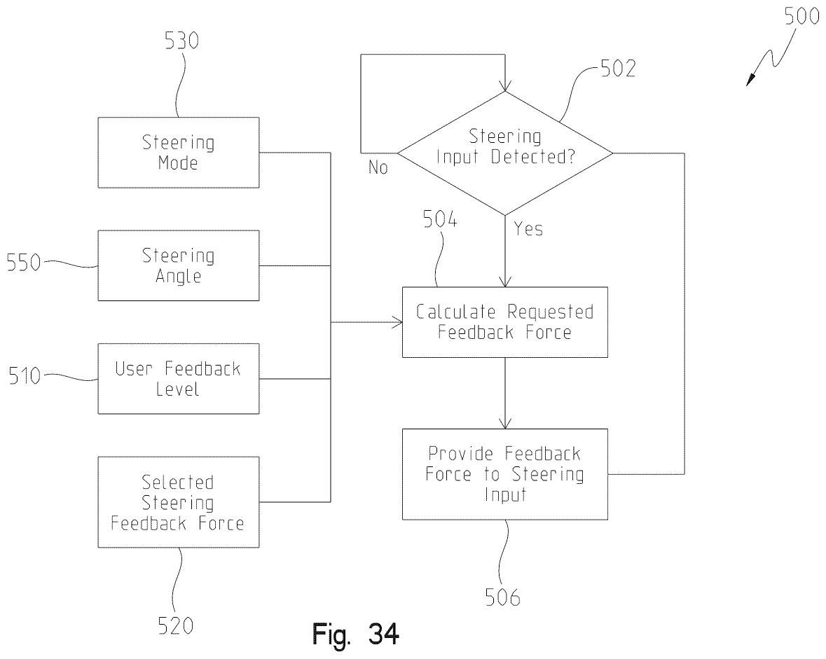

Turning to FIG. 34, process 500 will be explained. Process 500 includes a starting decision step 502 where the steering controller determines if a steering input is detected. When no steering input is detected, the step repeats itself. This decision step 502 may be continuously iterated, or nearly continuously, at a high frequency until a steering input is detected. When a steering input is detected, process 500 moves to block 504 where a requested feedback force is calculated using a steering mode 530, steering angle value 550 from steering angle sensor 308, and a selected user feedback force level 510. The requested feedback force is calculated in block 504 and is then provided to the steering unit 305 in block 506. The requested feedback force is transmitted to the steering input 20 by providing a torque pulse or a series of torque pulses from the steering unit 305. Additionally, steering unit 305 may provide continuous resistance to an operator providing an input to steering input 20. Additional details regarding steering systems can be found in U.S. patent application Ser. No. 17/410,781, filed Aug. 24, 2021, the entire disclosure of which is expressly incorporated herein.

In one example, in a first scenario when the feedback force level is 30%, steering angle is 20 degrees, and the selected drive mode is fourth steering mode 534, a first feedback force will be requested, and in a second scenario when the feedback force level is 60%, steering angle is 40 degrees, and the selected drive mode is first steering mode 531, a second feedback force will be requested. In the present embodiment, the second scenario indicates a more aggressive steering maneuver than the first scenario, and therefore, the second feedback force will be greater than the first feedback force.

The feedback force of the present vehicle is intended to provide an operator with a similar feeling or feedback as that of controlling a steering rack of a typical steering system. The current system has a free rotating steering input 20 which sends an electrical signal to control steering motor 320. This system does not contain the frictional forces experienced in a mechanical steering system (e.g., rack and pinion) directly coupled to the steering input 20. In the current system, a lack of feedback may feel unusual to the operator, and a simulated feedback force to the operator may provide a more comfortable operating experience.

In various embodiments, a user may select a feedback force mode 520 which provides discrete feedback force maps or functions independent of the steering modes. In various embodiments, feedback force modes may be defined by a Light mode, a Medium mode, and a Heavy mode. That is, in one example, for a first steering angle, the feedback force provided in Light mode is a first feedback force, the feedback force provided in Medium mode is a second feedback force, and the feedback force provided in Heavy mode is a third feedback force and the first feedback force is less than the second feedback force which is less than the third feedback force. Any or all of the various feedback force modes 520 may be created based upon a 3D map, a 2D map, or any other function based upon variables including any of steering angle 550, steering motor speed 552, vehicle speed 554, prime mover speed 555, gearbox position 556, throttle position 557, shock position sensor 558, throttle angle 559, accelerometer 561, gyroscope 562, GPS 563, brake input sensor 564, brake input 565, or IMU 566.

### Steering Based on Gearbox Position

As previously described, vehicle 2 is capable of steering/turning when not moving forward or backward because power is provided to track assemblies 100L, 100R independently by prime mover 51 and steering motor 320. In the present embodiment, steering controller 315 receives a signal 560 indicating the gearbox position 556 from controller 40. Gearbox position 556 may be a Park gear, a Neutral gear, a High gear, or a Low gear. In various embodiments, fewer gears may be used or more gears may be used. In the present embodiment, when steering controller 315 receives signal 560 indicating that gearbox position 556 is a park gear, steering controller 315 will disable the steering assembly 300. That is, when vehicle 2 is in a parked gear, or first position, the steering assembly 300 will be prohibited from providing power to either track assembly 100L, 100R. When steering controller 315 receives signal 560 indicating that gearbox position 556 is not a park gear (e.g., is, instead, in neutral, high, or low gear), or second position, the steering assembly 300 will be allowed to provide power to either or both of track assemblies 100L, 100R.

In the present embodiment, steering controller 315 will provide instructions to motor controller 330 to cease power to steering motor 320 when gearbox signal 560 indicates a park gear. In other embodiments, steering controller 315 may provide instructions to steering assembly 300 to create a physical disconnect, or decoupling, between steering motor 320 and any of motor control unit 330, battery 62, or generator 61 when gearbox signal 560 is a park gear.

In various embodiments, an indication or warning may be provided to an operator if steering controller 315 detects signal 560 indicating a park gear and also receives an input from steering input 20.

### Electric Accessories and Generator as Starter

Vehicle 2 includes generator 61 supported by front portion 10A of frame 10. In the present embodiment, generator 61 is configured to provide electrical power to a plurality of accessories. Generator 61 is coupled to powertrain 50. More particularly, generator 61 is mechanically coupled to prime mover 51 and configured to produce electrical power with a voltage between 12 Volts to 110 Volts (V). In various embodiments, generator 61 is configured to produce electrical power less than 12 Volts or greater than 110 Volts. Generator 61 may be coupled to one or more of electrical outputs (not shown). Electrical outputs may be electrical connection points configured to allow an accessory (e.g., lights, winch, appliance, pump, etc.) to be powered by vehicle 2. Additionally, vehicle 2 comprises a small-voltage battery 58 (e.g., 12V), a larger-voltage battery 62 (e.g., 48V), and a higher voltage generator 61 (e.g., up to 110V) so that a wide variety of voltage applications can be supported.

Generator 61 can also be used as a starter for prime mover 51. In the present embodiment, generator 61 may be configured to operate as a motor. Battery 62 may provide electrical power to generator 61 so that generator 61 operates as a motor to provide a starting force to prime mover 51. As previously disclosed, generator 61 is mechanically coupled to a crankshaft (not shown) of prime mover 51 with a pulley. In other embodiments, generator 61 is directly coupled to a crankshaft of prime mover 51. When generator 61 is used as a starter, a user input to indicate an ignition sequence will initiate a sequence for battery 62 to provide power to generator 61 so that generator 61 can rotate and provide rotational power to the crankshaft of prime mover 51 and facilitate the starting of prime mover 51.

### Autonomous Drive System

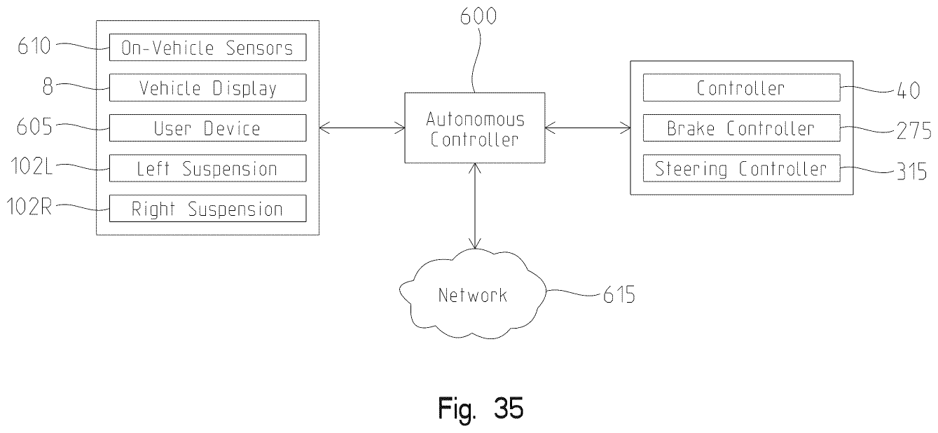

Now referring to FIG. 35, vehicle 2 may be configured to operate in an autonomous mode. Vehicle 2 may include an autonomous controller 600 configured to control autonomous operation of vehicle 2. In the present embodiment, a user device (e.g., a mobile device) 605 may provide a user signal to autonomous controller 600. A user may provide a user signal to vehicle 2 by providing a signal from user device 605 to autonomous controller 600. A user signal may be one or more of an ignition signal, throttle signal, a brake signal, a steering signal, audio signal or other vehicle signal. Autonomous controller 600 may also receive input signals from vehicle display 8 as well as at least one of a plurality of on-vehicle sensors 610. On-vehicle sensors 610 include audio sensors, visual sensors, cameras, LiDAR sensors, infrared sensors, or other types of sensors. On-vehicle sensors 610 may be positioned external to vehicle 2, within operator area 3 or adjacent powertrain 50. Autonomous controller 600 also receives inputs from left suspension 102L and right suspension 102R, including signals from at least one of shock position sensors 558 of shock absorbers 202, 142A, 142B, 142C, 152.

In response to receiving inputs from on-vehicle sensors 610, vehicle display 8, user device 605, left suspension 102L, and right suspension 102R, autonomous controller 600 provides instructions to at least one of controller 40, brake controller 275, and steering controller 315. Autonomous controller 600 may then provide instructions to controller 40 to control powertrain 50, provide instructions to brake controller 275 to control brake assembly 250, and provide instructions to steering controller 315 to control steering assembly 300.

In various embodiments, autonomous controller 600 is communicably coupled to a network 615. A user may access network 615 through a personal computer, a server, a mobile device, a remote controller, or other wireless device to provide inputs to autonomous controller 600 and remotely control vehicle 2.

### Carrier Wheel Position

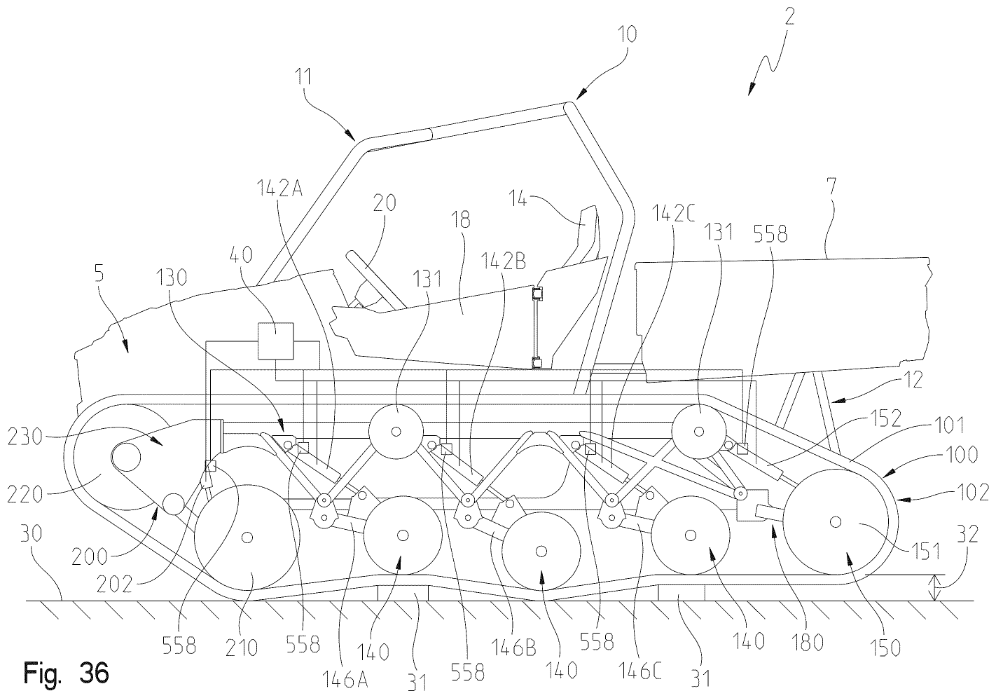

Referring now to FIG. 36, suspension assembly 102 may be configured with a wheel assembly 150 that is positioned above a ground surface 30 in an unloaded, neutral state (FIG. 36). That is, when vehicle 2 is unloaded and on a flat ground surface 30, wheel assembly 150 may be raised above ground surface 30 by a separation distance 32. In embodiments, wheel assembly 150 is raised off of the ground surface 30 by shortening the length of either of, or both of shock absorber 152 and swingarm assembly 180. In embodiments, the stroke length of either of, or both of shock absorber 152 and swingarm assembly 180 is reduced from a typical length.

When wheel assembly 150 is positioned to rest on ground surface 30, wheel assembly 150 will run into and move or ‘bounce’ (i.e., experience a ‘bounce event’) on or as a result of contact with obstructions 31, thereby causing the remaining components of suspension 102 to feel the effects of the ‘bounce event’ and decrease the ride quality of vehicle 2 and may decrease track tension Still referring to FIG. 36, when wheel assembly 150 is raised off of ground surface 30 in an unloaded, neutral state, wheel assembly 150 may avoid obstacles (e.g., ground obstructions 31), thereby increasing the ride comfort of suspension 102 of vehicle 2 and maintain track tension. Additionally, when wheel assembly 150 is raised off of ground surface 30 in a neutral state, the wheelbase (i.e., the distance between the forwardmost ground engaging member and the rearwardmost ground engaging member) is decreased, which increases the drivability and ride comfort of vehicle 2.

In embodiments, wheel assembly 150 is configured to remain off of the ground surface 30 by separation distance 32 when vehicle 2 is in an unloaded, neutral state, and when vehicle 2 is loaded with cargo, or the weight of vehicle 2 is shifted rearwardly (e.g., vehicle 2 is driving uphill), wheel assembly 150 is configured to extend downwardly to contact ground surface 30. That is, in embodiments, either of, or both of, shock absorber 152 or swingarm assembly 180 is configured to shift downwardly under increased weight in order to provide additional support to vehicle 2 and increase the wheelbase (i.e., the distance between the forwardmost ground engaging member and the rearwardmost ground engaging member).

Still referring to FIG. 36, wheel assembly 150 has a neutral state positioned above ground surface 30 by separation distance 32, which improves the ability of wheel assembly 150 to avoid obstructions 31. When wheel assembly 150 contacts obstruction 31, wheel assembly 150 moves or ‘bounces’ up and down, which may alter the overall track tension. In embodiments, increasing separation distance 32 to allow wheel assembly 150 to avoid obstructions 31 decreases the number, or frequency of, ‘bounce events’, and decreases the amplitude of the ‘bounce events’ which assists in maintaining track tension and increases the drivability of vehicle 2.

### Track Design

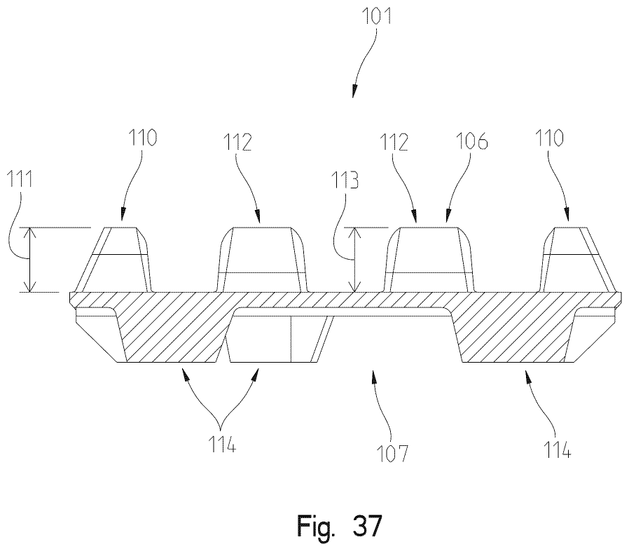

Now referring to FIG. 37, track 101 includes an inner surface, or side 106 and an outer surface, or side 107. Inner surface 106 is configured to engage suspension assembly 102 and outer surface 107 is configured to engage the ground surface 30. Illustratively, outer surface 107 includes a plurality of lugs, or tread portions 114. Further, inner surface 106 includes a plurality of outer lugs 110 and a plurality of inner lugs 112.

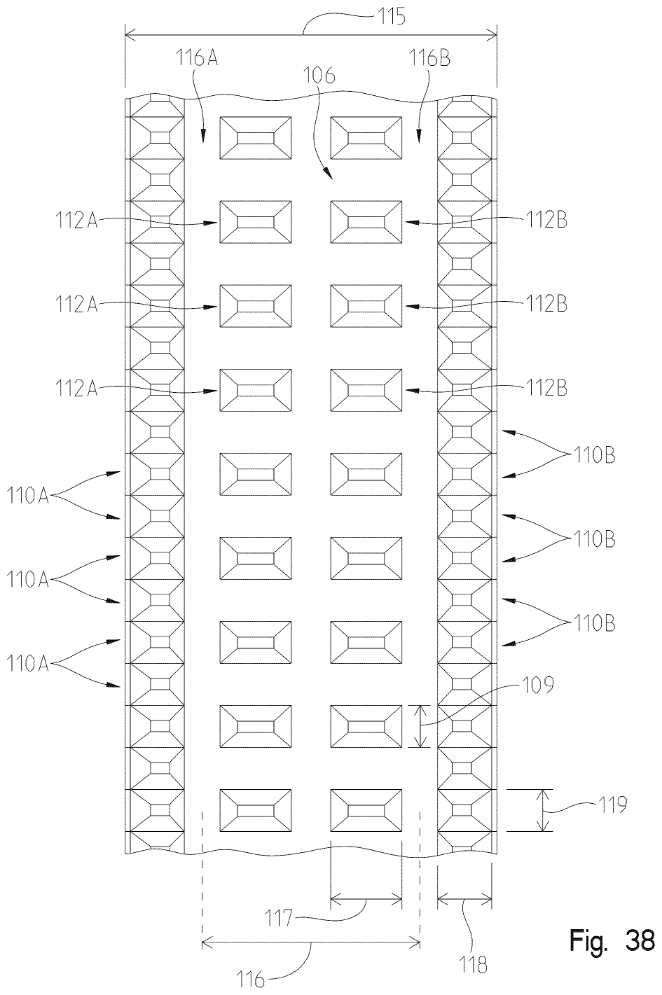

Referring now to FIG. 38, inner surface 106 comprises a track width 115. In embodiments, the track width 115 is approximately 200-400 millimeters (mm). In embodiments, the track width 115 is approximately 250-350 mm. In embodiments, the track width is 300 mm. Track 101 includes a first longitudinal row of outer lugs 110A and a second longitudinal row of outer lugs 110B positioned on either lateral end of track 101. First row of outer lugs 110A and second row of outer lugs 110B are comprised of a plurality of continuous outer lugs 110. That is, outer lugs 110 have no longitudinal separation (or minimum separation) between them. In embodiments, outer lugs 110 have a width 118, a length 119, and a height 111. In embodiments, width 118 is between 30-50 mm. In embodiments, width 118 is approximately 40 mm, and in embodiments, width 118 may be 41 mm. In embodiments, length 119 is between 20-40 mm, and in embodiments, length 119 is approximately 30 mm. In embodiments, height 111 is approximately 35 mm. In embodiments, width 118 is greater than 10% of the track width 115. In embodiments, the total width of outer lugs 110 (i.e., outer lugs 110A, 110B) is greater than 25% of the track width 115.

Still referring to FIG. 38, track 101 includes a first longitudinal row of inner lugs 112A and a second longitudinal row of inner lugs 112B positioned intermediate first longitudinal row of outer lugs 110A and second longitudinal row of outer lugs 110B. First longitudinal row of inner lugs 112A and second longitudinal row of inner lugs 112B are comprised of a plurality of inner lugs 112. In embodiments, inner lugs 112 have a width 117, a length 109 and a height 113. In embodiments, width 117 is between 40-60 mm. In embodiments, width 117 is 48 mm. In embodiments, length 109 is between 20-40 mm, and in embodiments, length 109 is approximately 30 mm. In embodiments, height 113 is approximately 35 mm. In embodiments, width 117 is greater than 15% of the track width 115. In embodiments, the total width of inner lugs 112 (i.e., inner lugs 112A, 112B) is greater than 30% of the track width 115.

Still referring to FIG. 38, outer lugs 110A are separated by inner lugs 112A by an inner channel 116A and outer lugs 110B are separated by inner lugs 112B by an inner channel 116B. Carrier wheels 141A, 141B, 141C, 151, 210 are configured to sit within, and run along channels 116A, 116B. In embodiments, channels 116A, 116B are separated by channel width 116. In embodiments, channel width 116 is between 150-200 mm. In embodiments, channel width 116 is 175 mm. In embodiments, outer lugs 110A, 110B are sized to increase the lateral strength of outer lugs 110A, 110B. That is, as the width of outer lugs 110A, 110B are increased, outer lugs 110A, 110B are able to experience, and withstand, a greater lateral force exerted by any of carrier wheels 141A, 141B, 141C, 151, 210. Outer lugs 110A, 110B are configured to withstand the lateral force exerted by carrier wheels 141A, 141B, 141C, 151, 210 to reduce the chances of any of carrier wheels 141A, 141B, 141C, 151, 210 from derailing from track 101. That is, by preventing derailing, carrier wheels 141A, 141B, 141C, 151, 210 are configured to stay within channels 116A, 116B and allow vehicle 2 to maintain an operating condition.

In embodiments, the total width of the lugs (i.e., outer lugs 110A, 110B, inner lugs 112A, 112B) is greater than 50% of the track width 115. In embodiments, the total width of the lugs (i.e., outer lugs 110A, 110B, inner lugs 112A, 112B) is approximately 60% of the track width 115.

In embodiments, outer lugs 110A, 110B have a height-to-width ratio of approximately 0.7:1-0.9:1. In embodiments, outer lugs 110A, 110B have a height-to-width ratio of 0.85:1.

In embodiments, inner lugs 112A, 112B have a height-to-width ratio of approximately 0.6:1-0.9:1. In embodiments, inner lugs 112A, 112B have a height-to-width ratio of 0.73:1.

### Cab Structures

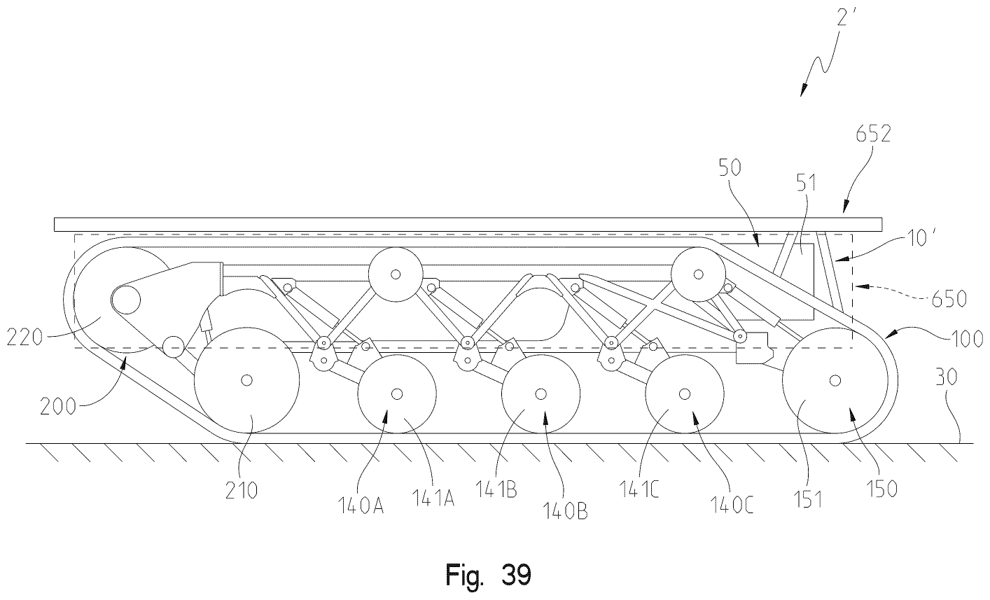

Now referring to FIGS. 39-43, a vehicle 2′ may be constructed similarly to vehicle 2. Vehicle 2′ may include a pair of track assemblies 100 and a frame assembly 10′ coupled between track assemblies 100 which may be substantially similar to frame assembly 10. A support structure 652 is supported by frame assembly 10′ which is positioned vertically above track assemblies 100. In embodiments, support structure 652 is a flat surface configured to support a cab structure 654. Vehicle 2′ includes components from vehicle 2, including prime mover 51, intake assembly 52 and airbox 53, exhaust assembly 55 and silencer 56, battery 58, CVT 60, generator 61, battery 62, converter 63, shiftable transmission, 65, propshaft assembly 70, front drive 90, steering motor 320, inverter 331, and one or more of controllers 40, 315, 330. In embodiments, each of prime mover 51, intake assembly 52 and airbox 53, exhaust assembly 55 and silencer 56, battery 58, CVT 60, generator 61, battery 62, converter 63, shiftable transmission, 65, propshaft assembly 70, front drive 90, steering motor 320, inverter 331, and one or more of controllers 40, 315, 330 are positioned within a profile 650. Profile 650 may generally be a laterally extending profile that extends generally below support structure 652, rearwardly of a forward extent of drive wheel 220, forwardly of a rearward extent load bearing wheel assembly 150, and above ground surface 30. In embodiments, profile 650 is positioned vertically above each of first carrier wheels 141A, second carrier wheels 141B, and third carrier wheels 141C. In embodiments, each of prime mover 51, intake assembly 52 and airbox 53, exhaust assembly 55 and silencer 56, battery 58, CVT 60, generator 61, battery 62, converter 63, shiftable transmission, 65, propshaft assembly 70, front drive 90, steering motor 320, inverter 331, and one or more of controllers 40, 315, 330 are positioned vertically below support structure 652.

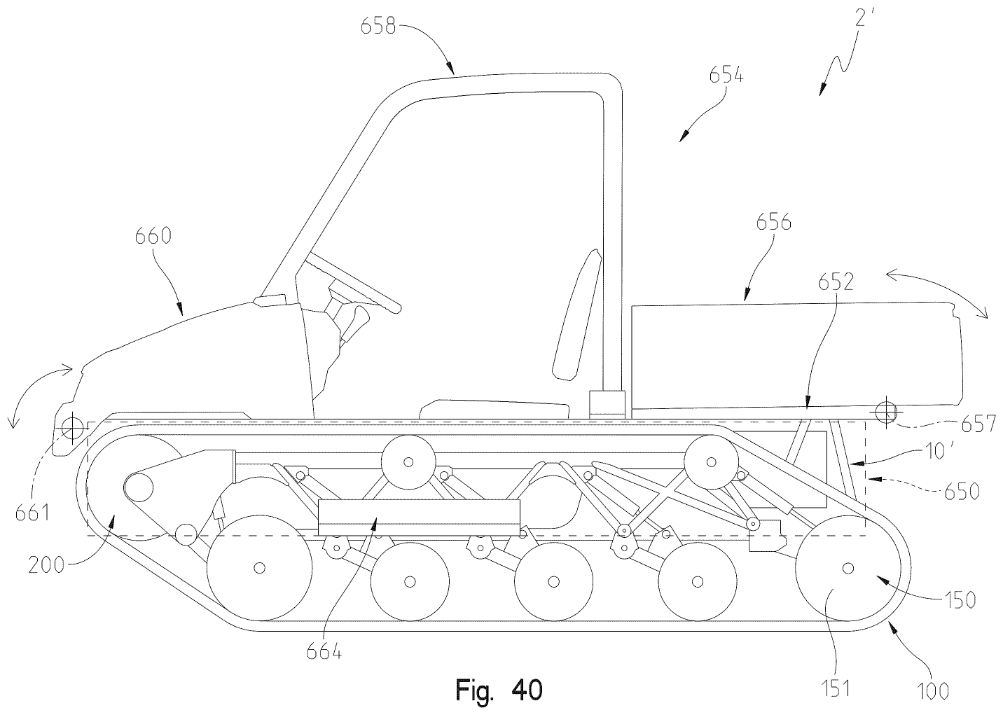

Referring now to FIG. 40, cab structure 654 is positioned on support structure 652 and may include a cab 658 positioned longitudinally intermediate a hood structure 660 and box assembly 656. In embodiments, hood structure 660 is rotatable about rotation axis 661 and conceals a storage area. Rotation axis 661 is positioned vertically above drive wheel assembly 200 viewed from a side perspective. In embodiments, box assembly 656 is rotatable about rotation axis 657. Rotation axis 657 is positioned at a generally rearward portion of profile 650, and rotation axis 657 is positioned vertically above load bearing wheel assembly 150 and carrier wheels 151 viewed from a side perspective. In embodiments, cab 658 of cab structure 654 may seat 1-person, 2-persons, or 3-persons. In embodiments, vehicle 2′ includes one or more steps 664 positioned vertically below and/or adjacent to cab 658 to allow an operator to enter into cab 658.

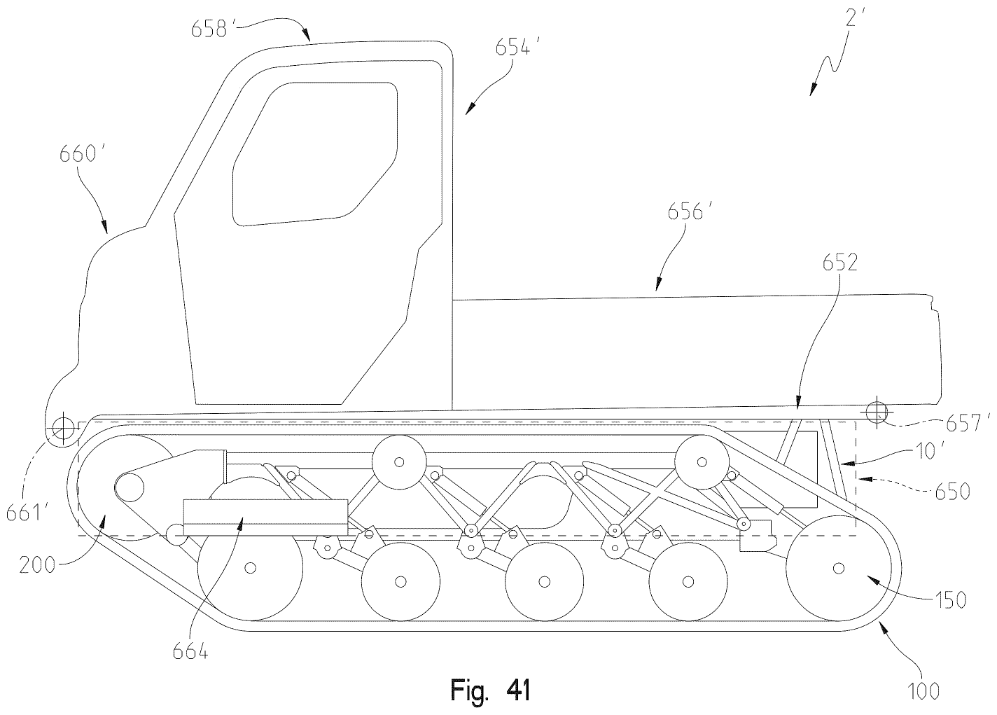

Referring to FIG. 41, a cab structure 654′ is positioned on support structure 652 and may include a cab 658′ positioned longitudinally intermediate a hood structure 660′ and box assembly 656′. In embodiments, box assembly 656′ is rotatable about rotation axis 657′. Rotation axis 657′ is positioned at a generally rearward portion of profile 650, and rotation axis 657′ is positioned vertically above load bearing wheel assembly 150 and carrier wheels 151 viewed from a side perspective. In embodiments, cab 658′ of cab structure 654′ may seat 1-person, 2-persons, or 3-persons. In embodiments, cab structure 654′ has a substantially similar longitudinal length as cab structure 654. Still referring to FIG. 41, box assembly 656′ has a greater longitudinal length than box assembly 656 and hood structure 660′ has a lesser longitudinal length than hood structure 660. That is, cab structure 654′ may maintain a similar length as cab structure 654 and increase the size of box assembly 656. In embodiments, box assembly has a length of approximately 5 feet. In embodiments, vehicle 2′ includes one or more steps 664 positioned vertically below and/or adjacent to cab 658′ to allow an operator to enter into cab 658′

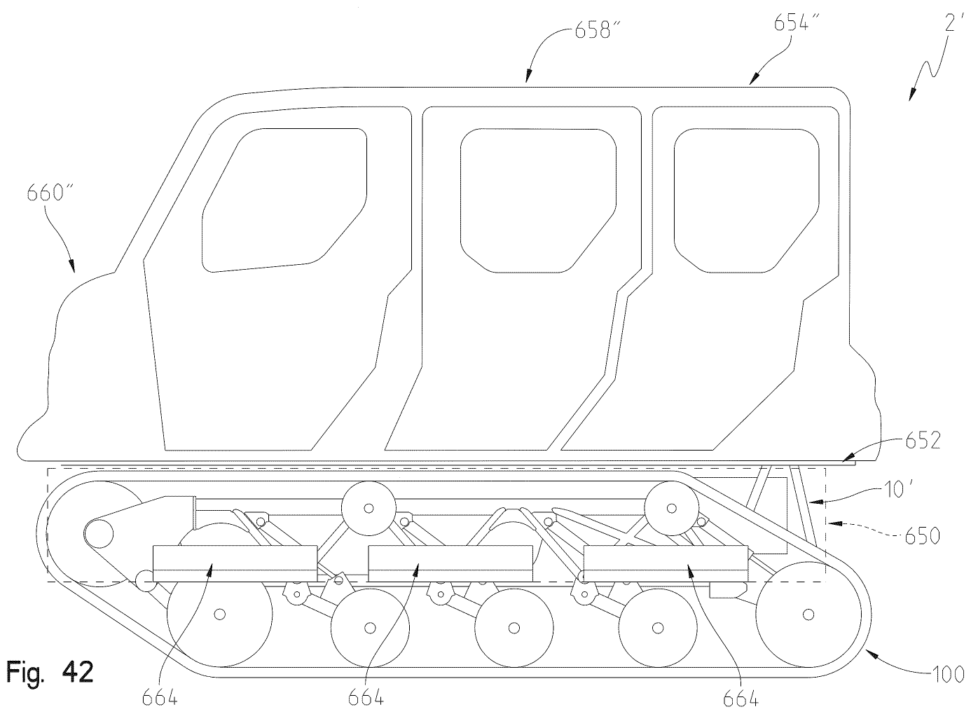

Referring now to FIG. 42, a cab structure 654′ is positioned on support structure 652 and may include a cab 658″ positioned longitudinally rearwardly of a hood structure 660″. In embodiments, hood structure 660″ is substantially similar to, or the same as, hood structure 660, 660′. Cab 658″ extends more than 80% of the length of support structure 652 and track assembly 100. In embodiments, cab 658″ is configured to support three rows of seating, and may seat 3-persons, 4-persons, 5-persons, 6-persons, 7-persons, 8-persons, 9-persons, or more persons. In embodiments, vehicle 2′ includes one or more steps 664 positioned vertically below and/or adjacent to cab 658″ to allow an operator to enter into cab 658″.

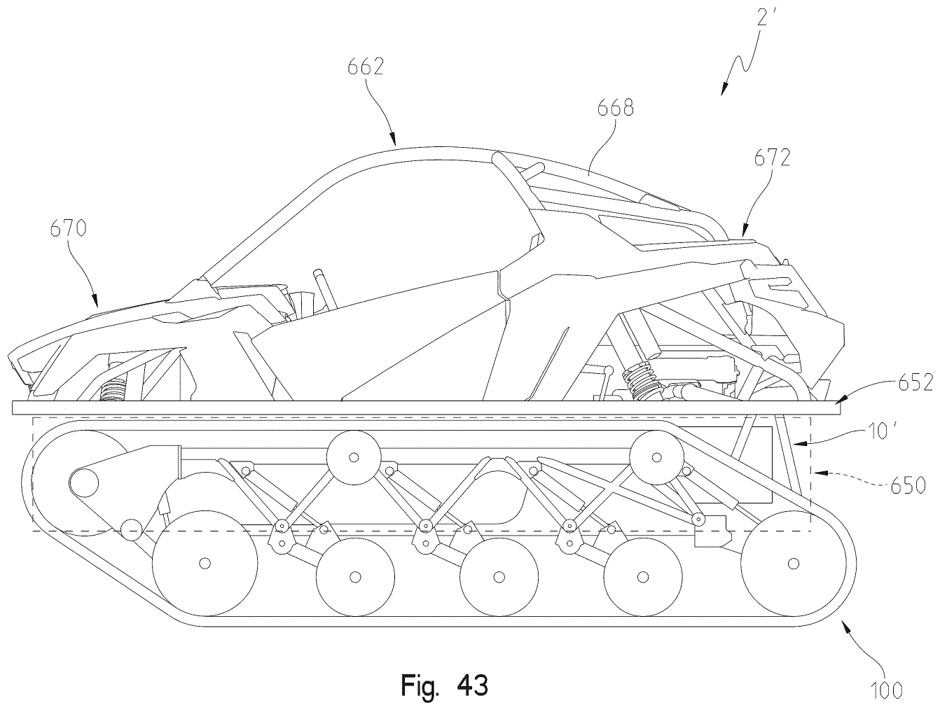

Referring to FIG. 43, vehicle 2′ may include a cab structure 662 positioned on support structure 652. Cab structure 662 may include an upper frame assembly 668 extending between a front, hood portion 670 and a rear, cargo portion 672. Cab structure 662 may have a sportier feel by decreasing seat height and lowering the center of gravity of vehicle 2′.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practices in the art to which this invention pertains.

1. A tracked vehicle, comprising:
a first track assembly and a second track assembly;
a powertrain configured to provide rotational power to the first track assembly and the second track assembly;
a steering system operably coupled to the first track assembly and the second track assembly, the steering system comprising:
a steering motor;
a geartrain operably coupled between the steering motor and the powertrain;
a steering control unit configured to receive a steering input signal;
a generator operably coupled to the powertrain, the generator configured to provide power to the steering motor; and
the steering control unit configured to provide a steering output signal to the steering motor, the steering output signal being one of a positive torque command and a negative torque command.

2. The tracked vehicle of claim 1, wherein the steering system further comprises a steering feedback unit, and the steering feedback unit is configured to provide a feedback signal to an operator of the tracked vehicle when the steering output signal is provided to the steering motor.

3. The tracked vehicle of claim 2, wherein the steering feedback unit is an electronic power steering unit.

4. The tracked vehicle of claim 1, wherein the powertrain includes an electronic controller, the electronic controller configured to receive a first powertrain characteristic from the powertrain at a first time and receive the first powertrain characteristic at a second time, and the steering control unit is configured to receive the first powertrain characteristic from the electronic controller and alter the steering output signal when the first powertrain characteristic at the second time is different than the first powertrain characteristic at the first time.

5. The tracked vehicle of claim 4, wherein the first powertrain characteristic is one of an engine speed, a gearbox position, and a vehicle speed.

6. The tracked vehicle of claim 4, wherein the first powertrain characteristic is a gearbox position, and the steering motor is configured to output one of a positive torque and a negative torque when the gearbox position is one of a reverse gear and a forward gear and a steering input is in a first direction, and the steering motor is configured to output the other one of the positive torque and the negative torque when the gearbox position is the other one of the reverse gear and the forward gear and the steering input is in the first direction.

7. The tracked vehicle of claim 4, wherein the first powertrain characteristic is one of an engine speed and a vehicle speed, and the steering control unit is configured to request an increase in the absolute value of the torque command when the first powertrain characteristic is increased.

8. The tracked vehicle of claim 1, wherein the powertrain includes an electronic controller, the electronic controller configured to receive an engine speed, a vehicle speed and a gearbox position from the powertrain, the steering output signal is configured to change based upon a change in any of the engine speed, the vehicle speed, and the gearbox position.

9. The tracked vehicle of claim 8, wherein the steering output signal is configured to change in accordance with a steering motor speed gradient based upon a change in the engine speed or the vehicle speed.

10. The tracked vehicle of claim 9, wherein the steering motor speed gradient includes a first steering motor speed interval between a first engine speed and a second engine speed and a second steering motor speed interval between a third engine speed and a fourth engine speed;
the difference between the first engine speed and the second engine speed equals the difference between the third engine speed and the fourth engine speed, the first engine speed is less than the second engine speed which is less than the third engine speed which is less than the fourth engine speed; and
the first steering motor speed interval is less than the second steering motor speed interval.

11. A vehicle, comprising:
a first track assembly;
a second track assembly;
a frame supported by the first track assembly and the second track assembly;
a powertrain supported by the frame, the powertrain including a prime mover, a transmission operably coupled to the prime mover, a drive member, and a propshaft extending from the transmission to the drive member;
the drive member comprising:
a drive housing;
an input configured to receive the propshaft;
a plurality of outputs including a first output and a second output, the first output rotatably coupled to the first track assembly and the second output rotatably coupled to the second track assembly; and
a steering assembly comprising:
a steering motor;
a geartrain operably coupled between the steering motor and the plurality of outputs; and
the steering motor is coupled to the drive housing.

12. The vehicle of claim 11, wherein the drive member is positioned at a forward portion of the vehicle and the prime mover is positioned at a rearward portion of the vehicle.

13. The vehicle of claim 11, further comprising a generator operably coupled to the prime mover and electrically coupled to the steering motor.

14. The vehicle of claim 11, wherein the geartrain is configured to provide a first torque to the first output and a second torque to the second output, and the first torque is a positive value and the second torque is a negative value.

15. The vehicle of claim 11, wherein the steering assembly further comprises a steering control unit communicably coupled to the steering motor, and the steering control unit receives one of an engine speed and a vehicle speed from the powertrain, and the steering control unit alters an operating characteristic of the steering motor based upon a change in one of the engine speed and the vehicle speed.

16. The vehicle of claim 11, wherein the geartrain further comprises a first shaft and a second shaft parallel to the first shaft, and the drive member includes a drive input shaft coupled to the input, and a portion of the drive input shaft extends between the first shaft and the second shaft.

17. The vehicle of claim 11, wherein a steering motor output is parallel to the first output and the second output.

18-71. (canceled)
